(19) United States
(12) Patent Application Publication
(10) Pub. No.: US 2026/0260100 A1
(43) Pub. Date: Sep. 3, 2026

(54) Deterministic Dual-Layer Architecture for Genome-Constrained AI Execution and Provenance-Tracked Content Synthesis

(71) Applicant: Polyup Inc., Saratoga, CA (US)

(72) Inventors: Amir Masoud Zarkesh, Saratoga, CA (US); Alex Zakharenkov, Davis, CA (US)

(21) Appl. No.: 19/547,293

(22) Filed: Feb. 23, 2026

Related U.S. Application Data
(63) Continuation-in-part of application No. 19/010,835, filed on Jan. 6, 2025.
Application No. 19/010,835 is a continuation-in-part of application No. 18/779,392, filed on Jul. 22, 2024, now Pat. No. 12,229,913.
Application No. 18/779,392 is a continuation-in-part of application No. 18/364,866, filed on Aug. 3, 2023, now abandoned.
(60) Provisional application No. 63/515,023, filed on Jul. 21, 2023.
(60) Provisional application No. 63/582,927, filed on Sep. 15, 2023.
(60) Provisional application No. 63/762,080, filed on Feb. 23, 2025.

(51) Int. Cl. G06N 3/123; G06F 21/53

(52) U.S. Cl. CPC G06N 3/123; G06F 21/53

(57) ABSTRACT

A computing system for controlled artificial intelligence content generation is disclosed. The system includes a first control layer having a deterministic execution engine configured to execute scripts defining content generation workflows. Each script includes deterministic instructions and syntactically distinguished AI invocation instructions identified by a designated keyword. The deterministic instructions are executed algorithmically, and execution is paused upon encountering an AI invocation instruction. A second control layer includes a validated token catalog stored in a structured data store and defining a finite set of permissible token sequences. An AI model interface receives a constrained context comprising a subset of the validated token catalog relevant to the AI invocation instruction and returns a selected token sequence associated with provenance metadata. Deterministic execution then resumes to complete the workflow. An agent orchestrator coordinates the control layers to generate a synthesized content item in a controlled and validated manner.

### CROSS-REFERENCE TO RELATED APPLICATIONS

This application claims priority to U.S. Provisional Patent Application No. 63/762,080 (Attorney Docket No. LMODP004P), filed Feb. 23, 2025 by Amir Zarkesh, titled Adaptive Multi-Agent Orchestration with Semantic Normalization and Automated Agent Evolution, which is incorporated herein by reference in its entirety and for all purposes. This application also claims priority to and is a continuation-in-part of U.S. patent application Ser. No. 19/010,835 (Attorney Docket No. LMODP003USX1), filed Jan. 6, 2025 by Zarkesh, et al., titled “Systems and Methods for Video Generation via Language-Based Three-Dimensional Interactive Environment Construction”, which claims priority to and is a continuation in part of U.S. patent application Ser. No. 18/779,392 (Attorney Docket No. LMODP003US) by Zarkesh, titled “Systems and Methods for Language-Based Three-Dimensional Interactive Environment Construction and Interaction”, filed Jul. 22, 2024, which claims priority to U.S. Provisional Patent Application 63/582,927 (Attorney Docket No. LMODP002P) by Zarkesh, titled “Enhancing Interactions and Task management for Avatars Using Feynman Path Integrals, Path Language, Large Language Models, and Cross-Environment History”, filed Sep. 15, 2023, and to U.S. patent application Ser. No. 18/364,866 (Attorney Docket No. LMODP001US) by Zarkesh, titled “Avatar Interaction and Task Management Using Path Language and Large Language Models”, filed Aug. 3, 2023, which claims priority to U.S. Provisional Patent Application 63/515,023 (Attorney Docket No. LMODP001P) by Zarkesh, titled “Avatar Interaction and Task Management Using Path Language and Large Language Models”, filed on Jul. 21, 2023, all of which are incorporated herein by reference in their entirety and for all purposes.

### FIELD OF TECHNOLOGY

This patent application relates generally to artificial intelligence and machine learning, and more specifically to the use of artificial intelligence and machine learning to facilitate content synthesis.

### BACKGROUND

Artificial intelligence systems are increasingly sophisticated and are being applied to content generation at industrial scale. However, conventional generative AI systems exhibit several fundamental limitations that prevent reliable deployment in production environments. In particular, conventional large language models and generative AI systems compute outputs from unbounded probability distributions, leading to severe computational instability and content fabrication (commonly referred to in the art as “hallucination”) where the model produces invalid, fabricated, or structurally inconsistent outputs. In multi-agent orchestration systems and complex programmatic workflows combining multiple AI inference calls, these probabilistic errors propagate through subsequent computational steps. This unchecked propagation results in catastrophic memory state corruption, redundant processing cycles, and severe computational overhead, as systems are forced to repeatedly process failed generative branches. The fundamental lack of a deterministic boundary in conventional computing architectures forces processors to treat all AI-generated outputs as unbounded variables, leading to excessive and wasteful utilization of hardware resources (e.g., GPU cycles, bandwidth, and memory allocation) when the system is required to regenerate entire data assets due to a single downstream semantic error.

### SUMMARY

In some embodiments, the techniques described herein relate to a computing system for controlled artificial intelligence content generation, including: a first control layer executed via one or more processors and including a deterministic execution engine configured to process scripts defining content generation workflows, a script including a plurality of deterministic instructions and one or more AI invocation instructions syntactically distinguished from the deterministic instructions by a designated keyword within the script, the deterministic execution engine executing the deterministic instructions algorithmically and pausing deterministic execution upon encountering an AI invocation instruction; a second control layer including a validated token catalog stored in a structured data store on a storage device and defining a finite set of permissible token sequences; an AI model interface configured to receive a constrained context including at least a subset of the validated token catalog relevant to the AI invocation instruction and to respond with a token sequence selected from the subset, the token sequence representing an atomic content element and being associated with provenance metadata identifying a source from which the token sequence was derived, wherein deterministic execution of subsequent deterministic instructions in the script is resumed after the token sequence is received; and an agent orchestrator configured to facilitate operation of the first control layer and the second control layer to execute the script to determine a synthesized content item.

In some embodiments, the techniques described herein relate to a computing system, wherein deterministic execution of subsequent deterministic instructions is resumed only after validating that the token sequence corresponds to an entry in the validated token catalog.

In some embodiments, the techniques described herein relate to a computing system, wherein the subsequent deterministic instructions include assertion instructions that specify a validation constraint evaluated against the token sequence after binding the token sequence to a variable, the synthesized content item being determined upon determining that the validation constraint is satisfied.

In some embodiments, the techniques described herein relate to a computing system, wherein the first control layer prevents process hallucination by ensuring that the deterministic execution engine enforces execution of every deterministic instruction in the script in a prescribed sequence such that an AI model cannot skip, reorder, or fabricate workflow steps, and wherein the second control layer prevents content hallucination by constraining AI model outputs to the finite set of permissible token sequences defined in the validated token catalog such that any AI model output referencing a token sequence absent from the validated token catalog is excluded from the synthesized content item and is rejected during validation.

In some embodiments, the techniques described herein relate to a computing system, wherein the script is defined in a domain-specific language having a formal grammar that syntactically distinguishes a plurality of statement types selected from the group consisting of: variable assignments binding values to variables in designated namespaces, assertions evaluating validation constraints, conditional branching and iterative loop structures, AI invocations identified by the designated keyword, and logging instructions, and deterministic filter operations that evaluate predicates using strict equality, numerical comparison, or deterministic string matching and are prohibited from performing semantic similarity operations unless wrapped within an AI invocation instruction bearing the designated keyword.

In some embodiments, the techniques described herein relate to a computing system, wherein the token sequence is a structured data object including: a unique identifier, a type classification corresponding to a content action category, one or more parameters with defined value bounds, compositional constraints specifying compatibility rules with other token sequences including at least one of a set of token sequences that cannot immediately follow the designated token sequence, a set of token sequences that must precede the token sequence or that are incompatible with the token sequence, and provenance metadata including at least a source asset identifier, an extraction chain identifier, and an extraction timestamp.

In some embodiments, the techniques described herein relate to a computing system, wherein the synthesized content item is associated with a provenance map recording an ordered mapping of token sequence identifiers to positions within the synthesized content item, the provenance map enabling identification and selective replacement of individual token sequences within the synthesized content item without entirely regenerating the synthesized content item.

In some embodiments, the techniques described herein relate to a computing system, further including a semantic hypervisor configured to manage execution of a plurality of AI agents by: instantiating isolated execution environments for the AI agents having separate input, output, and local variable namespaces identified by distinct syntactic prefixes within the scripts such that state from one AI agent's execution does not leak into another AI agent's execution; restricting the plurality of AI agents to output token sequences present in the validated token catalog, the validated token catalog being accessible to the plurality of AI agents in a read-only mode during content generation operations such that an AI agent's generation of a token sequence not present in the validated token catalog constitutes a boundary violation; and scheduling execution of deterministic operations within the scripts independently of AI model inference operations.

In some embodiments, the techniques described herein relate to a computing system, wherein the script is written in a domain-specific language defined by a formal grammar including production rules for statements including assignments, assertions, control flow structures, filter operations, AI invocations, and logging instructions, and wherein the script includes variables organized into designated namespaces including an input namespace for immutable parameters identified by a first syntactic prefix, an output namespace for mutable session state identified by a second syntactic prefix, and a local namespace for mutable block-scoped variables identified by a third syntactic prefix.

In some embodiments, the techniques described herein relate to a computing system, wherein the computing system is configured to generate an execution log classifying executed instructions as deterministic or probabilistic, the execution log enabling identification of sources of non-deterministic behavior within a workflow; identify, based on the execution log, a modification to at least one instruction in the script to address an identified source of non-deterministic behavior; and apply the modification to the script to produce a modified script, whereby subsequent execution of the modified script by the deterministic execution engine applies the modification to future content generation operations using the modified script without requiring modification of previously produced content generation outputs.

In some embodiments, the techniques described herein relate to a computing system, wherein the token sequence includes compositional constraint data specifying one or more rules governing valid combinations with other token sequences, the computing system further including an assembly model configured to determine the synthesized content item based on an ordered composition of selected token sequences including the token sequence upon validating that the ordered composition of selected token sequences satisfies the compositional constraint data.

In some embodiments, the techniques described herein relate to a computing system, wherein the token sequence has an associated status value indicating whether the token sequence is active, blacklisted, or deprecated, the subset excluding token sequences having a blacklisted or deprecated status.

In some embodiments, the techniques described herein relate to a computing system, wherein the validated token catalog is populated through an automated extraction pipeline including an ordered sequence of processing agents executing respective workflow scripts including deterministic instructions and one or more AI invocation instructions syntactically identified by a designated keyword, the processing agents performing: extraction of raw content data from approved reference assets using AI model analysis invoked by the designated keyword, normalization of the raw content data by applying one or more of signal smoothing using discrete Kalman filtering, path simplification using a Ramer-Douglas-Peucker algorithm, coordinate normalization mapping absolute coordinate values to relative coordinate values, temporal normalization mapping absolute time values to proportional values relative to a segment duration, and persistence of normalized token sequences to the validated token catalog with associated provenance metadata identifying a reference asset, the automated extraction pipeline, and an extraction timestamp.

In some embodiments, the techniques described herein relate to a computing system, wherein the system operates as a bidirectional pipeline in which: a mining subsystem executes the respective workflow scripts of processing agents to process approved reference assets and populate the validated token catalog with normalized token sequences, and a synthesis subsystem executes content generation workflow scripts to select token sequences from the validated token catalog and compose synthesized content assets, wherein both the mining subsystem and the synthesis subsystem use workflow scripts including deterministic instructions and AI invocation instructions syntactically identified by the designated keyword, such that both extraction and synthesis enforce an identical boundary between deterministic execution and probabilistic AI model inference, wherein the synthesized content item is designated as an approved reference asset for processing by the mining subsystem.

In some embodiments, the techniques described herein relate to a computing system, further including: a library of synthesized content items generated by AI-assisted content synthesis including the synthesized content item, the library storing a provenance record including an ordered mapping of token sequence identifiers to positions within the synthesized content item, each token sequence identifier referencing a corresponding entry in a validated token catalog from which the token sequence was selected during synthesis, wherein the computing system is configured to: receive a designation that a designated token sequence in the validated token catalog is invalid; query the library to identify a set of affected synthesized content assets whose provenance records contain a designated token sequence identifier; and for each affected synthesized content asset in the set: identify, from the provenance record, a position within the affected synthesized content asset at which the designated token sequence was used, select a replacement token sequence from the validated token catalog, the replacement token sequence being of a same type classification as the designated token sequence and having an active status, replace the designated token sequence at the position with the replacement token sequence while preserving all other portions of the affected synthesized content asset, and update the provenance record to reflect the replacement token sequence.

In some embodiments, the techniques described herein relate to a computing system, wherein determining that the designated token sequence is invalid is based on an audit of a subset of the synthesized content assets in the library, and wherein the selective replacement propagates the audit finding from the audited subset to all affected synthesized content assets in the library without requiring individual audit of each affected asset, the selective replacement requiring regeneration of only the portions of affected assets corresponding to the designated token sequence with remaining portions preserved intact.

In some embodiments, the techniques described herein relate to a computing system, wherein selecting the replacement token sequence includes providing candidate replacement token sequences and contextual information about the position within the affected synthesized content asset to an AI model, the AI model selecting the replacement token sequence from among a set of candidates.

In some embodiments, the techniques described herein relate to a computing system, wherein determining that the designated token sequence is invalid is associated with a blacklist entry including a reason for the designation, a replacement strategy indicator, and a query definition for identifying affected assets in the library.

In some embodiments, the techniques described herein relate to a method for controlled artificial intelligence content generation, including: executing a deterministic execution engine in a first control layer via one or more processors to process scripts defining content generation workflows, a script including a plurality of deterministic instructions and one or more AI invocation instructions syntactically distinguished from the deterministic instructions by a designated keyword within the script, the deterministic execution engine executing the deterministic instructions algorithmically and pausing deterministic execution upon encountering an AI invocation instruction; transmitting a constrained context including at least a subset of the validated token catalog relevant to the AI invocation instruction to an AI model interface, the constrained context determined by accessing a second control layer including a validated token catalog stored in a structured data store on a storage device and defining a finite set of permissible token sequences; receiving from the AI model interface a token sequence selected from the subset, the token sequence representing an atomic content element and being associated with provenance metadata identifying a source from which the token sequence was derived; resuming execution of subsequent deterministic instructions in the script after the token sequence is received; and determining a synthesized content item based on the deterministic instructions and the token sequence.

In some embodiments, the techniques described herein relate to one or more non-transitory computer readable media having instructions stored thereon for performing a method for controlled artificial intelligence content generation, the method including: executing a deterministic execution engine in a first control layer via one or more processors to process scripts defining content generation workflows, a script including a plurality of deterministic instructions and one or more AI invocation instructions syntactically distinguished from the deterministic instructions by a designated keyword within the script, the deterministic execution engine executing the deterministic instructions algorithmically and pausing deterministic execution upon encountering an AI invocation instruction; transmitting a constrained context including at least a subset of the validated token catalog relevant to the AI invocation instruction to an AI model interface, the constrained context determined by accessing a second control layer including a validated token catalog stored in a structured data store on a storage device and defining a finite set of permissible token sequences; receiving from the AI model interface a token sequence selected from the subset, the token sequence representing an atomic content element and being associated with provenance metadata identifying a source from which the token sequence was derived; resuming execution of subsequent deterministic instructions in the script after the token sequence is received; and determining a synthesized content item based on the deterministic instructions and the token sequence.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and computer program products for content generation. These drawings in no way limit any changes in form and detail that may be made by one skilled in the art without departing from the spirit and scope of the disclosed implementations.

FIG. 1 illustrates an overview method for providing a three-dimensional virtual environment, performed in accordance with one or more embodiments.

FIG. 2 illustrates a path large language model ecosystem, generated in accordance with one or more embodiments.

FIG. 3 illustrates one example of a computing device, configured in accordance with one or more embodiments.

FIG. 4 illustrates a method for configuring a three-dimensional virtual environment, performed in accordance with one or more embodiments.

FIG. 5 illustrates a method of generating an entity, performed in accordance with one or more embodiments.

FIG. 6 illustrates a method for generating a script governing a three-dimensional virtual environment, performed in accordance with one or more embodiments.

FIG. 7 illustrates a method of rendering a three-dimensional virtual environment, performed in accordance with one or more embodiments.

FIG. 8 illustrates a method of updating a three-dimensional virtual environment, performed in accordance with one or more embodiments.

FIG. 9 illustrates a method for rendering an animated entity within a three-dimensional virtual environment, performed in accordance with one or more embodiments.

FIG. 10 and FIG. 11 illustrate views of a default human animation rig, provided in accordance with one or more embodiments.

FIG. 12, FIG. 13, FIG. 14, and FIG. 15 illustrate views of entities (a box, a book, a bookshelf, and a shield) being animated, generated in accordance with one or more embodiments.

FIG. 16 illustrates an example of a three-dimensional virtual environment, generated in accordance with one or more embodiments.

FIG. 17 illustrates an overview method for executing a path large language model, performed in accordance with one or more embodiments.

FIG. 18 illustrates a path large language model ecosystem, configured in accordance with one or more embodiments.

FIG. 19 illustrates a flow diagram of a process flow, performed in accordance with one or more embodiments.

FIG. 20 illustrates a method of determining a path language, performed in accordance with one or more embodiments.

FIG. 21 illustrates a method of determining a path embedding for one or more paths, performed in accordance with one or more embodiments.

FIG. 22 illustrates a method of determining expected loss values for one or more paths, performed in accordance with one or more embodiments.

FIG. 23 illustrates a method of tuning a language model, performed in accordance with one or more embodiments.

FIG. 24 illustrates a method of determining a novel path, performed in accordance with one or more embodiments.

FIG. 25 illustrates a method of determining path guidance, performed in accordance with one or more embodiments.

FIG. 26 illustrates a localization graph generation method, performed in accordance with one or more embodiments.

FIG. 27 illustrates a path diagram generated in accordance with one or more embodiments.

FIG. 28 shows a conceptual diagram of the path large language model vocabulary.

FIG. 29 illustrates an example pipeline for generating a 3D interactive script, configured in accordance with one or more embodiments.

FIG. 30 illustrates a diagram of an ecosystem for providing a three-dimensional interactive virtual environment, configured in accordance with one or more embodiments.

FIG. 31 illustrates a diagram of an ecosystem for providing a three-dimensional interactive virtual environment, configured in accordance with one or more embodiments.

FIG. 32 illustrates a method of generating a video in accordance with such techniques, performed in accordance with one or more embodiments.

FIG. 33 illustrates a data model diagram, configured in accordance with one or more embodiments.

FIG. 34 illustrates a method for updating an agent, performed in accordance with one or more embodiments.

FIG. 35 illustrates the overall system-level architecture of MetaForm AI highlighting its major components and their interactions, configured in accordance with one or more embodiments.

FIG. 36 illustrates a block diagram of the semantic hypervisor, configured in accordance with one or more embodiments.

FIG. 37 illustrates a flowchart detailing the lifecycle of an AI agent within MetaForm AI, from the point it is tasked with a job to its eventual retirement, performed in accordance with one or more embodiments.

FIG. 38 illustrates a message passing diagram showing utilization of the Semantic Normal Form (SNF), configured in accordance with one or more embodiments.

FIG. 39 illustrates a task partitioning and execution flow diagram for a method performed in accordance with one or more embodiments.

FIG. 40 illustrates a block diagram showing two-way hallucination detection, configured in accordance with one or more embodiments.

FIG. 41 illustrates a workflow for auditing and mass updating, performed in accordance with one or more embodiments.

FIG. 42 illustrates a remediation and propagation method for correcting defects within a large library of synthesized content assets, in accordance with one or more embodiments.

FIG. 43 illustrates a mining chain pipeline, configured in accordance with various embodiments.

FIG. 44 illustrates a block diagram of an example of a token sequence (sometimes referred to herein as a genome), generated in accordance with one or more embodiments.

### DETAILED DESCRIPTION

### Part I—Overview

According to various embodiments, the disclosed system provides a dual-layer architecture that prevents hallucination in AI-driven content generation through both process-level and content-level control. The top-down layer uses a domain-specific deterministic execution language called DNA Contract Language (DCL) to separate algorithmic workflow logic from creative AI decisions, ensuring reproducible and auditable process execution. The bottom-up layer uses a genome-based constraint system (DNA AI) that limits AI selections to pre-approved token sequences stored in a structured catalog known as the DNA Map. These genomes are automatically mined and validated from authorized assets using multi-agent mining chains that apply normalization, smoothing, and quantization algorithms to produce interoperable data tokens. The system integrates these mechanisms within a “Semantic Hypervisor” that orchestrates agent execution and enforces both deterministic process control and vocabulary-limited AI behavior. This architecture provides verifiable, provenance-tracked AI generation, allowing selective asset updates through genome blacklisting and enabling scalable, reliable, and traceable synthetic media production.

Artificial intelligence systems are increasingly sophisticated and are being applied to content generation at industrial scale. However, conventional generative AI systems exhibit several fundamental limitations that prevent reliable deployment in production environments. First, conventional large language models and generative AI systems generate outputs from unbounded probability distributions, leading to content fabrication (commonly called “hallucination”) where the model produces invalid, fabricated, or inconsistent outputs. In complex workflows combining multiple AI calls, hallucination errors propagate through subsequent steps, compounding output inconsistency. What is needed is a mechanism to constrain AI generation to a bounded, pre-validated output domain.

Second, conventional AI workflows that interleave deterministic process logic and probabilistic AI inference within the same runtime environment suffer from process-level errors where AI models skip steps, invent logic, reorder operations, or fabricate workflow branches. The absence of a strict syntactic separation between algorithmic control and model inference undermines reproducibility, auditability, and traceability. What is needed is a formal boundary between deterministic execution and AI model invocation.

Third, conventional approaches to multi-agent AI orchestration use unstructured natural language messages or simple data-passing between agents, leading to redundant exchanges, duplicated computations, and inconsistent interpretations. Existing frameworks struggle to efficiently scale beyond small numbers of agents, and lack mechanisms for continuous self-improvement. What is needed is a structured communication and orchestration architecture capable of coordinating large numbers of AI agents with standardized knowledge sharing and automated agent evolution.

Fourth, AI-generated content produced at scale typically lacks structured provenance—there is no systematic way to identify which specific content elements were used in which outputs. When a specific element is later found to be defective, organizations must regenerate entire outputs from scratch because there is no mechanism for targeted, surgical correction. What is needed is a content lineage and provenance tracking system that enables selective updates across large asset libraries.

Accordingly, what is needed are improved techniques for AI-assisted content generation that address hallucination at both the process level and the content level, provide scalable multi-agent orchestration with structured communication, and enable provenance-tracked surgical updates across generated asset libraries.

The present techniques are a specific technical improvement over the applicant's own prior Path Large Language Model systems (U.S. Pat. No. 12,229,913) by introducing a hard syntactic boundary in the domain-specific language that forces deterministic execution of workflow steps while constraining probabilistic AI outputs to a finite, provenance-tracked genome catalog mined from approved reference assets. This dual-layer control is orchestrated by the Semantic Hypervisor described in the provisional application to which priority is claimed. The “domain-specific language” claimed herein (referred to conceptually
as the DNA Contract Language or DCL) represents the advanced, deterministic embodiment of the “path language representation” disclosed in the parent patent, and the “validated token catalog” is a highly structured repository storing “token sequences” formatted according to a “Semantic Normal Form (SNF)” as described in the provisional filing, thereby enforcing strict semantic normalization to ensure lossless interoperability among parallel AI agents. Furthermore, the “agent orchestrator” and “Semantic Hypervisor” function in tandem to execute the “Multi-Agent Orchestration” disclosed in the provisional by instantiating hardware-isolated execution environments, and the system's analysis of the “execution log” to automatically adapt deterministic workflow scripts fulfills the Automated Agent Design (ADAS) protocol described therein.

Part II of this disclosure describes a formalized path language for generating content such as videos, images, audio, or combinations thereof (e.g., interactive three-dimensional virtual environments). More specifically, Part II describes a core methodology for converting brand assets into structured path language representations for deterministic AI execution. Examples of specific techniques include conversion of visual assets into structured path representations, use of path integrals for content generation, and deterministic execution based on structured language representations.

Part III describes a multi-agent orchestration architecture configured to adaptively implement content generation techniques grounded in the formalized path language. More specifically, Part III describes a Meta-Agent Orchestrator for coordinating thousands of AI agents. Examples of specific techniques and mechanisms include Semantic Normal Form (SNF) for knowledge representation, Automated Agent Design (ADAS) for agent evolution, task partitioning, load balancing, parallel execution, and adaptive prompt construction.

Part IV extends the abstract “path language representations” of Part II to a concrete, rigorously-defined implementation and extend the multi-agent orchestration of Part III with comprehensive hallucination control. The theoretical description is supported by practical examples including multiple examples of DCL production files, many examples of genome primitives, and various examples of automated mining chains. Examples of specific techniques and mechanisms include providing the implementation mechanism for path language representations (DCL), defining the atomic units of paths as “genomes” (DNA AI), establishing the automated extraction methodology for approved genomes (Mining), implementing bidirectional hallucination prevention (Two-Way Control), creating a semantic hypervisor architecture for scalable orchestration (MetaForm), and enabling provenance-tracked mass updates via genome blacklisting. Together such techniques and mechanisms support commercially-critical mass content generation with efficient quality control.

### Part II—Path Large Language Model

### II.1. Introduction

Artificial intelligence systems are increasingly sophisticated and are being applied to content generation at industrial scale. However, conventional generative AI systems exhibit several fundamental limitations that prevent reliable deployment in production environments. Techniques and mechanisms described herein provide for the generation and presentation of interactive three-dimensional virtual environments, which are also referred to herein as MODs. An interactive three-dimensional virtual environment may include a virtual representation of a three-dimensional environment. The three-dimensional virtual environment may be populated by entities, such as avatars, animals, plants, objects, and the like. Some or all of these entities may be animated.

Although techniques and mechanisms described herein are described with respect to a three-dimensional virtual environment, as described in the application and as will be appreciated, such techniques and mechanisms are equally applicable to simpler use cases such as video generation, image generation, audio generation, or the generation of other types of content.

According to various embodiments, configuration information for presenting a three-dimensional virtual environment may be generated at least in part by a large language model based at least in part on user input, such as natural language. Some or all of the configuration information may be represented in a path large language model that serves as an embedding of the concepts for presenting the three-dimensional virtual environment.

According to various embodiments, the natural language input, which may include elements such as nouns, verbs, emoji, adjective, adverbs, and more may be used to generate one or more path large language model embeddings. For instance, a three-dimensional virtual environment may include a background setting, one or more entities, and a script governing actions that are performed by or on the entities within the environment when one or more triggering conditions are satisfied.

According to various embodiments, information for generating the three-dimensional virtual environment may then be provided to a client machine via the Internet. A user at the client machine may interact with the three-dimensional virtual environment, for instance via user input provided as text, voice, and/or touch. The three-dimensional virtual environment may then be updated at the client machine based on the input and in accordance with the configuration information.

Consider a user that would like to create an interactive three-dimensional virtual environment. Conventional approaches to creating an interactive three-dimensional virtual environment such as a game, simulation, or other such virtual environment involve complex tools such as game development studios, programming environments, and the like, which typically require specialized skills and experience to use effectively. Moreover, the use of such tools requires considerable time.

In contrast, techniques and mechanisms described herein provide for the creation of an interactive three-dimensional virtual environment based on user input provided in natural language, which may include voice input or text input. For instance, a user may simply describe one or more elements of a three-dimensional virtual environment, and the system may create the three-dimensional virtual environment automatically based on the input. For example, the user may describe the environment, one or more entities to be included within the environment, one or more actions or behaviors associated with the entities, one or more interactions between the entities, one or more interactions between the entities and the environment, or the like. Some such information may be provided at least in part using emojis, which may facilitate more nuanced characterization of the environment, the entities within the environment, and/or the actions performed by or on the entities.

Techniques and mechanisms described herein are directed toward utilizing a Path Large Language Model (PLLM) for tracking or managing the interactions of an avatar within an environment. This Path Language describes how an avatar interacts with various components within an embodied environment and how it is controlled, for instance by a human. Such techniques and mechanisms have a broad range of applications in complex task management, robotics, metaverses, video game playing, video game designing, and other tasks that require high-level interaction of an avatar within an embodied environment.

In some embodiments, a base or foundational Large Language Model (LLM) is fine-tuned to learn a new Path Language. Alternatively, a Path Language definition may be provided to an LLM in an input prompt, potentially along with one or more examples illustrating the usage of the Path Language. Regardless of the approach, the resulting model, which includes both the base or foundational LLM along with one or more elements associated with tuning the base or foundational LLM (e.g., one or more additional weights, hyperparameters, neural networks, etc.) and/or with definitions and examples for the Path Language within an input prompt, is referred to herein as a PLLM.

Artificial intelligence (AI) and machine learning (ML) technologies have advanced significantly over recent years, impacting diverse fields like natural language processing, image recognition, and game theory. Of particular interest are Large Language Models (LLMs) like GPT-4, which are capable of generating human-like text, understanding context, and responding to prompts intelligently. While these models offer impressive capabilities, their application to avatars has been relatively unexplored.

Existing models such as VOYAGER introduced the concept of LLM-powered embodied lifelong learning avatars, able to explore virtual environments like Minecraft continuously, developing skills and making consistent discoveries without human intervention. While these technologies marked significant strides in AI exploration and autonomy, their design has several limitations. For instance, their learning and operation heavily depend on predefined tasks or objectives, potentially limiting the avatar's capacity for creativity and unstructured learning. Furthermore, these technologies do not incorporate player or user interactions at a deep linguistic level, missing out on a rich dimension of environmental interaction and experience.

More recent AI technologies have explored the concept of reinforcement learning with reward functions to incentivize certain outcomes or behaviors. However, traditional approaches typically focus on simple, atomic actions and often struggle with complex tasks that involve many steps or high-level reasoning.

In contrast to conventional techniques, various embodiments of techniques and mechanisms described herein provide for sophisticated and capable avatars, which can learn from past experiences, predict future scenarios, and continually improve their interactions with their environment. Such techniques and mechanisms are applicable in a variety of contexts, including robotic automation, assistive technologies, and video game design and development. In these technical domains, the ability of an AI avatar that runs autonomously or is controlled by a user to learn and adapt to complex tasks, understand player or user interactions, and generate new environments or tasks can significantly improve the system's performance, versatility, and user experience.

In some embodiments, avatar-environment interaction tracking and task management may be performed via a Path Large Language Model (PLLM). The path language describes how an avatar interacts with different elements in an embodied environment as it is controlled by an external actor or acts autonomously. By utilizing the Feynman Path Integral concept, PLLM calculates the probability of successful paths or subpaths based on multiple observed paths. This formulation enhances the avatar's ability to understand and navigate complex, multi-step tasks, expanding its capabilities beyond existing models.

Techniques and mechanisms described herein refer to avatars. The term “avatar” refers to a virtual or physical entity under autonomous or external control. The avatar may be located within an embodied environment. The term “embodied environment” may refer to a physical or virtual environment.

In some environments, an “avatar” may not actually appear within an embodied environment. Instead, control may be achieved by, for instance, the user tapping, swiping, clicking, typing, conversing, controlling physical objects, or otherwise providing user input to interact with the embodied environment. In such configurations, the term “avatar” may refer, for instance, to the user's perspective of the embodied environment.

In some embodiments, an embodied environment may be a model of a physical environment. For instance, in a robotics context, one or more sensors may be used to construct a simulated model of a physical environment. Then, a model of a robot may be positioned within the simulated model. This embodied environment may be used to perform operations such as predicting the actions and behavior of entities within the physical environment, determining instructions (e.g., for movement) to provide to the robot, predicting the consequences of such instructions, and the like.

In some embodiments, an embodied environment may be an entirely virtual environment. For example, in a metaverse, avatars of humans may navigate a virtual environment and interact with other avatars and/or other aspects of the virtual environment based on user input. As another example, in a game, a human player may provide user input to control the actions of a virtual avatar within a virtual game environment.

For the purpose of exposition, consider the example of a virtual environment in the context of a game. In a game-playing scenario, a period of gameplay consists of a sequence of interactions that the avatar has with the environment. This sequence of interactions may be modeled as a path through the virtual environment, starting with a certain part of the environment and ending with a different part of the environment. The end point may be, for example, a goal, a failure condition, or some other terminating condition. The path may be determined based on user input.

As another example, consider a robot attempting to navigate a physical space to perform a task or complete an objective. To aid in instructing the robot, the robot and the physical space may be modeled as an avatar navigating a virtual space. In this context, a period of time may be modeled as a sequence of interactions that the avatar has with the virtual space. As with gameplay, this sequence of interactions may be modeled as a path through the virtual environment, starting with a certain part of the environment and ending with a different part of the environment. The end point may be, for example, the completion or failure of the task or objective.

According to various embodiments, the PLLM may employ a technique such as the Feynman path integral concept to compute the probability of paths or subpaths through an embodied environment. For instance, data may be gathered from multiple observed paths. Observed paths may be identified as successful paths or failed paths, or may be categorized or labeled in some other way. The avatar may not only move through the embodied environment, but may also interact with the environment. Accordingly, techniques and mechanisms described herein may be applicable to a wide range of applications, such as robotics and gaming, that feature high-interaction embodied environments.

Techniques and mechanisms described herein have a wide range of applications, for instance in the gaming and robotics industries. In some embodiments, for instance in the field of robotics, the PLLM may be employed to direct operations across various sectors, such as manufacturing, healthcare, and logistics. By learning from previous robotic operations and continuously adjusting decisions, the PLLM enhances efficiency and effectiveness in complex robotic tasks, contributing to improved outcomes and optimized processes.

In some embodiments, for instance in the gaming domain, the PLLM may be used to dynamically generate unique experiences based on previous interactions, adjusting the avatar's actions to maximize success, engagement, retention, or other desirable characteristics. For example, as more data is gathered, the game paths become richer and more informative, enabling game developers to gain insights into player behavior patterns, optimize game design, and create more immersive and engaging experiences. As another example, designers can interact with the PLLM, receiving valuable assistance in creating new games or modifying existing ones. For instance, the PLLM can generate new paths and interactions based on feedback and suggestions from designers, facilitating collaborative and iterative game development processes.

According to various embodiments, techniques and mechanisms described herein may be used in conjunction with any of a variety of LLM architectures, providing for enhanced versatility and adaptability of the system. By working with a wide range of LLM architectures, the PLLM can leverage the advancements and specific capabilities of different models, enhancing its overall performance and expanding its potential applications beyond gaming and robotics. This versatility enables various embodiments of techniques and mechanisms to be utilized in fields such as simulation and prediction models, risk assessment, autonomous vehicle navigation, and complex system management.

According to various embodiments, the PLLM may be constructed based not only on natural language, but also based on emoji. An emoji is a small digital image or icon used to express an idea, an emotion, an action, or some other concept. Emoji may be used to provide additional nuance in the definition of elements within the PLLM. For example, the word “happy” may encompass a range of gradations, whereas the Unicode includes many different emoji expressing various types and gradations of the emotion “happiness”.

According to various embodiments, an emoji may be used to define one or more elements of a PLLM. For instance, a verb, a noun, an adjective, an emotion, or an adverb may each be expressed as an emoji. As one example, an emoji may be used to identify an entity (i.e., a noun). Footballs, cats, and grapes are all examples of emojis corresponding to nouns. As another example, an emoji may be used to identify an action (i.e., a verb). Swimming, running, jumping, and dancing are all examples of emojis corresponding to actions. As yet another example, an emoji may be used to identify an adjective or an adverb. Happy, sad, and angry are all examples of emoji that may be used to modify a noun or a verb.

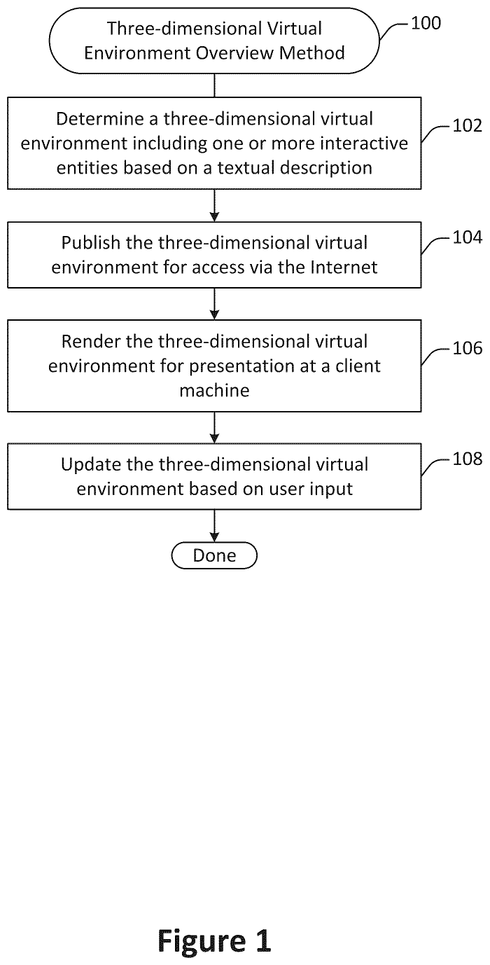

FIG. 1 illustrates an overview method 100 for providing a three-dimensional virtual environment, performed in accordance with one or more embodiments. The method 100 may be performed at any suitable computing system, such as a server system configured to construct the three-dimensional virtual environment based on interactions from a client machine and/or serve the three-dimensional virtual environment to a client machine via the Internet. An example of such a system is discussed with respect to Section 2.

A three-dimensional virtual environment including one or more interactive entities is determined at 102 based on a textual description. In some embodiments, the textual description may be provided via an interactive messaging interface. For instance, the textual description may be provided via an SMS message, an email message, a chat interface within a dedicated mobile application, a chat interface within a web application, or any other suitable mechanism for sending text-based messages.

According to various embodiments, the textual description may characterize the environment that is to be created. For instance, the textual description may describe the environment itself, one or more entities to include within the environment, one or more properties or characteristics of the entities, one or more interactions between the entities, one or more interactions between an entity and the environment, and/or any other attributes of the three-dimensional virtual environment.

In some embodiments, the three-dimensional virtual environment may be created based in part on additional information beyond the textual description. For example, a user may select, or the system may determine, a background environment in which to situate the entity or entities. As another example, a user may provide feedback, such as via a graphical user interface, to edit a three-dimensional virtual environment created by the system. Additional details regarding the configuration of a three-dimensional virtual environment are discussed throughout the application, for instance in Section 3.

The three-dimensional virtual environment is published for access via the Internet at 104. In some embodiments, publishing the three-dimensional virtual environment may involve any of various interactions for making the three-dimensional virtual environment accessible. For instance, the three-dimensional virtual environment may be stored in a manner accessible to a web server and addressable via a uniform resource locator (URL).

The three-dimensional virtual environment is rendered at 106 for presentation at a client machine. In some embodiments, rendering the three-dimensional virtual environment may involve transmitting one or more instructions from the server system to the client machine, for instance in response to a request by the client machine to access the three-dimensional virtual environment. The client machine may then execute the instructions to generate the three-dimensional virtual environment at the client machine. Additional details regarding a process for rendering a three-dimensional virtual environment at a client machine are discussed throughout the application, for instance in Section 4.

The three-dimensional virtual environment is updated at 108 based on user input. According to various embodiments, the user may interact with the three-dimensional virtual environment via touch input, voice input, text input, and/or any other process or mechanism for providing user input. Additional details regarding a process for animating entities within the three-dimensional virtual environment as well as updating a three-dimensional virtual environment based on user input are discussed throughout the application, for instance with respect to Section 4.

### II.2. System Architecture

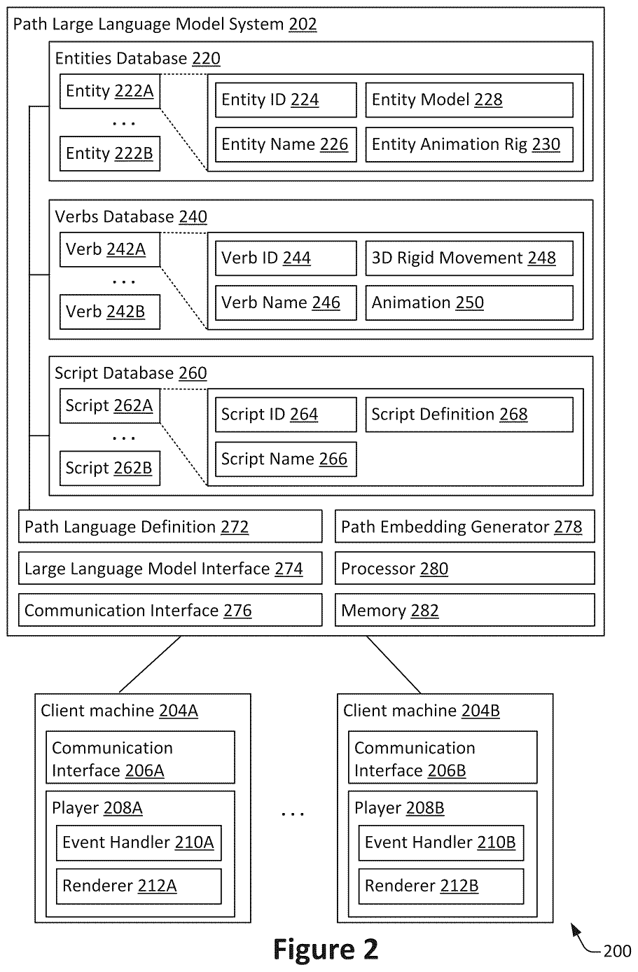

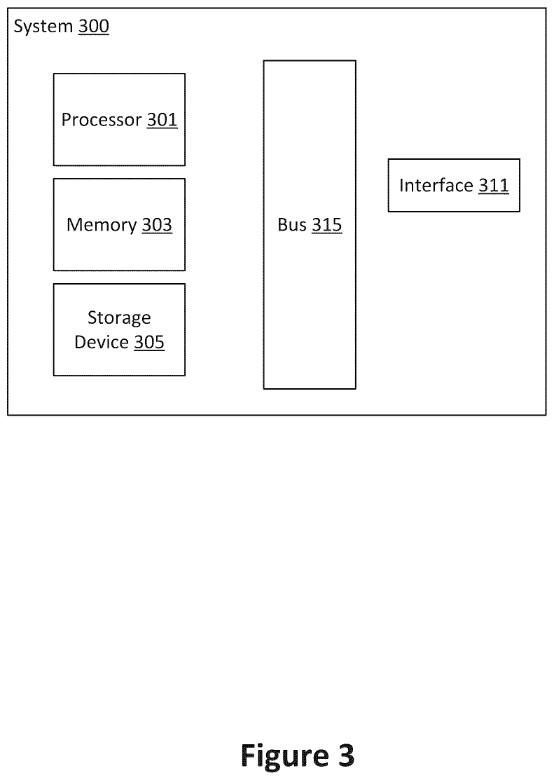

FIG. 2 illustrates a path large language model ecosystem 200, generated in accordance with one or more embodiments. The path large language model ecosystem 200 includes a path large language model system 202 in communication with one or more client machines 204A through 204B. The client machines include a client communication interface (206A, 206B) and a player (208A, 208B), which includes an event handler (210A, 210B) and a renderer 212B. The path large language model system 202 includes a path language definition 272, a large language model interface 274, a communication interface 276, a path embedding generator 278, a processor 280, and memory 282. The path language definition 272 may build upon entities and verbs stored in an entities database 220 and a verbs database 240. The entities database 220 includes entity database entries 222A through 222B. An entity database entry includes an entity ID 224, an entity name 226, an entity model 228, and an entity animation rig 230. The verbs database 240 includes verb database entries 242A through 242B. A verb database entry includes a verb ID 244, a verb name 246, a 3D rigid movement 248, and optionally an animation 250. The path language definition 272 may define a three-dimensional virtual environment using a script and store the script in a script database 260. The script database 260 may include script database entry 262A through 262B. A script database entry may include a script ID 264, a script name 266, and a script definition 268.

According to various embodiments, a client machine 204A may be any computing device capable of communicating with the path large language model system 202 via the Internet. For example, the one or more client machines 204A may be a mobile phone, a desktop computer, a tablet, a laptop computer, or any other suitable computing device. The one or more client machines 204A may communicate with the path large language model system 202 via the communication interface 206A.

In some embodiments, a client machine 204A may use a player 208A to present a three-dimensional virtual environment. Presenting a three-dimensional virtual environment may include operations such as rendering elements of the three-dimensional virtual environment for presentation on a display screen at the client machine, receiving user input, and updating the three-dimensional virtual environment based on the user input.

According to various embodiments, the client machine 204A may be configured to receive user input in any of various ways. For instance, the client machine 204A may receive user input via text, voice, and/or touch screen input. In some configurations, more than one type of user input may be employed in combination.

According to various embodiments, user input may be received at the client machine 204A to configure and/or interact with a three-dimensional virtual environment. For example, to present a three-dimensional virtual environment, the communication interface 206A may receive a script definition and supporting elements such as one or more three-dimensional model files, image files, audio files, and/or other media from the path large language model system 202. The renderer 212A may then render the three-dimensional virtual environment based on the script definition. User input may be processed via the event handler 210A to determine one or more instructions for updating the three-dimensional virtual environment. A visual and/or audio presentation of the three-dimensional virtual environment may then be updated by the renderer 212A based on the one or more instructions.

According to various embodiments, the player 208A may be configured to execute a script defined based on the path large language model in conjunction with user input received at the client machine to update the presentation of the three-dimensional virtual environment. For instance, an initialized three-dimensional virtual environment may include some number of entities positioned within, and potentially performing actions within, the three-dimensional virtual environment. The user may then provide user input to affect the three-dimensional virtual environment. The event handler 210A may process the user input to update the state of the three-dimensional virtual environment as well as evaluate the state of the three-dimensional virtual environment to determine whether an event defined in the script has occurred. When an event has occurred, the state of the three-dimensional virtual environment may be further updated. The updated state of the three-dimensional virtual environment may then be provided to the renderer 212A for updating the presentation of the three-dimensional virtual environment on a display device at the client machine.

According to various embodiments, the client machine 204A may include one or more components omitted from FIG. 2 for brevity. For example, the client machine 204A may include one or more processors, memory modules, communication busses, user input devices, display screens, speakers, and/or other components. Additional details regarding such components are discussed with respect to the computing device shown in FIG. 3.

According to various embodiments, the path large language model system 202 may be implemented on any of various combinations of computing hardware. For instance, the path large language model system 202 may be implemented on one or more computing devices in a cloud computing system.

In some embodiments, the path large language model system 202 may communicate with a client machine via the communication interface 276. For instance, the path large language model system 202 may interact with a client machine to generate a three-dimensional virtual environment and/or present a three-dimensional virtual environment at the client machine. Such operations may be performed via one or more processors 280 and one or more memory modules 282.

According to various embodiments, the path embedding generator 278 may generate scripts and/or path language embeddings based on user input. For instance, the path embedding generator may receive user input such as text, video, and/or voice via the communication interface 276, and generate a script that reflects the user input. The script may be generated in accordance with the path language definition 272, which may facilitate the presentation of a three-dimensional virtual environment.

The path language definition 272 may be used to specify a script for presenting a three-dimensional virtual environment. A script may be stored as an entry in the script database 260. Such an entry may include a script name 266 that characterizes the script and a unique script ID 264 for accessing the script entry in the script database 260. The script database entry may also include a script definition 268.

According to various embodiments, a script definition 268 may define a three-dimensional virtual environment in a manner consistent with the path language. A script may be stored as a JSON object or any other structured data object.

According to various embodiments, a script definition 268 may include configuration information for presenting the three-dimensional virtual environment. For example, a script definition may specify a background setting for the three-dimensional virtual environment. As another example, a script definition may specify three-dimensional virtual environment setup information such as initial locations and poses for entities within the background setting. As yet another example, a script definition may include one or more events for updating the three-dimensional virtual environment.

According to various embodiments, an event included within a script may specify any of various elements. For example, an event may specify a triggering condition for triggering the event. As another example, an event may specify an action that occurs when the event is triggered. As yet another example, an event may specify one or more actors to whom the action happens.

According to various embodiments, one or more elements within a script, such as an event, may be specified in terms of entities, verbs, adjectives, adverbs, and/or other elements within a path language definition. For example, an actor may be specified based on an entity ID 224A identifying an entity database entry 221A in the entities database table 220. As another example, an action performed by or on an entity may be specified as a verb ID 244 corresponding with a verb database entry 242 included in the verbs database table 240.

According to various embodiments, the entities database 220 may store information about entities that can be represented in a three-dimensional virtual environment. Such entities need not necessarily be predetermined, but rather can be dynamically created based on user input. The creation of entities is discussed in additional detail in Section 3.

In some embodiments, an entity may be associated with an entity ID 224 that uniquely identifies the entity. The entity may also have an entity name 226 that characterizes the entity. The entity model 228 may be a three-dimensional model that is used to represent the entity in the three-dimensional virtual environment. An entity may be associated with an entity animation rig 230 that is used to animate the entity. As discussed with respect to Section 3 and Section 4, various kinds of entities, including entities representing objects traditionally considered inanimate, may be animated and interacted with in accordance with techniques and mechanisms described herein.

According to various embodiments, the verbs database 240 may store information about actions that can be performed by or to entities within a three-dimensional virtual environment. A verb may be associated with a verb ID 244 that uniquely identifies the action. The verb may also have a verb name 246 that characterizes the action.

According to various embodiments, the 3D rigid movement 248 includes information for specifying how an entity model performing the action is to be moved in the three-dimensional virtual environment when the action is performed. The 3D rigid movement 248 may identify a movement through space of a center of mass associated with the three-dimensional model. For instance, a verb such as “walking” may be associated with 3D rigid movement information 248 that identifies a moving through space of the center of mass.

In some embodiments, a three-dimensional virtual environment may optionally be associated with an animation 250. The animation may be specified as a movement through space of one or more joints of the three-dimensional model relative to the center of mass. For instance, a verb such as “walking” may be associated with deformation of the entity model in a manner corresponding to walking. For instance, an entity animated using a human animation rig may include portions corresponding to legs, arms, head, and body. The animation information 250 may specify how such elements are to be moved when performing the action associated with the verb 242A.

In particular embodiments, an animation may be a superposition of other animations. For example, animations corresponding to walking and spinning may be combined to create a new type of movement.

According to various embodiments, various types of verbs are possible. Examples of verbs may include, but are not limited to: playing a sound, playing a music file, showing an image, playing a clip (e.g., graphics interchange format “GIF” file, a Giphy, a sticker, or another type of brief animation), playing a video, and/or animation via an animation rig.

According to various embodiments, potentially any entity may perform potentially any verb. For example, any entity may play a sound or a music clip simply by producing the audio. As another example, any entity may show an image or a video by projecting the image or video onto a side or surface of the entity by changing the texture in three dimensions. For instance, an image or video may be scaled or distorted to appear to be located on the side of a building, a bookshelf, an animal, or any other entity.

According to various embodiments, a verb may be modified by a modifier such as an adverb, which may represented text and/or an emoji. For example, an adverb such as “slowly” may be applied to the playing of a sound to indicate that the sound should be played slowly. Similarly, the adverb “slowly” may be applied to a walking animation to reduce the speed through space (i.e., the 3d rigid movement speed) and the animation speed of the animation.

In some embodiments, a verb may be specific to a particular entity animation rig. For example, some verbs may include 3D rigid movement and/or animation information specific to a default human animation rig. However. Other verbs may include 3D rigid movement and/or animation information specific to other animation rigs, such as rigs that are specific to particular entities. Thus, a verb database entry 242A may include other information not shown in FIG. 2, such as an entity animation rig identifier.

More generally, the path large language model system 202 may include various information not explicitly shown in FIG. 2 for the purpose of brevity. For example, the path large language model system 202 may include one or more repositories storing information related to background settings, adjectives, adverbs, and/or other such information associated with a path language definition 272. Such information is discussed in additional detail in Section 5. As another example, the path large language model system 202 may store information about user accounts and the users associated with user accounts. For instance, a three-dimensional virtual environment may be linked with a user account associated with its creation.

FIG. 3 illustrates one example of a computing device, configured in accordance with one or more embodiments. According to various embodiments, a system 300 suitable for implementing embodiments described herein includes a processor 301, a memory module 303, a storage device 305, an interface 311, and a bus 315 (e.g., a PCI bus or other interconnection fabric.) System 300 may operate as variety of devices such as one or more components of a path large language model system 202, a client machine (204A, 204B), or any other device or service described herein. Although a particular configuration is described, a variety of alternative configurations are possible. The processor 301 may perform operations such as those described herein. Instructions for performing such operations may be embodied in the memory 303, on one or more non-transitory computer readable media, or on some other storage device. Various specially configured devices can also be used in place of or in addition to the processor 301. The interface 311 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

### II.3. Configuring a Three-Dimensional Virtual Environment

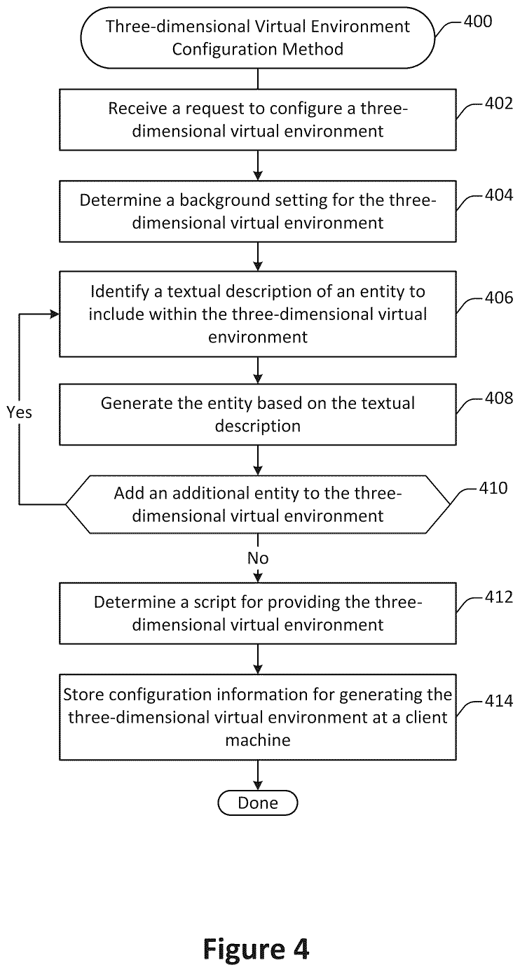

FIG. 4 illustrates a method 400 for configuring a three-dimensional virtual environment, performed in accordance with one or more embodiments. The method 400 may be performed at any suitable computing system, such as a server system configured to construct the three-dimensional virtual environment based on interactions from a client machine and/or serve the three-dimensional virtual environment to a client machine via the Internet. An example of such a system is discussed with respect to Section 2.

A request to configure a three-dimensional virtual environment is received at 402. According to various embodiments, the request may be received at the server system via any of various communication channels. Examples of such channels may include, but are not limited to: a mobile application, a web application, a messaging service, and combinations thereof.

The request may be received from a client machine in communication with the server system. According to various embodiments, any of a variety of client machines may be employed. For instance, the client machine may be a mobile device, a desktop computer, a tablet computer, a laptop computer, or any other type of computing device capable of communicating with the server system.

In some embodiments, the request may include input for determining some or all of the information discussed with respect to the method 400. Alternatively, or additionally, some or all of the information discussed with respect to the method 400 may be determined later, for instance via interaction between the server system and a client machine.

A background setting for the three-dimensional virtual environment is determined at 404. According to various embodiments, the background setting may include elements such as background scenery, structural objects, and the like for providing a three-dimensional virtual environment. For example, the background setting may specify imagery corresponding to background scenery such as a city scape, a natural landscape, a building interior, or other such surroundings for providing a three-dimensional virtual environment. As another example, the background setting may include one or more stationary foreground elements such as rocks, lakes, rivers, water, bridges, trees, buildings, or the like that may serve as obstacles, occlusions, or other aspects of the three-dimensional virtual environment.

In some embodiments, the background setting may be selected based on user input. For example, the user may select a background setting from a set of preconfigured background settings. As another example, a background setting may be generated automatically based on a textual description of the background setting. As yet another example, a background setting may be provided by a user, for instance in the form of a three-dimensional model and/or other elements.

A textual description of an entity to include within the three-dimensional virtual environment is identified at 406. In some embodiments, the textual description may be provided as part of the request received at 402 or may be provided as part of an interactive design process in which the user participates. The textual description may describe any object or collection of objects that may be represented in a virtual world. For example, the textual description may state: “Add a book that is walking down the street but jumps when it gets wet”, “The video should have a box that hip-hop dances when the music plays”.

In some embodiments, the text may include one or more emojis. An emoji may be specified in Unicode, text convention, or a different (e.g., proprietary) encoding. Emoji-based input may facilitate more nuanced descriptions of objects and their properties and actions. For example, a textual description without emoji may state “Add a book. It does not like water.” However, an emoji may be used to more easily and accurately specify the book's precise reaction to water. For instance, in the Unicode specification, the emoji “U+1F62C” corresponds to a grimacing face, the emoji “U+1F644” corresponds to a face with rolling eyes, the emoji “U+1F92F” corresponds to an exploding head, and the emoji “U+1F620” corresponds to an angry face. In the absence of an emoji, the system may have difficulty determining a user's intent from the sentence “It does not like water.” However, the use of emoji allows the user to more precisely specify the entity's reaction to water. Thus, the user may provide text input such as: “Add a U+1F4D6 that U+1F620 if it gets wet,” where “U+1F4D6” is the emoji corresponding to an open book.

According to various embodiments, a user may specify an emoji in any of various ways. For example, an emoji may be specified by selecting it, for instance in a client-side and/or server-provided user interface component. Such emoji may then be converted to Unicode when the input is analyzed as text. As another example, an emoji may be specified by using text corresponding to an emoji, such as “:-)” for “happy”. Such input may be left alone in text or may be converted to Unicode, depending on whether a suitable conversion is available. As yet another example, an emoji may be specified directly as Unicode by the end user.

The entity is generated at 408 based on the textual description of the entity. According to various embodiments, the entity may be generated based on a description of the entity provided in natural language and/or one or more emoji.

In some embodiments, the natural language and/or emoji may include one or more characteristics for animating the three-dimensional model are determined. In some embodiments, characteristics for animating the three-dimensional model may be determined based on the textual input provided by the user. For example, the user may describe an entity as “happy”, “sad”, or “in a hurry” via text. As another example, the user may provide one or more emoticons characterizing an emotion or other characteristic to be exhibited by the entity. Such information may then be included the entity configuration information.

According to various embodiments, the characteristics for animating the three-dimensional model may include information such as an initial location for positioning the three-dimensional model, an initial pose for rendering the three-dimensional model, a description of the manner in which the three-dimensional model is to be animated, and/or any other information related to the rendering of the three-dimensional model.

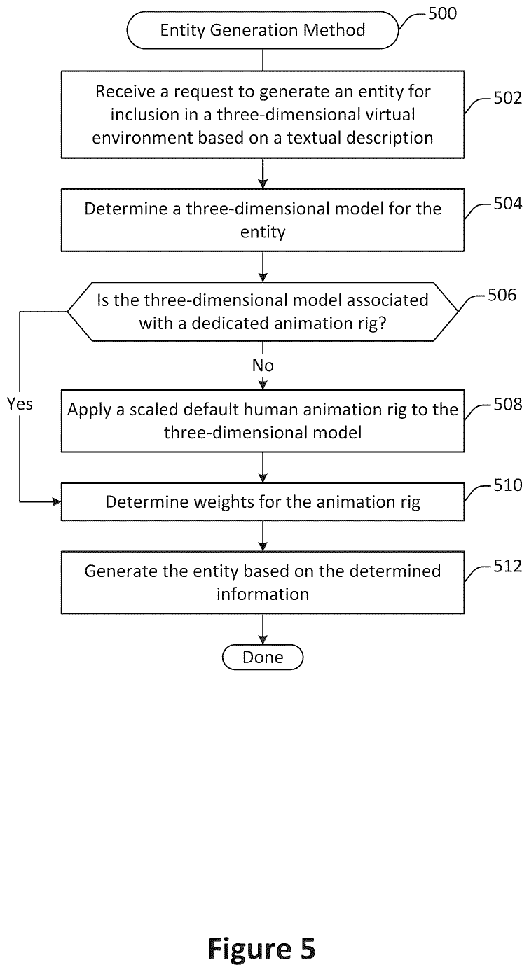

In some embodiments, the natural language and/or emoji may include one or more characteristics for interacting with the entity. The one or more characteristics for interacting with the entity may include ways in which the entity responds to user input. For instance, an entity that “likes” water may smile or clap when it gets wet, while an entity that “hates” water may frown or get angry in the same situation. As with the one or more characteristics determined at 2012, such information may be determined based on textual input provided by the user. Additional details regarding a process for generating an entity are discussed with respect to the method 500 shown in FIG. 5.

A determination is made at 410 as to whether to add an additional entity to the three-dimensional virtual environment. In some embodiments, the determination may be made based on user input. For instance, the user may indicate that all desired entities have been added. Alternatively, or additionally, the determination may be made based at least in part on an analysis of user input text that is used to create multiple entities in sequence or in parallel. For example, a user may provide input such as “The video should have a box that hip-hop dances when the music plays and a book that is walking down the street but jumps when it gets wet”, which may cause the system to add two entities corresponding with the box and the book.

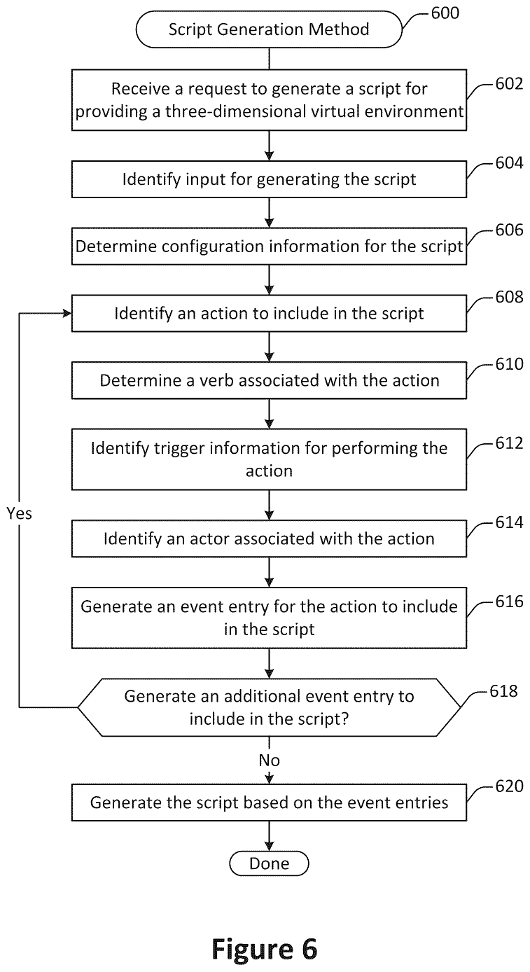

In particular embodiments, two or more entities may be determined at the same time based on analysis by a generative language model. For instance, a generative language model may be provided with an input prompt that includes the user input and one or more natural language instructions to generate the entity. Additional details regarding such operations are discussed with respect to the method 600 shown in FIG. 6.

A script for providing the three-dimensional virtual environment is determined at 412. According to various embodiments, the script may include one or more events for updating the three-dimensional virtual environment over time. For instance, events may be triggered based on user input, conditions that independently arise within the three-dimensional virtual environment, and/or other information. Additional details regarding the determination of a script are discussed with respect to the method 600 shown in FIG. 6.

Configuration information for generating the three-dimensional virtual environment at a client machine is stored at 414. According to various embodiments, the configuration information may be stored in any suitable location, such as a database system or other storage system accessible to the server system. The configuration information may include any of the information determined as discussed with respect to the method 400. Such information may include, but is not limited to: user input, information identifying the background setting for the three-dimensional virtual environment, one or more models or images associated with entities to include within the three-dimensional virtual environment, a script for governing the three-dimensional virtual environment, three-dimensional virtual environment metadata such as a URI, a name, or a unique identifier, other path language embedding information for the three-dimensional virtual environment, and/or any other relevant information.

FIG. 5 illustrates a method 500 of generating an entity, performed in accordance with one or more embodiments. The method 500 may be performed at any suitable computing system, such as a server system configured to construct the three-dimensional virtual environment based on interactions from a client machine and/or serve the three-dimensional virtual environment to a client machine via the Internet. An example of such a system is discussed with respect to Section 2.

A request to generate an entity for inclusion in a three-dimensional virtual environment based on a textual description is received at 502. In some embodiments, the request may be generated as discussed with respect to the operation 308 discussed with respect to the method 300 shown in FIG. 3. The request may include or identify the textual description.

A three-dimensional model for the entity is determined at 504. According to various embodiments, the three-dimensional model may be determined in any of various ways. For example, the system may search an internal database of three-dimensional models. As another example, the system may search the Internet, for instance via a general web search or a publicly available database of models, to identify a suitable three-dimensional model. As yet another example, the user may select or provide a three-dimensional model.

In some embodiments, a search query may be determined based on a prompt provided to a generative language model. For example, the generative language model may be provided within an input prompt that includes the user input and a natural language instruction to provide a search query for identifying a three-dimensional model that reflects the user's intent.

In some implementations, one or more machine learning models may be used to select a three-dimensional model. For instance, images of models returned via search results may be evaluated by a pre-trained machine learning classification model to select a model that best matches the search query.

A determination is made at 506 as to whether the three-dimensional model is associated with a dedicated animation rig. The term “animation rig” refers to a division of a three-dimensional model into independently mobile components for the purpose of animating the three-dimensional model. Some three-dimensional models, such as standardized models associated with humans, animals, and the like may include such a rig. However, other such three-dimensional models, particularly those associated with objects traditionally considered inanimate, such as rocks, may lack a dedicated animation rig.

Upon determining that the three-dimensional model is not associated with a dedicated animation rig, a scaled default human animation rig is applied to the three-dimensional model at 508. Applying the scaled default human animation rig may involve, for instance, dividing the three-dimensional model into regions roughly corresponding with the independently movable portions of the default human animation rig, scaled to fit the virtual space occupied by the three-dimensional model. Such operations are discussed in more detail in Section 4.

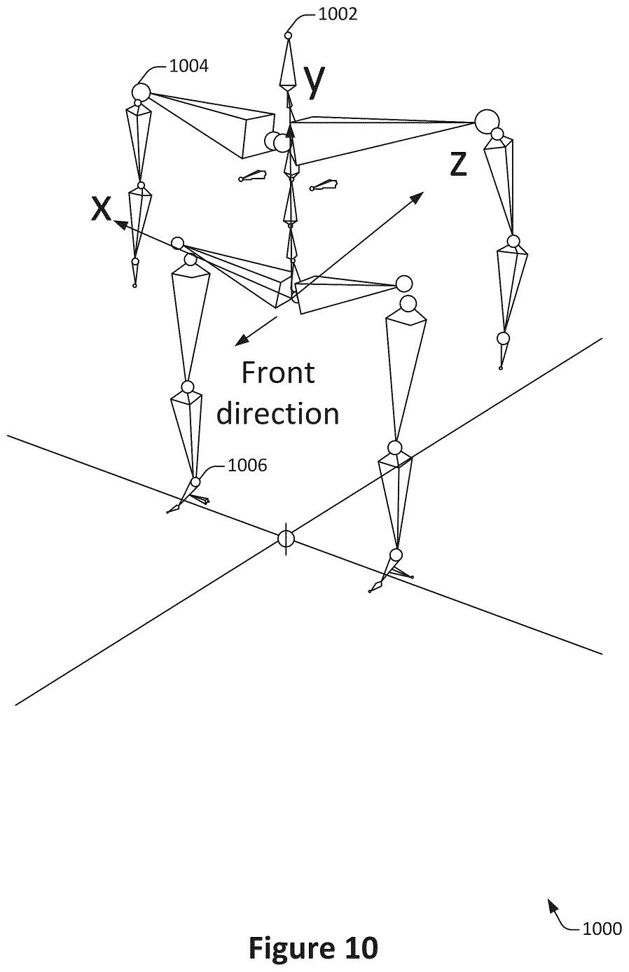

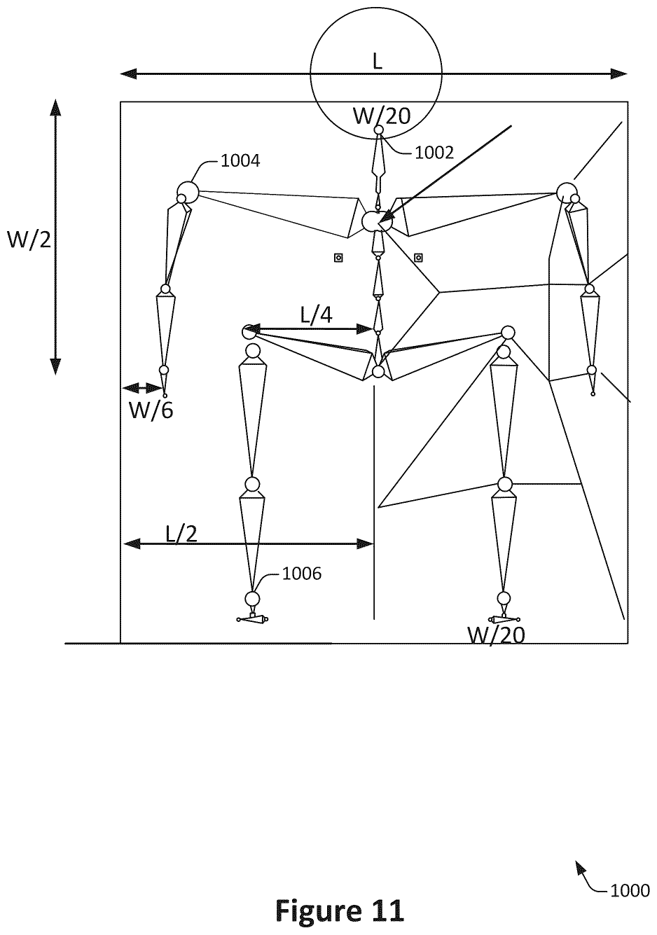

FIG. 10 and FIG. 11 illustrate views of a default human animation rig 1000, provided in accordance with one or more embodiments. According to various embodiments, an animation rig may include some number of joints. For example, the default human animation rig 1000 includes the joint 1002 corresponding to the top of the human head, the joint 1004 corresponding to the top of the right human shoulder, and the joint 1006 corresponding to the heel of the right human foot, among other joints.

In some embodiments, as shown in FIG. 10, the rig may be defined in a three-axis coordinate system allowing the joints to be repositioned in space to illustrate animation. When the joints are repositioned, rendering the three-dimensional model may involve repositioning and/or distorting the portions of the model connecting the joints in accordance with the joint locations.

According to various embodiments, a default animation rig may be applied to any three-dimensional model by scaling it to fit the shape of the three-dimensional model. For instance, as shown in FIG. 11, if the height of the three-dimensional model is parameterized as W, then the head joint may be located on the midline from left to right at a distance of W/20 from the top of the model. Similarly, the right hip joint 1008 may be positioned at a distance of L/4 from the midline, where the width of the three-dimensional model is parameterized as L.

To aid in clarity, only a few of the specific joint vertices and their corresponding parameterized locations are not specifically called out in FIG. 10 and FIG. 11. According to various embodiments, the specific joint vertices employed, as well as their locations within the rig, may be dependent on the particular rig that is employed.

In some embodiments, a single default (e.g., human) animation rig may be used for any three-dimensional model not already associated with a dedicated animation rig. Alternatively, one or more type-specific three-dimensional models may be employed. For instance, an entity of the class of “four-legged animals” may be assigned an animation rig associated with four-legged animals, while an entity of the class “bird” may be assigned an animation rig associated with birds. In this way, any entity may be animated through use of a default rig, but the animation various types of entities may also be improved through the use of model-specific or type-specific animation rigs.

Returning to FIG. 5, weights for the animation rig are determined at 510. In some embodiments, the weights for the animation rig may be determined based on any of a variety of approaches. For example, the weights may be determined via skinning or vertex weighting. As a more specific example, an approach such as Linear Blend Skinning may be employed. Additional details are discussed in Magnenat-Thalmann, N., & Thalmann, D. (1988), “Human body deformations using joint-dependent local operators and finite element theory”, which is hereby incorporated by reference in its entirety and for all purposes.

The entity is generated at 514 based on the determined information. In some embodiments, generating the entity may involve defining configuration data such as an initial location of the entity within the three-dimensional virtual environment, a three-dimensional model for the entity, an animation rig for the entity, one or more weights for the animation rig, and any other information.

In some embodiments, the generation of an entity for inclusion in a three-dimensional virtual environment may include one or more operations not shown in FIG. 5. For example, a generative language model may analyze the textual description and generate a response message to a user to elicit additional information, such as a clarification regarding the user's intent. For instance, consider a sentence such as “The chicken is ready to eat.” Such a sentence is ambiguous, since it is unclear whether the user intends to convey that (1) the chicken is ready to eat something or that (2) the chicken is ready to be eaten. In the event that such ambiguity is unclear from context, the user may be asked to provide additional input clarifying the meaning reflected in the user input.

FIG. 6 illustrates a method 600 for generating a script governing a three-dimensional virtual environment, performed in accordance with one or more embodiments. The method 600 may be performed at any suitable computing system, such as a server system configured to construct the three-dimensional virtual environment based on interactions from a client machine and/or serve the three-dimensional virtual environment to a client machine via the Internet. An example of such a system is discussed with respect to Section 2.

A request to generate a script for providing a three-dimensional virtual environment is received at 602. In some embodiments, the request may be generated as discussed with respect to the operation 412 shown in FIG. 4.

Input for generating the script is identified at 604. According to various embodiments, the input may include user input provided by a user. Such input may include, but is not limited to: natural language text, voice input transcribed to text, one or more emojis, one or more image files, one or more video files, one or more audio files, and/or any other information. Such information may be provided at a client machine and transmitted to the path large language model system 202 via the Internet.

Configuration information for the script is determined at 604. According to various embodiments, the configuration information may include data such as a script name, a unique identifier for the script, a URI for accessing the script, an author of the script, or the like.

An action to include in the script is identified at 608. The action may be determined by parsing the user input. For instance, natural language in the user input may be parsed to identify words associated with actions, such as verbs.

A verb associated with the action is determined at 610. In some embodiments, the verb associated with the action may be determined by using one or more words associated with the action to search the verb database for one or more matching entries. The verb may be specified as an identifier associated with an entry in the verbs database 240.

Trigger information for performing the action is identified at 612. In some implementations, the trigger information may be determined by parsing the user input to identify explicitly conditional words such as “when” and “if”. Alternatively, or additionally, the trigger information may be determined by parsing the user input to identify implicit conditions, such as preferences or characteristics. For instance, a phrase such as “likes apples” or a smiling emoji combined with an apple emoji may be used to infer that an entity should exhibit a positive emotion when it encounters an apple. The triggering information may be specified as an event defined in accordance with the path large language model definition.

An actor associated with the action is identified at 614. In some embodiments, the actor may be an entity discussed with respect to the method 400 as being included in the three-dimensional virtual environment. Such an entity may be included at the time that the three-dimensional virtual environment is initialized or may be introduced later, for instance as the result of performing an action. The actor may be identified via an entity ID 224 included in an entity database entry in the entities database 220.

An event entry for the action is generated at 616. In some embodiments, the event entry may include structured text that contains the information determined at operations 608, 612, and 614. For instance, the event entry may be an entry in a JSON object that includes elements for one or more actors, triggers, and/or actions.

In particular embodiments, an element included within an event entry may include one or more arguments. Such arguments may correspond to characteristics such as adverbs, adjectives, or other modifiers to provide for a more nuanced action. Such information may be provided as text or may be provided as an identifier associated with an adverb, adjective, or other modifier included within the path large language model definition.

A determination is made at 618 as to whether to generate an additional event entry to include in the script. In some embodiments, the determination may be made based on whether the user input identifies any additional action-related information for governing the three-dimensional virtual environment.

Upon determining not to generate an additional event entry, the script is generated at 620 based on the event entries. In some implementations, generating the script may involve creating a file or string that includes the event entries generated at 616. The file or string may include additional information, such as the configuration information determined at 606.

Although the method 600 is shown for the purpose of illustration as being a linear process executed as a distinct series of steps, in some configurations one or more of the operations shown in FIG. 6 may be performed in parallel or in a different sequence. For example, some or all of the operations shown in FIG. 6 may be performed by a generative language model by completing an input prompt to generate novel text corresponding to all or a portion of the script. For example, a script generation input prompt may include natural language instructions for generating the script, information pertaining to one or more entities or verbs that may be included within the script, and user input and/or other dynamically determined instructions for generating the script. The generative language model may then determine novel text corresponding to the events determined as discussed with respect to the method 600 shown in FIG. 6.

### II.4. Rendering a Three-Dimensional Virtual Environment

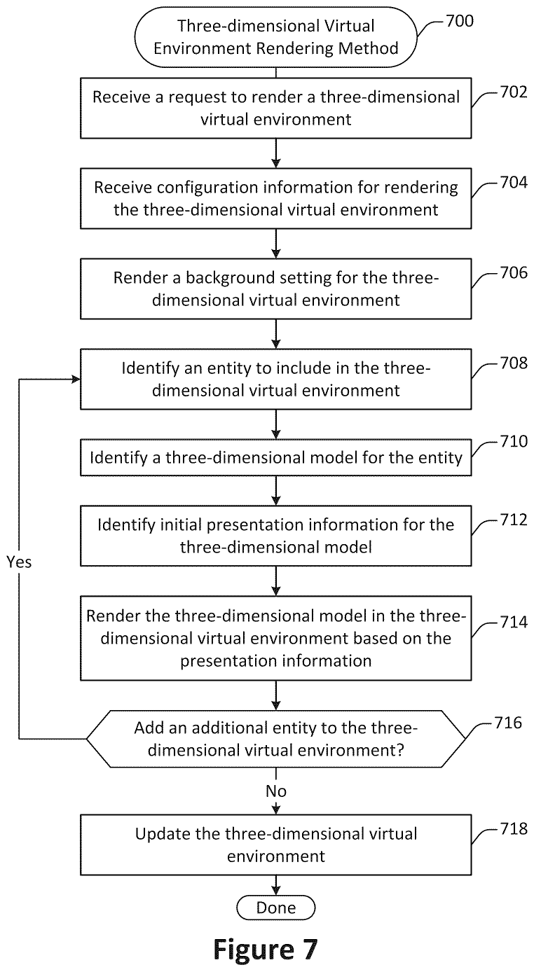

FIG. 7 illustrates a method 700 of rendering a three-dimensional virtual environment, performed in accordance with one or more embodiments. The method 700 may be performed at any suitable computing system, such as client machine in communication with a server system configured to construct the three-dimensional virtual environment based on interactions from a client machine and/or serve the three-dimensional virtual environment to a client machine via the Internet. An example of such an ecosystem is discussed with respect to Section 2.

A request to render a three-dimensional virtual environment is received at 702. In some embodiments, the request may be generated when a client machine visits a URL associated with a three-dimensional virtual environment. For instance, the URL may include an identifier uniquely identifier the three-dimensional virtual environment. Alternatively, the request may be generated when a dedicated mobile application at a client machine accesses a three-dimensional virtual environment through a communication interface.

Configuration information for rendering the three-dimensional virtual environment is received at 704. In some embodiments, the configuration information may be transmitted from the path large language model system 202 to the client machine in response to a request from the client machine. The configuration information may include data such as a background setting, one or more entity models, one or more animation rigs, and/or one or more scripts for providing the three-dimensional virtual environment.

A background setting for the three-dimensional virtual environment is rendered at 706. In some embodiments, the background setting may be rendered by the renderer 212A, which may be configured to produce a visual representation of a three-dimensional virtual environment.

An entity to include in the three-dimensional virtual environment is identified at 708. The entity may be identified based on an identifier included in the configuration information received at 704.

A three-dimensional model for the entity is identified at 710. In some embodiments, the three-dimensional model may be included in the configuration information received at 704. The three-dimensional model may be identified based on the entity identifier.

Presentation information for the three-dimensional virtual environment is identified at 712. In some implementations, the presentation information may be included in the configuration information received at 704. The presentation information may include, for instance, a characterization of an initial location within the three-dimensional virtual environment, an initial pose for the three-dimensional model, an initial action being performed by the three-dimensional model, and/or any other such information for initially rendering the three-dimensional virtual environment.

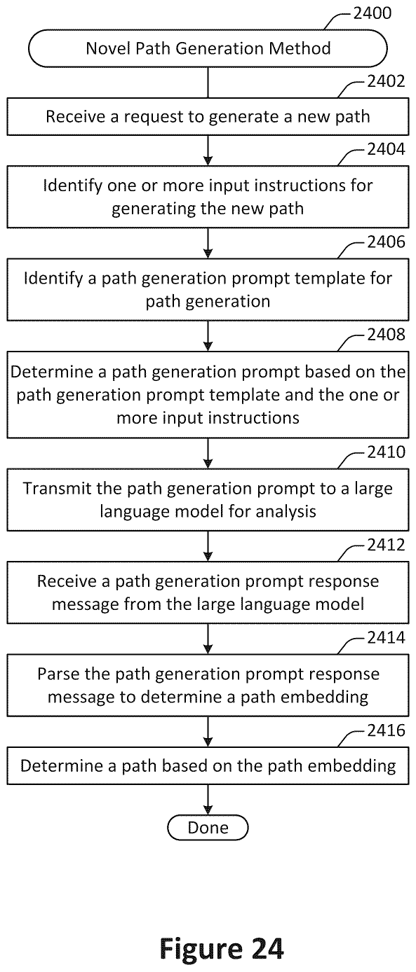

The three-dimensional model is rendered in the three-dimensional virtual environment at 714 based on the presentation information. For instance, the three-dimensional model may be located at a particular location within the three-dimensional virtual environment and arranged in a particular pose while performing a particular action, as discussed with respect to the operations 710j and 712. The rendering may be performed by the renderer 212A, which is configured to determine a visual representation of the three-dimensional virtual environment based on the background setting, one or more three-dimensional models, and the presentation information. Additional details regarding a method for rendering a three-dimensional model are discussed with respect to the method 2400 shown in FIG. 24.

A determination is made at 716 as to whether to add an additional entity to the three-dimensional virtual environment. In some embodiments, additional entities may be added until all entities in the configuration information received at 704 identified for initial presentation in the three-dimensional virtual environment have been rendered.

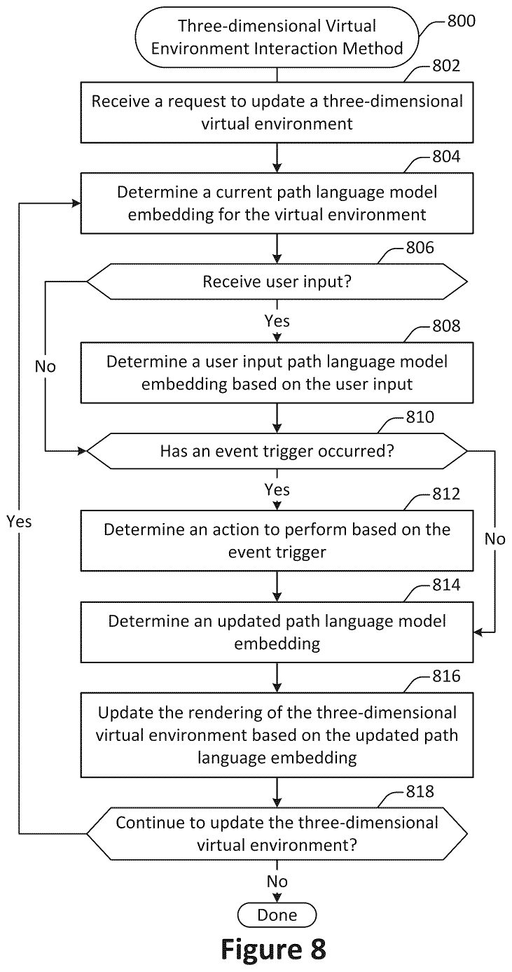

Upon determining not to add an additional entity to the three-dimensional virtual environment, the three-dimensional virtual environment is updated at 718. According to various embodiments, the three-dimensional virtual environment may be updated based on a script included in the configuration information received at 704 in conjunction with user input received at the client machine. Additional details regarding a process for updating the three-dimensional virtual environment are discussed with respect to the method 800 shown in FIG. 8.

According to various embodiments, one or more of the operations shown in FIG. 7 may be performed in an order different than that shown. For instance, two or more entities may be rendered in parallel by the renderer.

FIG. 8 illustrates a method 800 of updating a three-dimensional virtual environment, performed in accordance with one or more embodiments. The method 800 may be performed at any suitable computing system, such as client machine in communication with a server system configured to construct the three-dimensional virtual environment based on interactions from a client machine and/or serve the three-dimensional virtual environment to a client machine via the Internet. An example of such an ecosystem is discussed with respect to Section 2.

A request to update a three-dimensional virtual environment is received at 802. In some embodiments, the request may be generated as discussed with respect to the operation 718 shown in FIG. 7.

A current path language model embedding for the three-dimensional virtual environment is determined at 804. In some embodiments, the current path language model embedding may describe a current state of the three-dimensional virtual environment. For instance, the path language embedding may include details such as the locations, poses, actions, and histories of entities within the three-dimensional virtual environment. Additional details regarding a path language model are discussed in Section 5.

In some implementations, the initial path language model embedding may simply reflect the state of the three-dimensional virtual environment at the time the three-dimensional virtual environment is initialized. For instance, the initial path language model embedding may specify the initial locations, poses, and actions being performed by the entities at the time the three-dimensional virtual environment is initialized. However, if the three-dimensional virtual environment has been updated after initialization, for instance based on user input, the path language model embedding may be updated to reflect the changes.

A determination is made at 806 as to whether input has been received. According to various embodiments, user input may be provided in any of various ways. Examples of suitable channels for providing user input include, but are not limited to: text, emoji, voice, other audio, images, videos, touch, and mouse clicks. For example, a three-dimensional virtual environment may permit a user to throw a water balloon at a moving target. Depending on the user's device and the configuration of the three-dimensional virtual environment, the user may perform such an action via a touch screen swipe, a voice instruction, a text message, a button click, or any other suitable input techniques.

Upon determining that user input has been received, a user input path language model embedding is determined at 810 based on the user input. For instance, the user input may specify that a particular entity is to be moved in a particular direction. Such information may then be processed by the player 208A to convert the information into a format consistent with the configuration of the three-dimensional virtual environment.

A determination is made at 810 as to whether an event trigger has occurred. In some embodiments, the determination may be made by evaluating the current path language model embedding and/or the user input path language model embedding in combination with the script. The event handler 210A may determine whether the user interaction and/or the normal operation of the three-dimensional virtual environment has triggered an event. For example, the script may include an event that is triggered if two different entities collide. Such a collision may be driven by user input, or may occur due to the two entities moving autonomously through the three-dimensional virtual environment.

Upon determining that an event trigger has occurred, an action to perform based on the event trigger is determined at 812. According to various embodiments, the action may include the performance of one or more verbs specified by the script and defined in the path large language model.

An updated path language model embedding is determined at 814. In some embodiments, the updated path language model embedding is determined by the event handler 210A based on the current path language model embedding, the user input path language model embedding, and/or one or more actions to perform.

In some configurations, the performance of a verb may trigger an additional event. For instance, the script may specify that an explosion occurs if two different entities collide. The script may also include an event that specifies that a song is to be played if an explosion occurs. Hence, the collision of the two entities may trigger an explosion which is reflected in an updated path large language model embedding. The updated path large language model embedding may then trigger the playing of the song.

In some embodiments, more than one action may be performed at 812, for instance in a chain reaction of events. Alternatively, a single action may be performed at 812, with subsequent actions occurring during a subsequent iteration of the loop represented by the operations 804 through 818.

The rendering of the three-dimensional virtual environment is updated at 816 based on the updated path language embedding. In some embodiments, the rendering may be updated by the renderer 212A. For static objects or for 3D rigid movement, updating the rendering of the three-dimensional virtual environment may involve operations such as adjusting which entities, media elements, and other elements are presented within the three-dimensional virtual environment. For animated entities, the animation may be performed as discussed with respect to the method 2400 shown in FIG. 24. Updating the rendering of the three-dimensional virtual environment at 816 may involve performing one or more of the operations in the method 700 shown in FIG. 7, such as updating the rendering of one or more entities included in the environment.

A determination is made at 818 as to whether to continue to update the three-dimensional virtual environment. In some embodiments, the determination may be made at least in part based on user input. For instance, the three-dimensional virtual environment may continue to be updated as long as it is being presented on a display screen at the client machine.

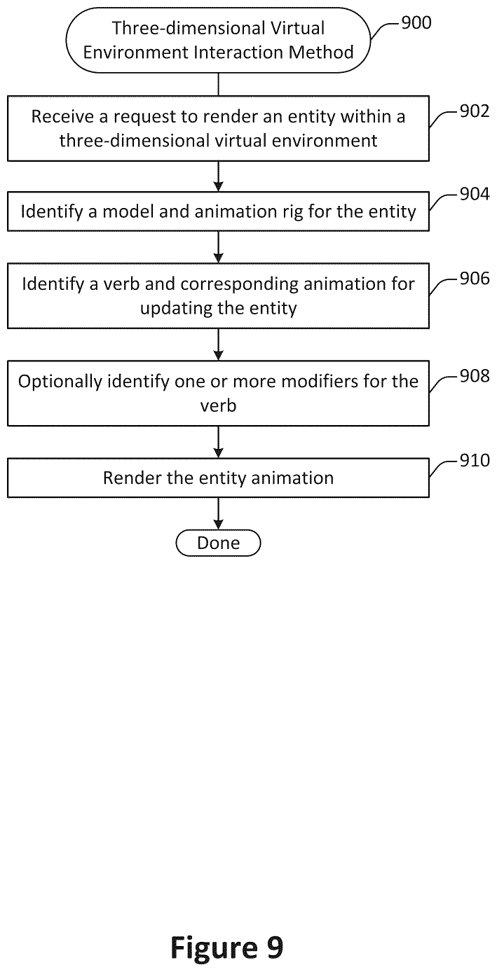

FIG. 9 illustrates a method 900 for rendering an animated entity within a three-dimensional virtual environment, performed in accordance with one or more embodiments. The method 900 may be performed at any suitable computing system, such as client machine in communication with a server system configured to construct the three-dimensional virtual environment based on interactions from a client machine and/or serve the three-dimensional virtual environment to a client machine via the Internet. An example of such an ecosystem is discussed with respect to Section 2.

A request to render an entity within a three-dimensional virtual environment is received at 902. In some embodiments, the request may be generated as discussed with respect to the operation 714 shown in FIG. 7. As discussed with respect to the operation 816 shown in FIG. 8, such a request may also be generated after the initial rendering of the environment. The request to render the entity may identify elements such as the entity to be animated, the verb that the entity is performing, optionally a trajectory in the three-dimensional virtual environment along with the entity is to be moving, and optionally one or more modifiers for the verb.

A three-dimensional model and an animation rig for the entity is identified at 904. In some embodiments, the three-dimensional model and the animation rig may be identified by accessing metadata information associated with the entity, which may be included in or referenced by the script. For instance, as discussed with respect to FIG. 2, an entity may be associated with a default animation rig or an animation rig specific to an entity or type of entity. The animation rig may include independently movable joints which may be moved through space to give the appearance that the entity is animated.

A verb and corresponding animation for updating the entity are identified at 906. As discussed herein, a verb may be associated with an animation. The animation may identify a set of movements corresponding to elements of an animation rig. For instance, the animation may identify trajectories through space within a coordinate system for the joints included in an animation rig in order to implement the animation.

One or more modifiers for the verb are optionally identified at 908. Modifiers may include adjectives or adverbs such as “slowly” that may affect how the animated entity is rendered. Such modifiers may be included in the script or may be determined dynamically, for instance based on user input.

The entity animation is rendered at 910 based on the 910. In some embodiments, rendering the entity animation may involve operations such as moving the joints of the three-dimensional model through space in a manner specified by the animation identified at 904 as optionally modified by one or more modifiers identified at 908. For instance, the movement may be increased or decreased in speed.

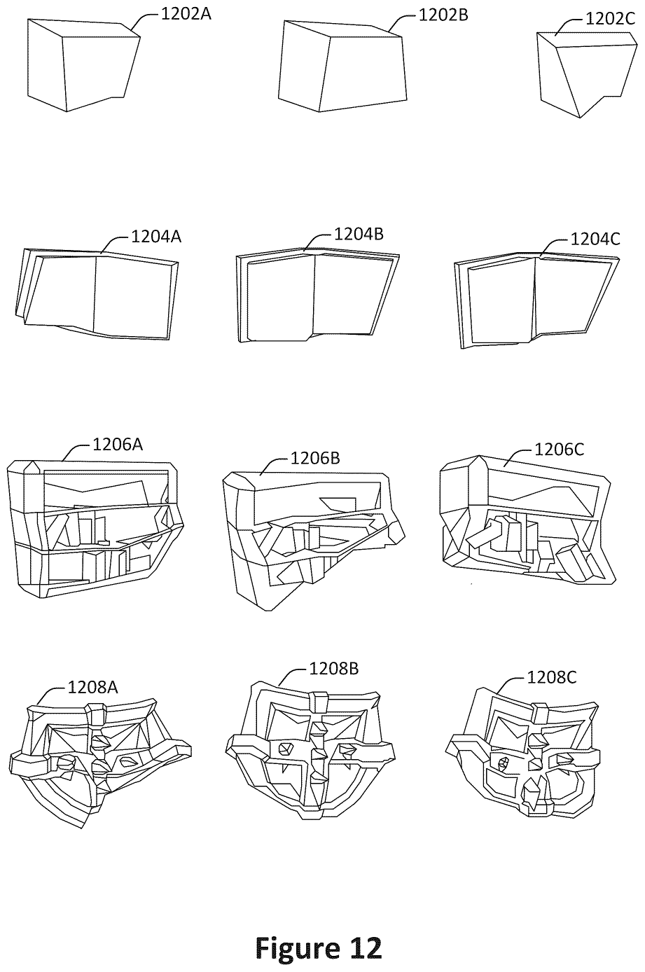

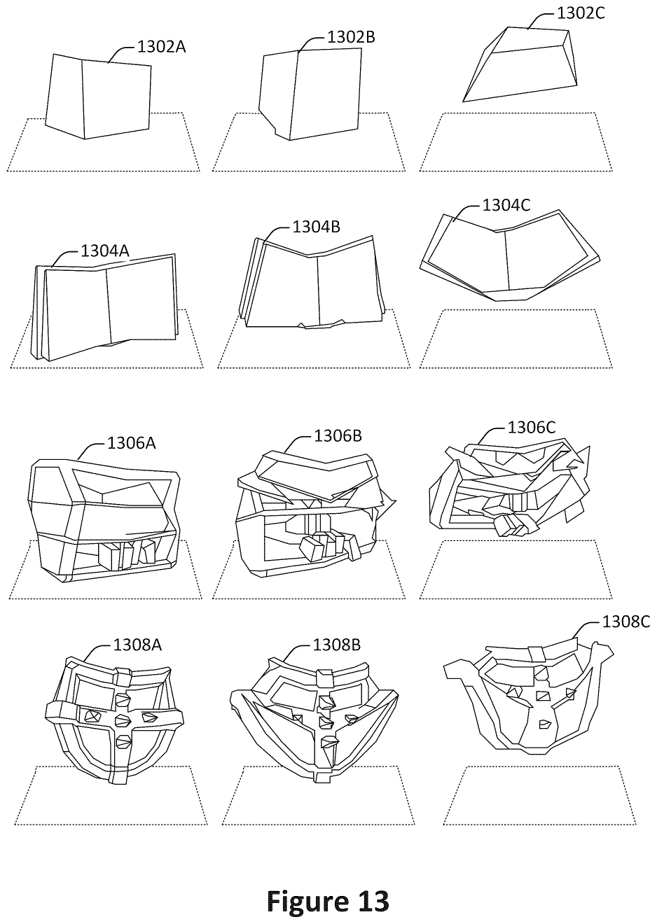

FIG. 12, FIG. 13, FIG. 14, and FIG. 15 illustrate views of entities (a box, a book, a bookshelf, and a shield) being animated, generated in accordance with one or more embodiments. According to various embodiments, the specific images shown in FIG. 12 through FIG. 15 are included for the purpose of illustration. An actual animation of a three-dimensional model may involve additional frames beyond those shown in FIG. 12 through FIG. 15.

According to various embodiments, because the entities shown in FIG. 12 through FIG. 15 correspond to objects traditionally considered inanimate, they are not associated with dedicated animation rigs, and instead a default human animation rig is applied to each of the models. As shown in these figures, applying the default animation human rig involves dividing the three-dimensional model into portions corresponding to the default human rig scaled to the region corresponding to the three-dimensional model. In this way, any object having a three-dimensional model can be animated.

In FIG. 12, the three-dimensional models are shown as walking. For example, 1202A illustrates a box, 1204A illustrates a book, 1206A illustrates a bookshelf, and 1208A illustrates a shield. Moving from left to right, at 1202B, 1204B, 1206B, and 1208B the entities each move forward a model portion corresponding with a human foot. At 1202C, 1204C, 1206C, and 1208C the entities each move forward a model portion corresponding with the other foot, creating the appearance of walking.

In FIG. 12, the three-dimensional models are shown as walking. For example, 1202A illustrates a box, 1204A illustrates a book, 1206A illustrates a bookshelf, and 1208A illustrates a shield. Moving from left to right, at 1202B, 1204B, 1206B, and 1208B the entities each move forward a model portion corresponding with a human foot. At 1202C, 1204C, 1206C, and 1208C the entities each move forward a model portion corresponding with the other foot, creating the appearance of walking.

In FIG. 13, the three-dimensional models are shown as jumping. For example, at 1302A, 1304A, 1306A, and 1308A the entities are shown as being positioned near the floor, crouching to build energy for jumping. At 1302B, 1304B, 1306B, and 1308B the entities are shown as starting to leave the floor, with portions of the models corresponding to human hands raising in the air. At 1302C, 1304C, 1306C, and 1308C the entities are shown as being positioned above the floor, giving the appearance of jumping.

In FIG. 14, the three-dimensional models are shown as jumping. For example, at 1402A, 1404A, 1406A, and 1408A the entities are shown as being positioned with portions of the models corresponding with one human foot forward. At 1402B, 1404B, 1406B, and 1408B the entities are shown as starting to move the other foot. At 1402C, 1404C, 1406C, and 1408C the entities are shown as moving the other foot across the body, giving the appearance of dancing.

In FIG. 14, the three-dimensional models are shown as DYING. For example, at 1402A, 1404A, 1406A, and 1408A the entities are shown as being in a standing position. At 1402B, 1404B, 1406B, and 1408B the entities are shown as starting to collapse. At 1402C, 1404C, 1406C, and 1408C the entities are shown as having collapsed, giving the appearance of dying.

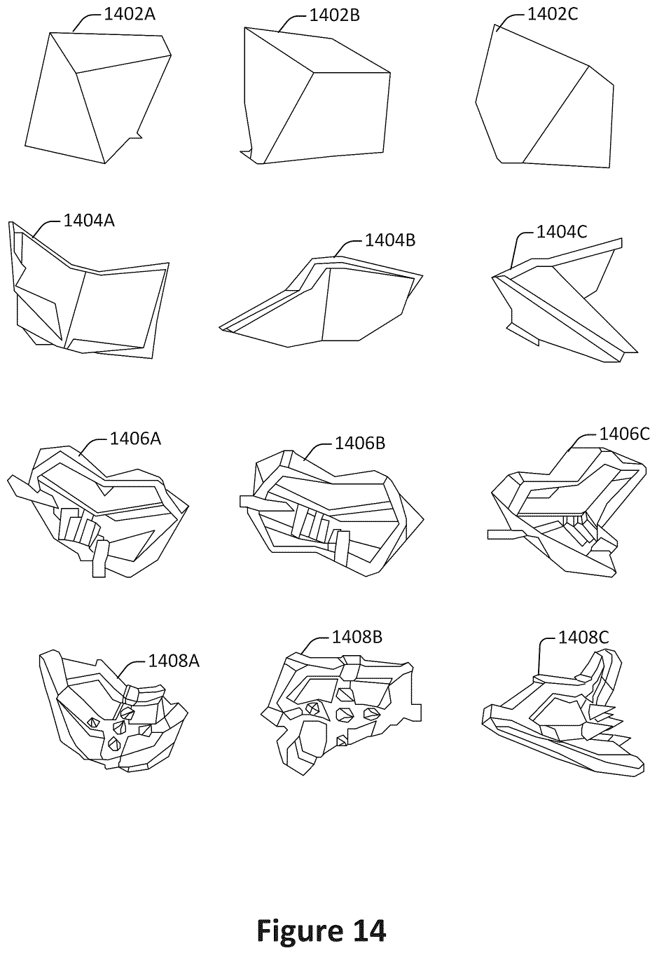

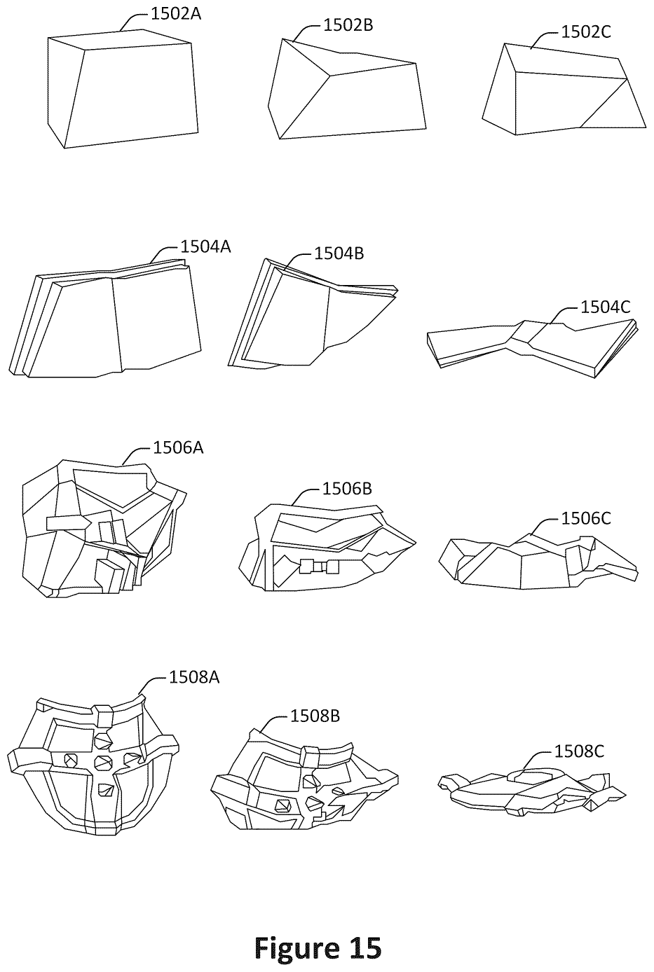

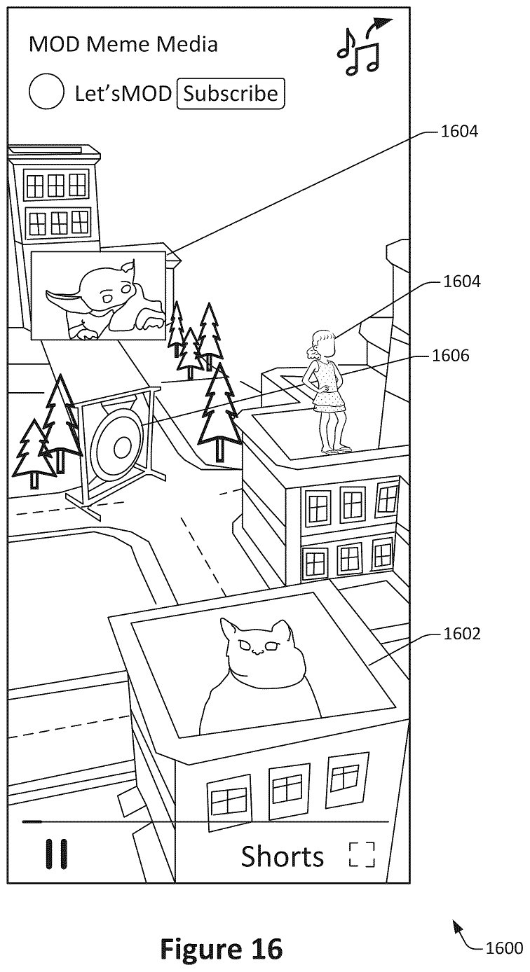

FIG. 16 illustrates an example of a three-dimensional virtual environment 1600, generated in accordance with one or more embodiments. As discussed herein, the three-dimensional virtual environment may be dynamically configured based on user input, then presented at a client machine. Once presented at the client machine, a user may provide user input to interact with the three-dimensional virtual environment.

As shown in FIG. 16, potentially any entity within the three-dimensional virtual environment may perform potentially any verb within the path language model. For example, at 1602, a building displays an image of a cat. As another example, a girl is animated as dancing at 1604. As yet another example, a building is displaying a video at 1604, which does not play until the user touches or clicks on the video. As still another example, a picture of a gong is configured to play a sound when a triggering condition is met (e.g., receiving a click or touch by a user).

### II.5. Path Language

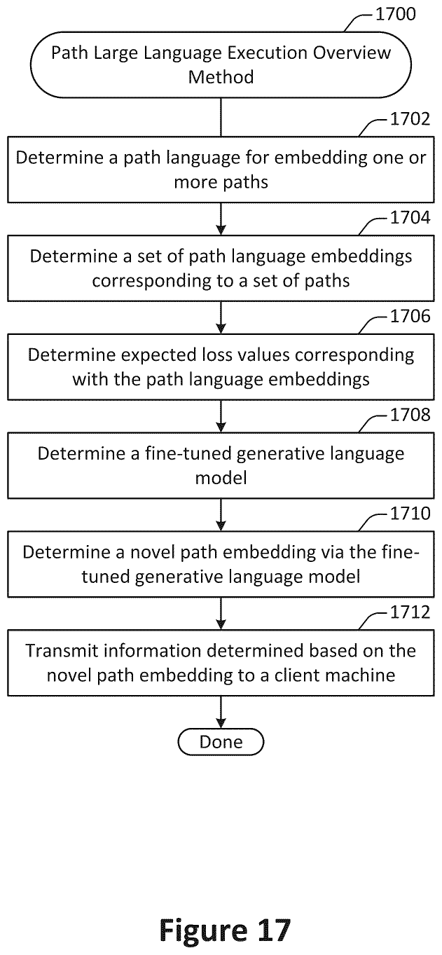

FIG. 17 illustrates an overview method 1700 for executing a path large language model, performed in accordance with one or more embodiments. According to various embodiments, the method 1700 may be performed at any suitable computing device, such as one or more of the computing devices shown herein.

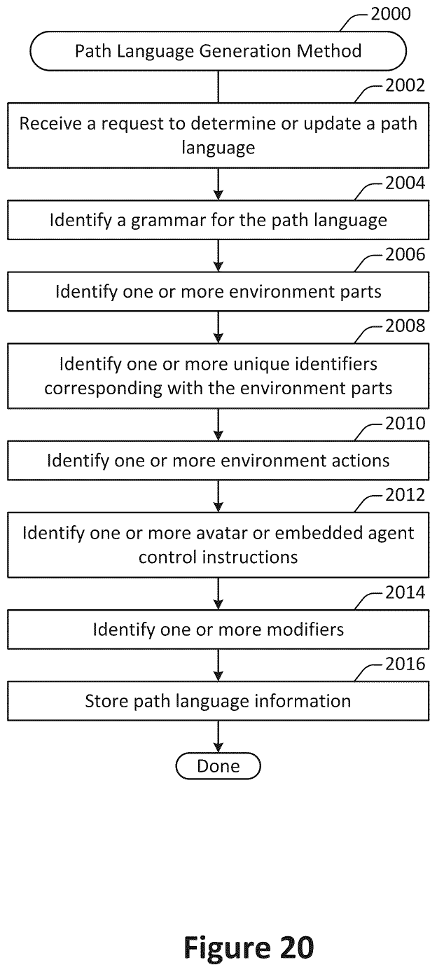

A path language for embedding one or more paths is determined at 1702. Additional details regarding the determination of a path language are discussed with respect to the method 2000 shown in FIG. 20.

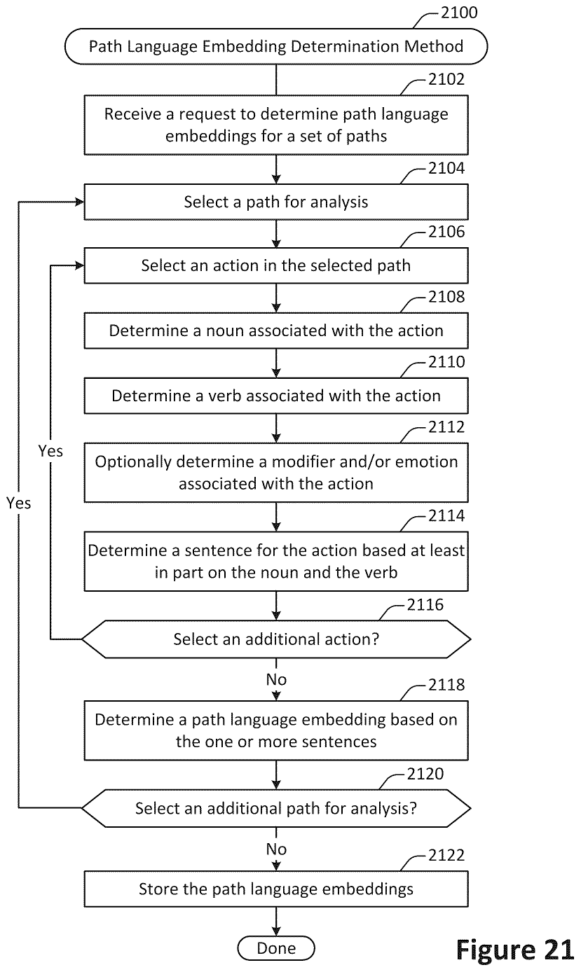

A set of path language embeddings corresponding to a set of paths are determined at 1704. Additional details regarding the determination of path language embeddings are discussed with respect to the method 2100 shown in FIG. 21.

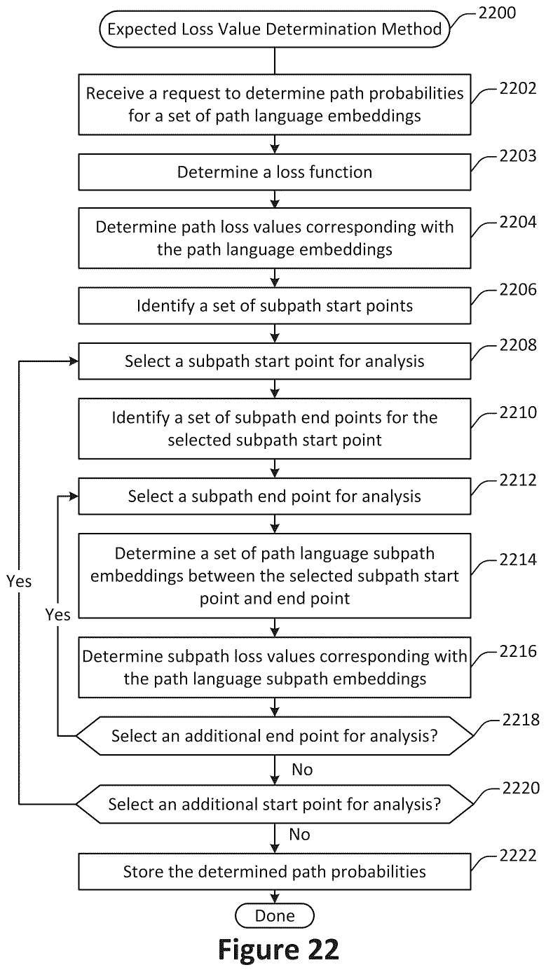

Expected loss values corresponding with the path language embeddings are determined at 1706. Additional details regarding the determination of the expected loss values are discussed with respect to the method 2200 shown in FIG. 22.

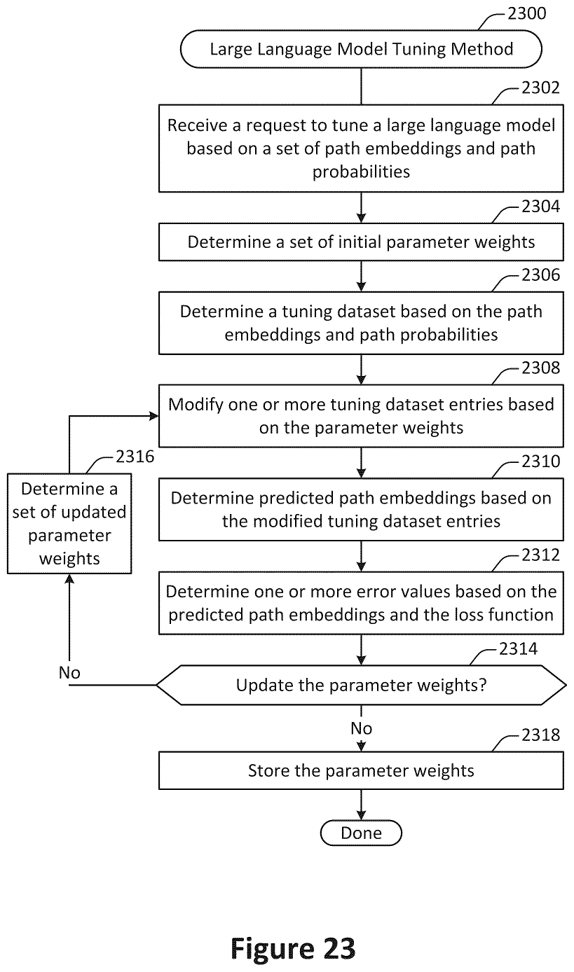

A fine-tuned generative language model is determined at 1708. Additional details regarding the fine-tuning of a generative language model are discussed with respect to the method 2300 shown in FIG. 23.

According to various embodiments, as discussed herein, a generative language model need not necessarily be finetuned. Alternatively, or additionally, a standard generative language model may be taught to employ the PLLM within a prompt. For instance, the prompt may include a definition of the PLLM along with one or more examples of how to use the PLLM.

A novel path embedding is determined via the fine-tuned generative language model at 1710. Information determined based on the novel path embedding is transmitted to the client machine at 1712. According to various embodiments, novel path embeddings and information determined based on novel path embeddings may be determined in any of various contexts.

In some embodiments, a novel path may be generated so as to identify a new path through an embedded environment, for instance to solve a robotics problem. As another example, a novel path may be generated to aid in the design or alterative of an embedded environment. Additional details regarding such applications are discussed with respect to the method 2400 shown in FIG. 24.

In some embodiments, the capabilities of an environment part can be dynamically controlled by either a human operator or an AI system during different gameplay sessions, task executions, or iterations of the environment. This adaptive control mechanism allows for versatile interactions and task management, as the behavior of environment parts can be modified based on the specific requirements or conditions of the run.

In some embodiments, when a human operator controls an environment part, they can directly influence its capabilities and behavior. Such control may potentially introduce unique and unpredictable elements into the environment. Conversely, when an AI system controls an environment part, it can dictate the part's behavior based on predefined rules, learned behaviors, or adaptive algorithms. In this way, the AI may act to ensure consistent and/or optimized performance, and/or act to further some other goal such as engagement.

In some embodiments, the same environment part may be controlled by a human operator in one run and an AI system in another. This variation may facilitate the introduction of a range of dynamics and interactions into the environment. The PLLM may account for and learn from these variable control dynamics, enhancing its ability to manage and predict paths within the environment.

In some implementations, the PLLM may learn from the paths of both human-controlled and AI-controlled avatars within the environment. This concurrent learning mechanism may allow the PLLM to assimilate a broad range of experiences and strategies, enhancing its ability to predict and manage paths within the environment.

In some embodiments, the PLLM may be directed to learn from human-controlled paths, assimilating the unique strategies, creativity, and unpredictability that human players can introduce. Concurrently, the PLLM can also learn from AI-controlled paths, assimilating the consistent, optimized, and rule-based strategies that AI systems can introduce.

In some embodiments, the control of environment parts by AI systems can be further diversified. For instance, in some configurations a single AI system may control all AI-controlled parts. Alternatively, different AI-controlled parts may be managed by distinct AI system. Such variation may provide for a range of AI strategies and behaviors to be introduced into the environment, further enhancing the diversity of interactions and paths that the PLLM can learn from.

According to various embodiments, in scenarios where multiple human operators and/or multiple AI systems are involved in controlling various parts of the environment, the PLLM may manage this complex and dynamic environment effectively. For instance, the PLLM may learn from the broad range of interactions and strategies introduced by the multiple controllers, thereby enhancing its path prediction and management capabilities.

In some embodiments, initializing the PLLM may involve an independent provision of a finite set of environment parts. Provisioning an environment part may involve specifying its shape, function, utility, and/or other characteristics. The shape of an environment part may include a specification of its physical or virtual form and structure, while the function or utility of an environment part may identify its operational capabilities within the environment. The independent initialization of environment parts may allow the PLLM to fully comprehend the embodied environment in which it operates. In this way, the model may be configured to accurately interpret interactions with a part and effectively predict and manage the avatar's paths within the environment.

According to various embodiments, a static starting analysis can be performed as part of the initial construction of the Path Large Language Model (PLLM). The static starting analysis may involve identifying some or all of the possible paths that an avatar can take within the environment, for instance by considering factors such as the speed and movement capabilities of environment parts.

In some embodiments, the static starting analysis can be used to account for physical or virtual constraints within the environment. For instance, some interactions may not be possible initially due to the speed or position of certain environment parts. If two parts cannot get close enough within a certain timeframe, the paths requiring such interaction can be disregarded in the initial analysis. Thus, the static starting analysis may provide a foundational understanding of the feasible paths within the environment. By identifying feasible paths at the outset, the static starting analysis may allow the PLLM to focus on viable paths from the onset, enhancing the efficiency of its learning process and the effectiveness of its path prediction and management capabilities.

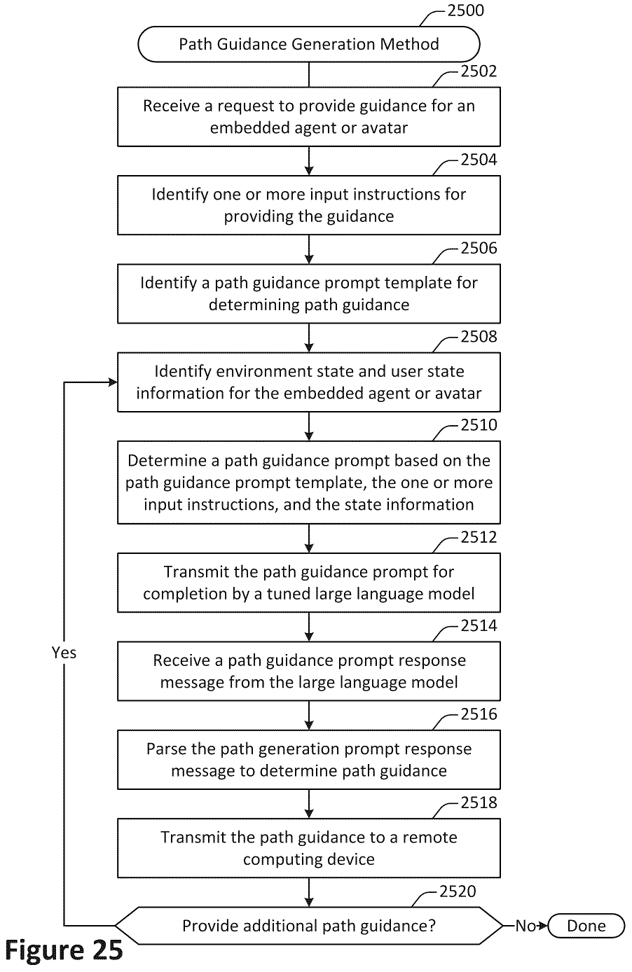

In some embodiments, a novel path may be generated so as to provide guidance or control instructions for causing an avatar to navigate an embedded environment. Additional details regarding such applications are discussed with respect to the method 2500 shown in FIG. 25.

According to various embodiments, the path large language model may be applied in any of a variety of ways. For example, in an educational setting, personalized feedback and suggestions may be provided to users for improving their understanding of complex topics or skills. As another example, in a commercial setting, customized shopping experiences may be created by learning customer preferences through interaction history and suggesting products or services accordingly. As yet another example, in a virtual reality (VR) and/or augmented reality (AR) application, user engagement and interaction may be enhanced via application of the path language in a simulated environment. As still another example, multi-avatar collaboration may be supported by allowing multiple avatars to work in unison by learning from each other's interaction paths, thus improving overall system performance.

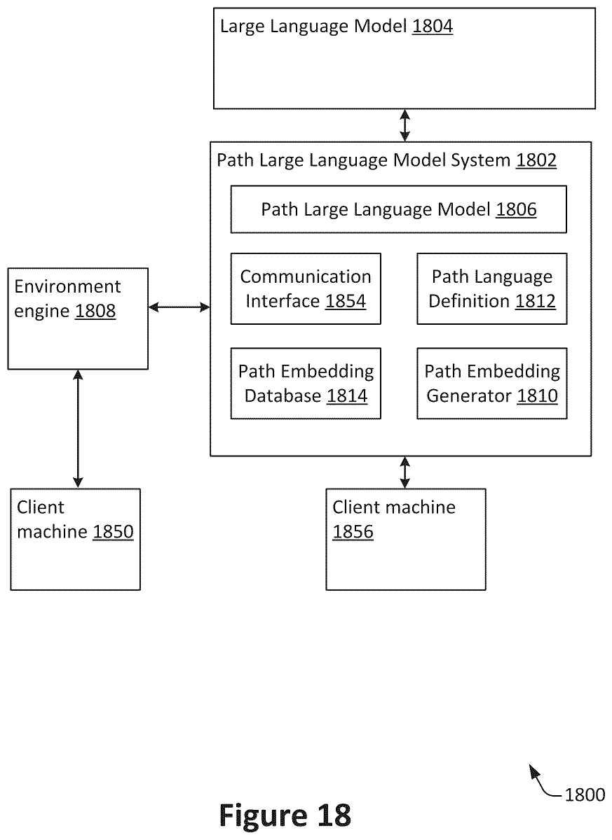

FIG. 18 illustrates a path large language model ecosystem 1800, configured in accordance with one or more embodiments. The path large language model ecosystem 1800 is an alternative configuration and/or alternative view of the path large language model ecosystem 200 shown in FIG. 2. The path large language model ecosystem 1800 includes a path large language model system 1802 in communication with a large language model 1804 and a client machine 1856 via a communication interface 1854. The path large language model system 1802 may also be in communication with an environment engine 1808, which may in turn communicate with a client machine 1850 via the communication interface 1854.

According to various embodiments, the environment engine 1808 may provide an embedded environment to the client machine 1850. For instance, the environment engine 1808 may provide an environment such as a game, a metaverse, or another simulated system.

Alternatively, the environment engine 1808 may correspond to a physical environment as sensed by a robot.

According to various embodiments, the large language model 1804 may be any suitable large language model. For example, the large language model 1804 may be Google Bard, ChatGPT, or another such model.

In some embodiments, the large language model 1804 may be multimodal. A multimodal model supports input of more than one type. For example, a multimodal model may support input via a combination of video and text.

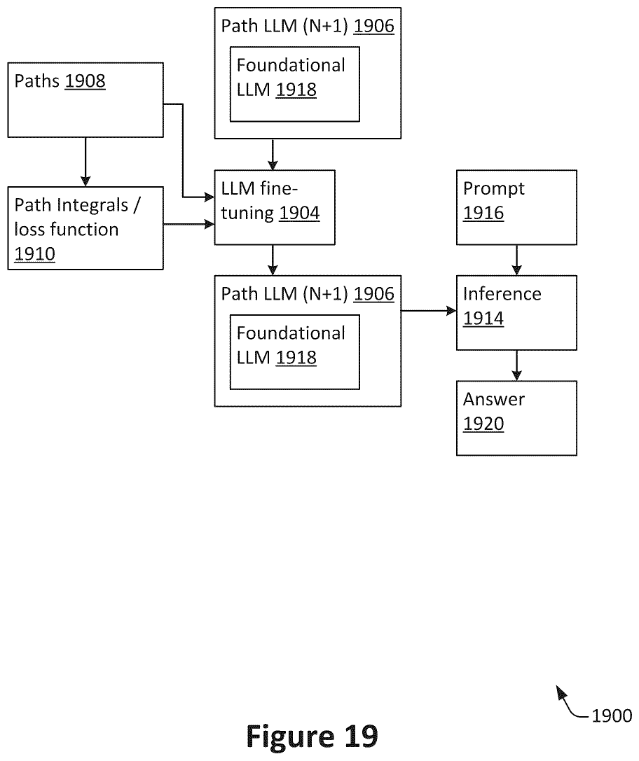

The path large language model system 1802 includes a path large language model 1806. In some implementations, the path large language model 1806 may be trained via fine-tuning as discussed with respect to FIG. 19 and FIG. 23.

The path large language model system 1802 also includes a path language definition 1812. In some embodiments, the path language definition 1812 may be determined as discussed with respect to the method 2000 shown in FIG. 20.

The path large language model system 1802 also includes a path generator 1810 configured to generate path embeddings, which may then be stored in the path embedding database 1814. The path generator 1810 may generate path embeddings as discussed with respect to the method 2100 shown in FIG. 21.

FIG. 19 illustrates a flow diagram of a process flow 1900, performed in accordance with one or more embodiments. In the process flow 1900, a path LLM is determined by a fine-tuning process that is based on one or more paths. The paths 1908 are used to generate training data to fine-tune the path LLM at 1904. The paths 1908 are also used to determine a loss function by computing Feynman path integrals over path-level loss functions at 1910. The loss function is used to determine error values from the output of the path LLM during the fine-tuning at 1904. The fine-tuning yields an updated path LLM at 1906.

In some embodiments, the loss function may simply reflect the path probabilities. That is, the path large language model may be penalized for producing paths of low probabilities. Alternatively, the path probabilities may be used as an input for a more complex loss function. For instance, path probabilities may be weighted based on user engagement. In this way, the large language model may be tuned to generate paths having higher probability for higher engagement rather than paths that have the overall highest probability.

In particular embodiments, different versions of a path language model may be tuned using different loss functions to accomplish different purposes. For example, in the robotics space, the loss function may prioritize the path having the highest chance of achieving a goal, subject to the constraint of not injuring a person or damaging the robot. As another example, in the gaming space, the loss function may prioritize user engagement, user retention, or some combination thereof. User engagement may be defined as, for instance, an amount of time a user spends in an environment. User retention may be defined as, for instance, a number of times a user enters an environment.

In some embodiments, the path LLM 1918 may be fine-tuned by using a low-rank adaptation (LoRA) process. Additional details regarding path LLM tuning are discussed with respect to the method 2300 shown in FIG. 23.

According to various embodiments, the path LLM 1918 may be iteratively tuned periodically, for instance when a sufficient amount of new path data is received. In this way, the path language is dynamic and evolves over time through continuous learning from new paths taken by the avatar. As new interactions occur, the PLLM also updates and refines the path language, incorporating the learned information to improve its decision-making capabilities. Additional details regarding path language refinement are discussed with respect to the method 2000 shown in FIG. 20.

According to various embodiments, this adaptability enables the PLLM to continuously optimize the avatar's interactions within the environment, ensuring the avatar's actions align increasingly with the desired objectives. In case the avatar is also controlled by a human, then PLLM can help to provide highly effective inputs and conversations.

After the PLLM has been trained, then it may be used for inference at 1914. During the inference phase, a prompt is provided at 1916. The prompt is pre-processed via the PLLM and then provided to the foundational LLM at 1918. The foundational LLM 1918 then produces the answer 1920.

FIG. 20 illustrates a method 2000 of determining a path language, performed in accordance with one or more embodiments. According to various embodiments, the method 2000 may be performed at any suitable computing device, such as one or more of the computing device shown herein.

A request to determine or update a path language is received at 2002. In some embodiments, the request may identify an existing path language. Alternatively, an entirely new path language may be created. The request may be received at a system such as the system 1802 shown in FIG. 18.

A grammar for the path language is identified at 2004. In some embodiments, the grammar may be specified based on user input. Alternatively, or additionally, one or more configuration parameters may be consulted. The grammar may identify relationships between various parts of speech, and may be used to form sentences based on these parts of speech. The grammar may identify some number of different sentence types.

For example, one sentence type may be of the form “AVATAR VERB NOUN

[OPTIONAL ADVERB]” and corresponds to interactions between an avatar and other elements of an embedded environment. In this example, NOUN corresponds to a part of the environment, while VERB corresponds to the action. AVATAR identifies that avatar and OPTIONAL ADVERB corresponds to an optional modifier such as a time period over which the action occurs.

As another example, another sentence type may be of the form “AVATAR VERB NOUN [OPTIONAL ADVERB]” and correspond to a control instruction issued by a human or autonomous control process. In this example, NOUN corresponds to the part of the environment at which the avatar is located, VERB identifies the control instruction, and OPTIONAL ADVERB identifies a modifier such as a time period over which the control instruction was issued.

As yet another example, one sentence type may be of the form “NOUN1 VERB NOUN2 [OPTIONAL ADVERB]” and corresponds to interactions between an elements of an embedded environment and other elements of an embedded environment. In this example, NOUN1 and NOUN2 correspond to parts of the environment, while VERB corresponds to the action. OPTIONAL ADVERB corresponds to an optional modifier such as a time period over which the action occurs.

As another example, another sentence type may be of the form “AVATAR SAID SENTENCE” and correspond to a text communication issued by a human or autonomous control process. In this example, SENTENCE can refer to parts of the environment. The foundational LLM makes it possible for PLLM to understand these sentences even if they are general conversation (e.g., a person's thoughts regarding the AVATAR's movement).

One or more environment parts are identified at 2006. According to various embodiments, an environment part may correspond to any element within one or more embedded environments. For example, an environment part may correspond to a platform, a door, a table, a two-dimensional plane, a three-dimensional region, a volume of liquid, a hazard, a ceiling, a wall, a room, or any other element that may be represented within an embedded environment.

In some embodiments, an environment part may be identified by analyzing environment specification and/or event information. For example, an environment may include an object library that uniquely identifies the objects within the environment. As another example, an environment may emit events while the environment is being executed. An event may identify one or more elements within the environment that are related to the event. Alternatively, an environment part may be identified based on user input.

One or more unique identifiers corresponding with the environment parts are identified at 2008. According to various embodiments, any suitable technique may be used to create a unique identifier for an environment part. As one example, the name of an environment in which the environment part occurs may be combined with a name corresponding to the environment part type and, optionally, a unique number. For instance, a room in a metaverse environment may be uniquely identified as “METAVERSE-ROOM-152”.

One or more environment actions are identified at 2010. One or more avatar control instructions are identified at 2012. One or more modifiers are identified at 2014. According to various embodiments, the environment actions, embedded avatar control instructions, and/or modifiers may be identified in a manner similar to that of the identification of environment parts at 2006.

Path language information is stored at 2016. In some embodiments, the path language information may be stored at the system 202 so that the path language may be used to determine and decode path language embeddings.

FIG. 21 illustrates a method 2100 of determining a path embedding for one or more paths, performed in accordance with one or more embodiments. According to various embodiments, the method 2100 may be performed at any suitable computing device, such as one or more of the computing device shown herein.

A request to determine path language embeddings for a set of paths is determined at 2102. According to various embodiments, the request may be received in any of variety of contexts. Such contexts may include, but are not limited to: tuning a large language model, developing a new embedded environment, changing an existing embedded environment, determining a novel path for navigating an embedded environment, and providing guidance for navigating an embedded environment.

A path is selected for analysis at 2104. According to various embodiments, paths may be selected in any suitable order, in sequence or in parallel. In some embodiments, a path may be specified via event data. For instance, an embedded environment may emit events characterizing actions, parts, and other aspects of the embedded environment.

In some embodiments, a path may be specified via image data. For instance, video or still images of an avatar or other aspects of an embedded environment may be recorded and then analyzed to determine information related to actions.

An action in the selected path is selected at 2106. In some embodiments, actions may be selected sequentially. Alternatively, actions may be selected in a different order. For instance, portions of the selected path may be analyzed in parallel. Depending on the application, an action may correspond with a period of time, one or more events reflected in event data, or some combination thereof.

A noun associated with the action is determined at 2108. In some embodiments, the noun may correspond to a part within the environment. For instance, the noun may correspond to a wall, a platform, a region of water, or some other such virtual object. Alternatively, a noun may correspond to an avatar or an embedded avatar.

A verb associated with the action is determined at 2110. In some embodiments, the verb may correspond to an interaction between an avatar and some part or parts in the environment. Alternatively, the verb may correspond to an instruction causing the avatar to perform an action, such as movement, within the embedded environment.

A modifier and/or emotion associated with the action is optionally determined at 2112. In some embodiments, the modifier may be any adverb, adjective, or other such part of speech that provides contextual information about a verb performed by or with respect to a noun. For instance, the modifier may be a length of time that the action was performed.

In some embodiments, a modifier and/or emotion may include a modifier as reflected by an emoji. For instance, a verb associated with movement may be modified by an emoji representing an emotion such as sadness, happiness, or anger.

A sentence for the action is determined based at least in part on the noun and the verb. In some embodiments, the sentence may be determined based on a grammar associated with the path language. For example, the path language may include one type of sentence describing interactions between parts of the environment and the avatar. Such sentences may include a noun characterizing the part of the environment interacting with the avatar, a verb characterizing the nature of the interaction, and an optional modifier specifying the length of the interaction. An example of a sentence generated in accordance with this sentence type may be: “The avatar was hit by the spike S-2902 for two seconds.” In this example, “the spike S-2902” is the noun, “was hit by” is the verb”, and “for two seconds” is the modifier.

As another example, the path language may include another type of sentence describing a control interaction associated with the embedded avatar. The control interaction may be based on an instruction determined at least in part based on user input. Alternatively, or additionally, the control interaction may be based on an instruction determined at least in part based on an autonomous control process or some other machine-based control technique. Such a sentence may include a noun identifying the avatar, a verb characterizing the control interaction, and optionally a modifier characterizing the length of the control action. An example of a sentence generated in accordance with this sentence type may be: “The avatar moved forward from platform—3123 for 10 seconds.” In this example, the noun is “platform—3123”, “moved forward” is the verb, and “for 10 seconds” is the modifier.

As still another example, the path language may include another type of sentence describing input by or to a human (e.g., a human controlling an avatar) or other controller of the system as a specific time. Such inputs may be provided via a chat environment where the player is in conversation with other parts in the same embodiment. For example, in a game environment, after an avatar captures 20 coins in a row, a non-playing character in the scene may say: “You nailed 20 coins in a row. This is rare.” As another example, an avatar controller may be provided with a hint at a particular time. As the result of such communication, a player's engagement and/or success may increase.

According to various embodiments, a structured grammar allows for precise and detailed representation of the avatar's interactions, facilitating effective analysis and decision-making. The examples discussed above may be expanded to support more complex grammars. For example, an optional adjective can be used to identify the capabilities of the specific avatar. As another example, a sentence may support more than one noun, avatar, and/or modifier. As yet another example, a sentence may include more complex structures, such as objects or subordinate clauses. For instance, as discussed above, sentences describing actions can be combined with non-structured chat between and among the avatar, an avatar controller, and the environment parts.

A determination is made at 2116 as to whether to select an additional action. In some embodiments, additional actions may continue to be selected until the end of the path is reached. Alternatively, a different terminating condition may be used.

If it is determined not to select an additional action, then at 2118 a path language embedding is determined based on the one or more sentences. In some embodiments, the path language embedding may include the sentences determined at 2114, concatenated into a body of text.

A determination is made at 2120 as to whether to select an additional path for analysis. In some embodiments, additional paths may continue to be selected until all paths have been analyzed. Alternatively, a different terminating condition may be used.

If it is determined not to select an additional path for analysis, then at 2122 the path language embeddings are stored. The path language embeddings may be stored on any suitable storage device for use in any of a variety of applications as discussed herein. For instance, the path language embeddings may be stored in a database.

In particular embodiments, any or all of a variety of additional information may be stored in conjunction with the path language embeddings. For example, the database may store whether a given path was successful or not. As another example, the database may store a score value or other such indicator of performance. As yet another example, the database may store an indication of user engagement, such as the length of time spent in the environment. As still another example, the database may store an indication of user retention, such as the number of times a user returned to the environment. Such types of information may be used, for instance, to inform a loss function as discussed with respect to FIGS. 4 and 20.

FIG. 22 illustrates a method 2200 of determining expected loss values for one or more paths, performed in accordance with one or more embodiments. According to various embodiments, the method 2200 may be performed at any suitable computing device, such as one or more of the computing device shown herein.

A request to determine path probabilities for a set of path language embeddings is determined at 2202. According to various embodiments, the request may be received when a large language model is initially tuned for the purpose of analyzing observed path language embeddings and generating novel path language embeddings. Alternatively, or additionally, an existing set of path probabilities may be updated based on newly observed paths.

A loss function is determined at 2203. According to various embodiments, the particular formulation of the loss function may depend on the use case. For example, a loss function may be formulated so as to penalize disengagement, non-retention, low-probability paths, failed paths, or some combination thereof.

Path loss values corresponding with the path language embeddings are determined at 2204. In some embodiments, the path loss values may be determined by computing a Feynman Path Integral of the loss function over the paths. For example, consider the following equation from quantum mechanics:

$$Z = \int D [ x ] {e}^{\frac{iS [ x ]}{ℏ}}$$

In this equation, Z is the partition function, or the “sum over all histories”, that is used to calculate observable quantities. The integral ∫[D[x] represents an integral over all possible paths x(t) that the system can take. S[x] is the action, which is an integral over time from the initial to the final state of the Lagrangian of the system, L(x, dx/dt), where x is the position and dx/dt is the velocity. That is, S[x]=∫_t1\hat{ }t2 L(x(t), dx(t)/dt) dt. Then, h is the reduced Planck's constant. The exponential term, exp (iS[x]/ȟ), provides a weight for each path, which is complex and depends on the action S[x].

In statistical mechanics, Feynman's path integral formulation takes a form that is very similar to the original quantum mechanical version, but with a significant difference: the factor of i (the imaginary unit) in the action's exponent is replaced with −1, changing the nature of the integral from a quantum superposition to a statistical sum. The Feynman path integral in statistical mechanics can then be used to calculate a partition function, for instance to compute a statistical average. The partition function Z in statistical mechanics is given by:

$$Z = \int D [ x ] {e}^{\frac{- S [ x ]}{kT}}$$

In this formulation, S[x] is again the action associated with the path x, while k is Boltzmann's constant, T is the temperature, and D[x] represents an integral over all possible paths.

In some embodiments, in the context of a PLLM, the Feynman path integral (or its statistical mechanics variant) may be used to calculate a sum over all paths (plays), where each path is weighted by the exponential of the negative of its “action” or loss function. For instance, consider the example of a loss function defined based on total churn rate. In this case, the Feynman path integral itself would provide a measure of the total churn over all paths in the game, taking into account the probability of each path.

As an illustrative example, let P (p) denote the probability of path p which can be estimated from the play data and let S (p) denote the “action” of path, which is the loss function (i.e., the total churn rate over the path, in this example). Then, the Feynman path integral approximation in this context and using established computational methods like Monte Carlo would take a discrete form as following:

$$I = \sum pP ( p ) {e}^{- S ( p )}$$

In this equation, the sum over p is over all possible (e.g., all observed) paths. The integral effectively gives a measure of the total loss (e.g., “churn”) over all paths in the game, taking into account both the probability of each path and its loss. In the context of reinforcement learning, the system may seek to identify a move that reduces or minimizes this integral by finding a move that leads to paths with a high probability and low loss. That is, at each step the system may choose a move that minimizes (or approximately minimizes) the Feynman path integral over possible paths between the next (e.g., recommend) part position and the goal.

A set of subpath start points are identified at 2206. According to various embodiments, a subpath start point may be a part associated with the path language model. The subpath start points for an embedded environment may thus include some or all of the parts associated with that embedded environment.

In some embodiments, subpath start points may be identified by determining environment parts that are particularly significant. For example, subpath start points in a game may include key locations (e.g., the beginning or end of a level or stage), key rewards (e.g., coins), and/or key hazards (e.g., spike traps). As another example, subpath start points in a robotics context may include key locations in a physical environment. As yet another example, subpath start points in a metaverse context may include key virtual locations within the metaverse.

In some embodiments, one or more subpath start points may be identified based on user input. Alternatively, or additionally, one or more subpath start points may be identified by analyzing the path language embeddings. For instance, environment parts that seem to form key branching points in the path language embeddings may be selected as subpath start points.

A subpath start point is selected for analysis at 2208. According to various embodiments, subpath start points may be analyzed in any suitable order, in sequence or in parallel.

A set of subpath end points for the selected subpath start point are identified at 2210. According to various embodiments, the subpath end points may be identified in a manner similar to the identification of the subpath start points. Additionally, subpath end points may be restricted based on the observed path embeddings. For example, if the only paths from a subpath start point A to a prospective subpath end point B traverse at least one other subpath start point in between points A and B, then the prospective subpath end point B may be rejected as a subpath end point.

A subpath end point is selected for analysis at 2212. According to various embodiments, subpath end points may be analyzed in any suitable order, in sequence or in parallel.

A set of path language subpath embeddings between the select subpath start point and end point are determined at 2214. In some embodiments, the path language subpath embeddings may be determined by analyzing the path language embeddings identified in the request received at 2202 to identify portions of the path language embeddings that start at the selected subpath start point and end at the selected subpath end point.

Subpath loss values corresponding with the path language subpath embeddings are determined at 2216. According to various embodiments, the subpath loss values may be determined in a manner similar to the path loss values, as discussed with respect to operation 2204.

A determination is made at 2218 as to whether to select an additional end point for analysis. If it is determined not to select an additional end point for analysis, then a determination is made at 2220 as to whether to select an additional start point for analysis. According to various embodiments, additional start points and end points may continue to be selected until all suitable combinations identified have been analyzed.

If it is determined not to select an additional start point for analysis, then at 2222 the determined path probabilities are stored. In some embodiments, not all path probabilities and/or subpath probabilities may be stored or even computed. For example, to reduce computational complexity, statistically insignificant or highly improbable paths may be pruned, focusing computational resources on the most relevant and informative interactions.

In some embodiments, to ensure scalability and efficiency in complex environments, one or more optimization algorithms may be employed to streamline the calculation of path probabilities. For example, parallel processing techniques may be used to analyze multiple paths simultaneously, enhancing computational efficiency.

In some embodiments, the operations shown in FIG. 22 may be performed in an order different from that shown. For example, subpath probabilities may be computed first and then used to aid in the calculation of parent probabilities.

FIG. 23 illustrates a method 2300 of tuning a language model, performed in accordance with one or more embodiments. According to various embodiments, the method 2300 may be performed at any suitable computing device, such as one or more of the computing device shown herein.

A request to tune a large language model based on a set of path embeddings and path probabilities is received at 2302. In some embodiments, the large language model may be initially tuned based on a set of path embeddings, and then may be periodically re-tuned as additional path embeddings are received. In particular embodiments, the tuning may involve a low-rank adaptation procedure.

A set of initial parameter weights is determined at 2304. In some embodiments, the parameter weights may be initialized using any suitable initialization procedure.

A tuning dataset is determined at 2306 based on the path embeddings and path probabilities. In some embodiments, the tuning dataset may be determined by generating training data observations that include some elements of the path embeddings with other elements removed. For instance, the large language model may be given the first X words from a path embedding and be asked to predict the next Y words.

As discussed with respect to the method 2200 shown in FIG. 22, expected loss values may be determined based at least in part on the path probabilities. These expected loss values may be included in the tuning dataset to penalize the large language model for generating paths having a high expected loss.

In some embodiments, the loss function may simply reflect the path probabilities. That is, the path large language model may be penalized for producing paths of low probabilities. Alternatively, as discussed above, the path probabilities may be used as an input for a more complex loss function. For instance, path probabilities may be weighted based on user engagement and/or user retention. In this way, the large language model may be tuned to generate paths having higher engagement and/or retention rather than paths that have the highest probability or the greatest chance of success.

One or more tuning dataset entries are modified at 2308 based on the parameter weights. In some embodiments, a tuning dataset entry may be embedded in the input parameter space for the large language model. The resulting embedding may then be multiplied by the parameter space.

Predicted path embeddings are determined based on the modified tuning dataset entries at 2310. In some embodiments, the predicted path embeddings may be determined by providing the modified tuning dataset entries to the large language model and then parsing the responses received from the large language model.

One or more error values are determined at 2312 based on the predicted path embeddings and the loss function. In some embodiments, the error values may be determined by penalizing the model for generating paths that produce high loss values under the loss function.

A determination is made at 2314 as to whether to update the parameter weights. In some embodiments, the determination may be made at least in part by determining whether an error value exceeds a designated threshold.

At 2316, if it is determined to update the parameter weights, then a set of updated parameter weights are determined. According to various embodiments, any suitable method (e.g., gradient descent) may be used to update the parameter weights.

At 2318, if it is determined not to update the parameter weights, then the parameter weights are stored. The parameter weights may then be used to pre-process any input provided to the large language model.

FIG. 24 illustrates a method 2400 of determining a novel path, performed in accordance with one or more embodiments. According to various embodiments, the method 2400 may be performed at any suitable computing device, such as one or more of the computing device shown herein.

A request to generate a new path is received at 2402. In some embodiments, the request may be generated in the context of creating a new embedded environment. Alternatively, the request may be generated in the context of altering an existing embedded environment. As still another possibility, the request may be generated so as to provide instructions for an autonomous embedded avatar such as a robot in a physical environment or a non-playing character within a game or metaverse.

One or more input instructions for generating the new path are identified at 2404. In some embodiments, some or all of the input instructions may be provided in natural language. The input instructions may be provided via user input. Alternatively, or additionally, some or all of the input instructions may be retrieved from a storage system, where they are for instance stored as configuration parameters.

According to various embodiments, the nature of the input instructions may depend in part on the context in which the new path is requested. For example, the input instructions may instruct the tuned large language model to generate a path having a designated probability. As another example, the input instructions may instruct the tuned large language model to generate a path having particular characteristics. For instance, the path may involve a particular noun, verb, and/or modifier.

A path generation prompt template for path generation is identified at 2406. In some embodiments, the path generation prompt template may include natural language template instructions to the large language model instructing the large language model to generate a path. The path guidance prompt template may include one or more fillable portions in which information such as the input instructions and the prior path information may be embedded to create a prompt.

A path generation prompt is determined at 2408 based on the path generation prompt template and the one or more input instructions. In some embodiments, the path generation prompt may be determined by filling one or more fillable portions in the path generation prompt template with the input instructions.

The path generation prompt is transmitted to a large language model for analysis at 2410. A path generation prompt message is received from the large language model at 2412.

The path generation prompt response message is parsed at 2414 to determine a path embedding. In some embodiments, parsing the path generation prompt response message may involve extracting a portion of the prompt that includes a path embedding. The path embedding may identify, for instance, one or more sentences expressed in the path large language model grammar.

A path is determined at 2416 based on the path embedding. According to various embodiments, the way in which the path is determined at 2416 may vary based on the context in which the novel path is generated. For example, if the novel path is generated in the context of a robotics application, then the novel path may be generated by translating from the path embedding into one or more instructions interpretable by a controller device at a robot. As another example, if the novel path is generated in the context of environment design, then the novel path may be translated into environment components, events, or other such objects interpretable by an environment engine supporting the design or execution of the environment.

FIG. 25 illustrates a method 2500 of determining path guidance, performed in accordance with one or more embodiments. According to various embodiments, the method 2500 may be performed at any suitable computing device, such as one or more of the computing devices shown herein.

In some embodiments, the method 2500 may be used for training a human or autonomous controller of an avatar. The probabilities computed using the Feynman Path Integral concept may serve as the foundation for formulating a reward function within the PLLM for reinforcement learning. This reward function represents the success rate or objectives achieved by the avatar. By optimizing interactions based on this reward function, the PLLM guides the avatar through the environment, actively searching for the highest cumulative reward and improving its decision-making capabilities over time.

A request to provide guidance for an embedded avatar is received at 2502. In some embodiments, the request may be generated in the context of a game. For example, a user may provide user input indicating a request to receive guidance. As another example, guidance may be requested automatically based on some triggering condition. For instance, guidance may be requested when an avatar has repeatedly failed to overcome the same obstacle.

One or more input instructions for providing the guidance are identified at 2504. According to various embodiments, the one or more input instructions may be determined based on one or more configuration parameters. For example, in a “difficult” mode the one or more input instructions may instruct the language model to provide only a hint, while in an “easy” mode the one or more input instructions may instruct the language model to identify the best path.

A path guidance prompt template for determining path guidance is identified at 2506. In some embodiments, the path guidance prompt template may include natural language template instructions to the large language model instructing the large language model to generate guidance. The path guidance prompt template may include one or more fillable portions in which information such as the input instructions and the prior path information may be embedded to create a prompt.

Environment state and user state information for the embedded avatar is identified at 2508. In some embodiments, environment state may include any information characterizing the status or location of the embedded avatar. For instance, such information may include as a current environment part at which the avatar is located, a path traveled by the avatar to reach the current point in the embedded environment, and/or condition information associated with the avatar.

In some embodiments, user state information may characterize any information about the actor or autonomous system controlling the embedded avatar. For example, the user state information may characterize a user skill level, a user experience level, a user engagement level, a user retention level, or other such information.

A path guidance prompt is determined at 2510 based on the path guidance prompt template, the one or more input instructions, and the state information. In some embodiments, the path guidance prompt may be determined by filling one or more fillable portions in the path guidance prompt template with the input instructions and the state information.

At 2512, the path guidance prompt is transmitted for completion by a tuned large language model. A path guidance prompt response message is received from the tuned large language model at 2514.

The path generation prompt response message is parsed at 2516 to determine path guidance. In some embodiments, parsing the path generation prompt response message may involve extracting a portion of the prompt that includes a path embedding. The path embedding may identify, for instance, a suggested path that the actor controlling the avatar is advised to pursue. The path embedding may then be translated into information more immediately interpretable by an actor such as a human or an autonomous control process.

In some embodiments, parsing the path generation prompt response message may involve extracting information for providing one or more clues other than an explicit path. For instance, the completed prompt may include a natural language instruction to “Look around for another way through” rather than providing an explicit indication of a specific path to pursue.

The path guidance is transmitted to a remote computing device at 2518. In some embodiments, the path guidance may be sent as a message, sound (e.g., via text-to-speech) or graphic (e.g., an arrow) that is presented within the embedded environment.

A determination is made as to whether to provide additional path guidance at 2520. According to various embodiments, additional path guidance may continue to be provided until a terminating condition is met. For example, the avatar may overcome a designated obstacle. If additional path guidance is to be determined, then updated prior path information is determined at 2508, for instance based on one or more actions taken in response to the provided guidance.

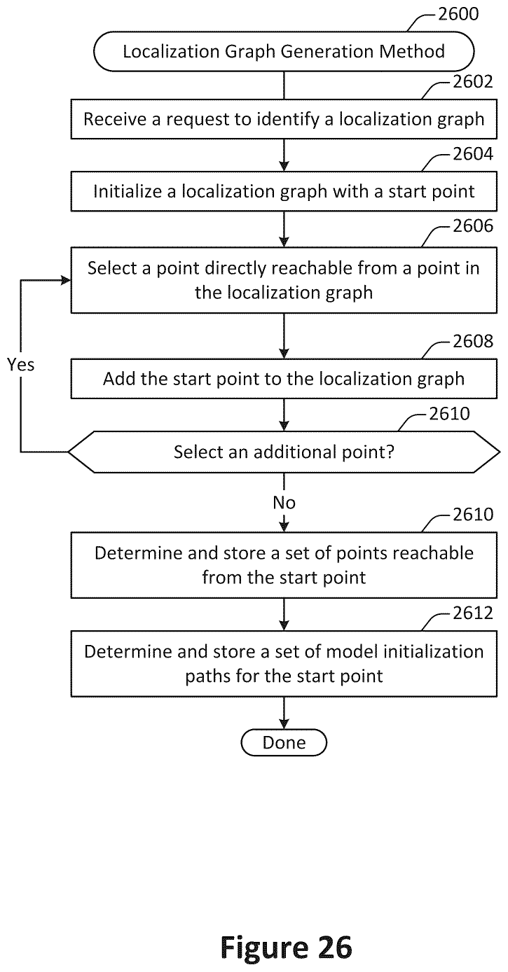

FIG. 26 illustrates a localization graph generation method 2600, performed in accordance with one or more embodiments. According to various embodiments, the method 2600 may be performed at any computing device described herein.

In some embodiments, the method 2600 may be used to determine a set of points (e.g., parts) reachable from a start point (e.g., a current part in a path). Alternatively, or additionally, the method 2600 may be used to identify a set of paths that may follow from a start point, for instance in solving a cold start problem by generating data to initially tune a PLLM.

A request to identify a localization graph is received at 2602. The request may be received initially, before path data is available, or later in a periodic fashion, when new path data has been received.

A localization graph is initialized with a start point at 2604. The start point may be any part in the environment reachable by an avatar or embedded avatar. The localization graph may be a directed graph that begins at the start point.

A point directly reachable from a point in the localization graph is selected at 2606. The start point is added to the localization graph at 2608. In some embodiments, a constraint may be imposed on point selection. For example, the point that is closest to the start point and that is not yet in the localization graph may be selected. As another example, a point may not be selected if the shortest path from the start point to the selected point were to exceed a designated threshold distance. As yet another example, a point may not be selected if the selected point is not reached from the start point in any path yet observed.

In some embodiments, a point directly reachable from a point in the localization graph may be identified by analyzing observed path data. Alternatively, or additionally, such a point may be identified by analyzing the environment itself. For instance, characteristics of an actual or simulated environment may be analyzed to identify a part that is reachable from another part.

At 2610, a determination is made as to whether to select an additional point. In some embodiments, additional points may continue to be selected until a terminating condition is met. For instance, additional points may continue to be selected until no selectable points remain, as discussed based on criteria such as those referred to with respect to operation 2608. As another example, additional points may continue to be selected until the localization graph reaches a designated size.

Upon determining not to select an additional point, a set of points reachable from the start point via the localization graph is determined and stored at 2610. The set of points may include any that have been added to the localization graph. In some embodiments, this set of points may be used to filter sentences in paths generated by the PLLM. For instance, when the PLLM generates a recommended path, the set of sentences included in the recommended path may be scanned to identify any that include a point that was not identified as reachable. If such a point is detected, the sentence that includes the identified point may be removed.

In some embodiments, this set of points may be used to filter paths determined by the PLLM. For instance, when the PLLM generates a recommended path, the set of sentences included in the recommended path may be scanned to identify any that include a point that was not identified as reachable. If such a point is detected, the recommended path may be rejected. Repeated instances in which the PLLM generates rejected paths may cause the model to be retuned.

A set of model initialization paths for the start point are optionally determined and stored at 2612. In some embodiments, the set of model initialization paths may be paths from the start point to any of the points in the localization graph. The initialization paths may be used as an initial input to the PLLM to tune the PLLM before sufficient empirical path data has been observed.

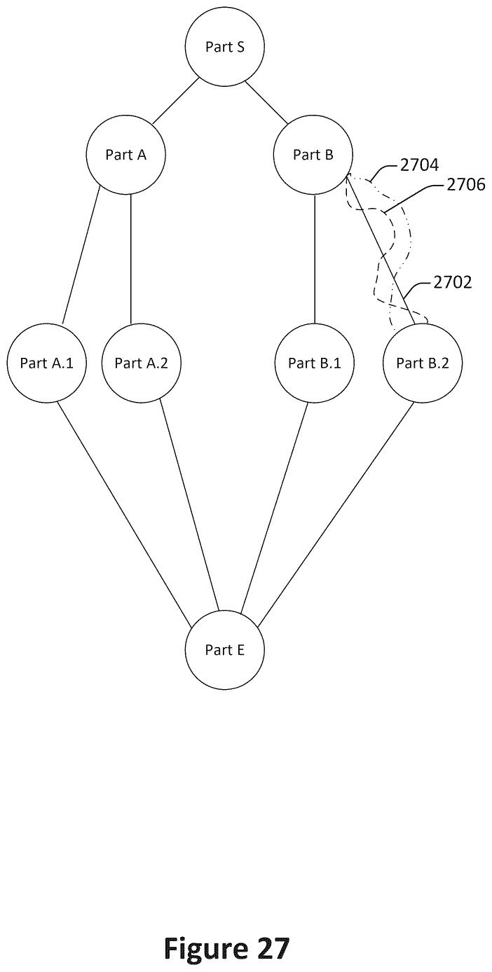

FIG. 27 illustrates a path diagram generated in accordance with one or more embodiments. In FIG. 27, the circles represent parts and the solid lines represent paths between parts. The dotted lines represent individual plays. As discussed herein, paths may use semantic embedding to effectively smooth out differences between similar plays. For instance, the subplay 2704 is different from the subplay 2706. However, because both subplays start at Part B and end at point B.2, the subpaths that result from these subplays are identical when converted to path language. For instance, both subplays may correspond to the sentence: “The Avatar moved to Part B.2”, depending on the characteristics of the grammar.

The techniques and mechanisms described above may be expanded in various ways. For example, the concept of a “path” may be expanded to encompass not only single events or sequences within one game or robotics task, but also to multiple games plays and/or multiple tasks performed over time. Such an approach may allow the system to incorporate information learned from multiple iterations and variations. As another example, loss functions may be expanded to account for financial transactions, more complex user engagement metrics, churn rates, and the like, providing a more holistic view of an avatar's interactions within the environment. As yet another example, the history of actions performed in an environment and/or modifications to an environment may be recorded on a blockchain, for instance to ensure transparency and accountability. As still another example, environment modifications may be coupled with a revenue distribution model, for instance a model managed by a Decentralized Autonomous Organization (DAO) to compensate creators of game modifications or robotic task sequences. Additional details regarding these and other expansions are discussed in the following passages.

In some implementations, the path language and PLLM may be refined to take into account not only single events or sequences within one task or game, but also the avatar's history across multiple tasks or games. Incorporating such past activity introduces the capacity to learn from the history of the avatar's interactions and adapt future actions accordingly. For example, if a robot has executed a particular task sequence across multiple environments, these historical interactions can be used to optimize the robot's future actions. As another example, a person who has performed a particular task sequence in one environment may have learned from the experience and on that basis be guided to a different task sequence in another environment. Such adaptation allows the system to create a more nuanced and effective path optimization process, improving the avatar's ability to manage complex and evolving environments.

According to various embodiments, the loss function used in reinforcement learning may be expanded in various ways. In the gaming or virtual environment context, the loss function may be expanded to include metrics such as churn minimization, player retention, player interaction rates, engagement maximization, and the like. In the robotics context, the loss function may be expanded to cover a robot's task execution sequence to minimize downtime, maximize efficiency, reduce task abandonment rates, reduce operation failure rates, reduce the number of unnecessary movements, or improve the quality of task completion. In both contexts, the loss function may be expanded to consider an avatar's history across multiple games and/or environments. Expanding the loss function to encompass a variety of situations may allow the system to select and/or optimize paths based not only on outcomes within the environment, but also on external factors.

In some embodiments, a loss function may be specified over more than one variable. For example, a loss function may penalize path recommendation based on a combination of task abandonment and unnecessary movement. As another example, a loss function may penalize path recommendation based on a combination of player engagement and player retention.

In some embodiments, the path language of the PLLM may be expanded to include a new class of nouns representing cryptocurrency transactions associated with actions within the paths. A cryptocurrency transaction may be linked with a unique identifier, similar to the identifiers used for environment parts. Such a linkage may facilitate the precise representation and optimization of financial transactions within the environment, such as purchasing virtual goods or equipment in a video game or allocating resources in a robotic task. For instance, a robot tasked with building a structure in the physical world or an avatar building a structure in a virtual world such as a metaverse may use resources in the course of such construction. These resources may be represented as cryptocurrency transactions. By integrating cryptocurrency transactions into the path language of the PLLM, the system may optimize not only the actions performed by or recommended to the avatar or robot, but also the associated financial transactions. For instance, the system may return a course of action that minimizes costs.

In some embodiments, a path language grammar may include various types of sentences that capture additional facets of avatar's interactions within the environment. The types of sentences may include, but are not limited to, sentence types for avatar control, interaction of avatars and other parts, interactions between parts, avatar decisions, execution of cryptocurrency transaction, and user actions. For example, a sentence type may capture a user action such as completing a task successfully. As another example, a sentence type may capture a user action such as liking and/or sharing a game modification, a game play, or a robotic task with others. Such expansions provide for a more detailed and nuanced representation of the avatar's actions and interactions within the environment. As one example of an additional type of sentence, a sentence such as “The robot moved OBJECT X to LOCATION Y, spending Z amount of cryptocurrency resources” where each of X, Y, and Z may be filled based on the particular activity being captured by the sentence.

According to various embodiments, in the context of user-generated content (UGC) games or user-programmed robotic tasks, the history of modifications (MODs) to a game environment or robotic task sequence may be recorded on a blockchain. The blockchain provides a transparent, immutable, and verifiable record of changes made to the game or task sequence, ensuring accountability. For instance, if a user modifies a game environment or alters a robotic task sequence, such a modification may be recorded on the blockchain. Such recordation may facilitate clear tracking of modifications, for instance helping resolve disputes about the origin of specific modifications.

In some embodiments, the unique identifier may be linked with a unique transaction ID on a blockchain. For instance, a MOD may be represented as a non-fungible token (NFT). MODs may then be linked with one or more cryptocurrency transactions. Such a linkage may allow a MOD to be bought, sold, licensed, and/or traded, with transactions recorded on the blockchain. For example, smart contracts may be used to automate licensing agreements. As another example, cryptocurrency transactions may be used to facilitate the purchase of virtual goods or equipment in a video gaming or metaverse environment. As yet another example, cryptocurrency transactions may be used to allocation resources in a robotics context.

In some embodiments, the unique identifier may be created by applying a function to one or more sentences expressed in the path language. The function may provide a one-to-one mapping between the path language and an identifier space. Accordingly, the function may be used to produce a unique identifier from a corresponding path sentence. Similarly, the function may be used to produce a corresponding path sentence from a unique identifier. Because a MOD may be expressed as one or more sentences in the path language, the function may then provide a mechanism for storing a MOD on a blockchain as a unique identifier and/or reconstructing a MOD from an identifier stored on a blockchain.

In some implementations, the association of a MOD with a unique identifier stored on a blockchain may facilitate a revenue distribution model. For instance, a percentage of revenue generated from a game modification or a robotic task sequence may be distributed to a creator associated with all or part of the game modification or robotic task sequence. When multiple creators are involved, revenue can be divided among them. Such an arrangement may encourage innovation by ensuring that those who create more new modifications or task sequences receive a larger portion of the revenue. At the same time, such an arrangement can also be used to reward the original creators, maintaining a balance between encouraging innovation and rewarding original creation. The specific ratio of revenue distribution can be dynamically adjusted based on factors such as the complexity of the modification, the number of users who use or benefit from the modification, and the overall impact of the modification on the game or task sequence. For instance, the revenue distribution may be configured to as to allocate a larger portion of the revenue to the creator of the new modification or task sequence and a smaller portion to the creator of a previous modification or task sequence on which the new modification or task sequence is based.

In some implementations, Decentralized Autonomous Organizations (DAOs) may be used to facilitate transactions related to MODs, UGC games, and/or robotic tasks. DAOs are organizations represented by transparent rules encoded as a computer program. A DAO is controlled by the members of the organization rather than rules established by a central government. For example, a DAO may be configured to provide for a decentralized and democratic decision-making process regarding the allocation of revenue shares among the contributors to a game modification or a robotic task sequence. Such an arrangement may facilitate a fairer and more transparent system for revenue distribution, fostering a sense of community and shared ownership among contributors. As another example, a DAO may be used in conjunction with the PLLM to govern a metaverse. For instance, By understanding the rules, regulations, and communal resources of the metaverse, the PLLM could predict and guide democratic decisions within the metaverse.

In some embodiments, smart contracts may be used to facilitate transactions related to MODs, UGC games, and/or robotic tasks. Smart contracts are self-executing contracts with the terms of the agreement directly written into lines of code. They are stored on the blockchain and automatically execute transactions when predetermined terms and conditions are met. In the context of the PLLM, specific actions or achievements may be configured to trigger automatic rewards in the form of cryptocurrency transactions based on linkages between the blockchain and MODs and/or paths.

According to various embodiments, the association of a MOD with a unique identifier may be used to evaluate a MOD. For example, the unique identifier may be used to replay a sequence of modifications leading to a MOD. As another example, the unique identifier may be used to review the evolution of an environment. As yet another example, the unique identifier may be used to facilitate debugging efforts.

In some embodiments, the unique identifier for a MOD may be used to perform command and control operations. For instance, the unique identifier may be translated into interpretable instructions. For example, instructions may be interpreted by a controller device at a robot. As another example, instructions may be interpreted by an environment engine supporting the design and/or execution of an environment.

In some embodiments, the unique identifier for a MOD may be used to guide or evaluate MOD creation decisions. For example, the unique identifier may be used as input for training AI/ML models to learn common or successful MODing sequences. Models trained in this fashion may then be used to suggest such sequences to users. Alternatively, or additionally, models trained in this fashion may be used to predict the potential impact of a MODing sequence before it is implemented.

In some embodiments, a virtual economy using cryptocurrencies within a metaverse or gaming environment may be provided. The PLLM may be utilized to learn and predict economic behaviors of avatars, thereby enhancing the overall economic dynamics of the environment. For instance, optimal behavior may be learned and predicted, which may be used to provide recommendations for future actions.

In some embodiments, the PLLM may be extended to encompass Decentralized Finance (DeFi) transactions and operations within a metaverse or gaming environment. For instance, the model may learn and predict financial interactions such as lending, borrowing, or earning interest on cryptocurrencies. Such an extension may be used to influence the path-selection process.

In some embodiments, NFTs may be integrated into the path language used by the PLLM. NFTs may be used to uniquely identify avatars or objects within the environment. Such identification may enhance the PLLM's ability to understand and predict interactions involving unique virtual items.

In some implementations, the PLLM may perform real-time path adjustment based on dynamic changes in the environment. These real-time path adjustments may enhance the PLLM's adaptability and help to ensure that a robot's or avatar's actions remain recommended in the face of unexpected environmental changes.

In some embodiments, the PLLM may be applied in augmented reality/virtual reality (AR/VR) settings. By understanding and predicting user interactions in AR/VR, the PLLM may enhance user immersion in a metaverse or gaming environment.

In some embodiments, the PLLM may predict user behavior based on past paths. Such extension may allow the system to provide personalized experiences and proactive guidance within the environment.

In some implementations, social interactions between multiple avatars may be modeled and managed. For instance, the avatars may interact within a metaverse setting. By understanding the social dynamics of the environment, the PLLM may predict and guide social interactions.

In some embodiments, the PLLM may be applied across different platforms and devices. In this way, the user may be provided with a consistent user experience in a game or metaverse environment irrespective of the device used.

In some embodiments, privacy and security mechanisms for protecting user data and transactions within the environment may be incorporated into the PLLM. For instance, the PLLM may learn and predict potential security risks, which may allow it to contribute to building trust and promoting wider adoption of the metaverse or game.

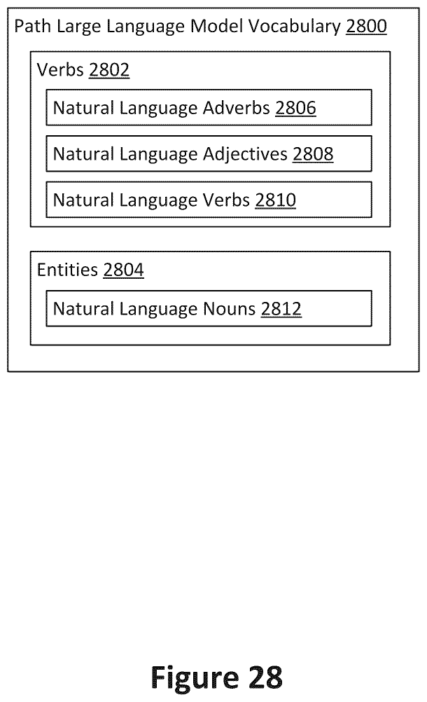

FIG. 28 shows a conceptual diagram of the path large language model vocabulary 2800. As discussed herein, the path large language model vocabulary 2800 includes verbs 2802 and entities 2804. The path large language model entities 2804 correspond conceptually with natural language nouns 2812, while the path large language model verbs 2802 correspond conceptually with natural language adverbs 2806, natural language adjectives 2808, and natural language verbs 2810.

In some embodiments, a single triggering event can lead to the performance of multiple verbs by the same adjective. For instance, a script may indicate that an entity is “happy walking slowly” if a triggering event is detected. Such an action description includes a verb (i.e., “walking”), an adjective (i.e., “happy”), and an adverb (i.e., “slowly”). Such an entity may be animated as slowly moving from one point to another using a walking animation while expressing a happy emotion.

### II.6. Agentic Pipeline

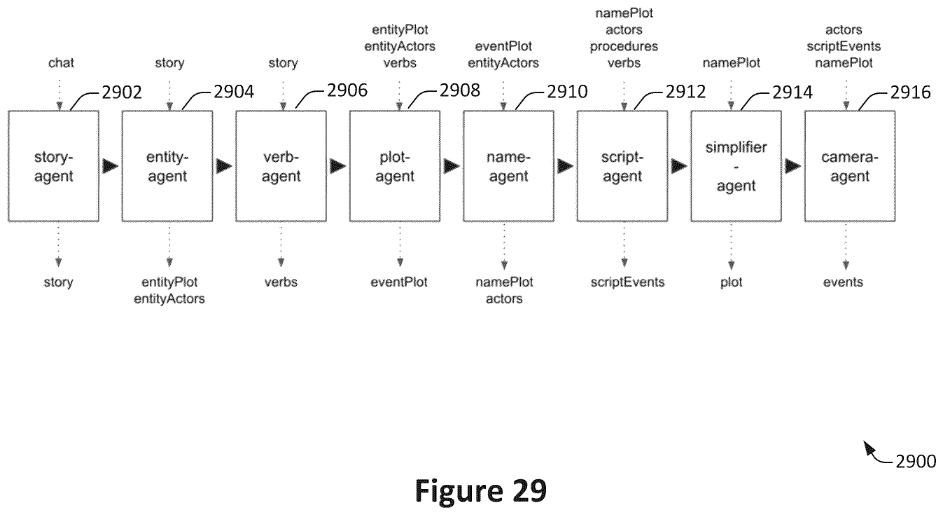

In some embodiments, techniques and mechanisms described herein for generating a 3D interactive script may employ an agentic configuration. FIG. 29 illustrates an example pipeline 2900 for generating a 3D interactive script, configured in accordance with one or more embodiments. In FIG. 29, the different boxes correspond to generative language model agents. The elements above the boxes correspond to inputs, while the elements below the boxes correspond to outputs. It should be noted that the pipeline 2900 shown in FIG. 29 is only an example of a pipeline that may be used, and that a 3D interactive script consistent with techniques and mechanisms described herein may be configured in a different manner.

At 2902, a story agent receives as input chat input and generates a story from the chat input. At 2904, an entity agent receives as input the story and determines an entity plot and entity actors. At 2906, a verb agent receives as input the story and determines the verbs to employ in the 3D interactive script. At 2908, a plot agent receives as input the entity plot, entity actors, and entity verbs and generates an event plot. At 2910, a name agent receives as input the event plot and the entity actors and generates as output the name of the plot and the actors. At 2912, the script agent receives as input the name of the plot and the actors, the procedures, and the verbs and generates a script that includes one or more events. At 2914, a simplifier agent receives as input the name of the plot and generates the plot. For instance, the simplifier agent may replace duplicative elements in the plot such as similar events for different entities with parameterized events that may be applied to different entities. At 2916, the camera agent receives as input the actors, the script events, and the name of the plot and generates the set of events to include in the final script.

According to various embodiments, each of the agents shown in FIG. 29 may correspond to one or more prompts that are completed by a generative language model. For instance, the story agent may correspond to a prompt that includes natural language instructions to generate a story based on the chat input.

In some embodiments, the path language model is conducive to a highly agentic configuration. Conventional techniques for generating animation convert text input directly to video output. In contrast, various embodiments described herein generate multiple intermediate elements, including a story, a plot, one or more actors, one or more verbs, and one or more events. These different intermediate elements can be generated by different agents, eliminating the need for a monolithic process.

In some embodiments, the path language model is conducive to granular revision of a 3D interactive script. Because conventional techniques for generating animation convert text input directly to video output, the generated animation cannot be directly revised in a semantic sense. That is, the elements included in an animation generated using conventional techniques do not have semantic meaning in the final animation. In contrast, a 3D interactive script generated in accordance with one or more embodiments described herein includes components such as a story, a plot, one or more actors, one or more verbs, and one or more events. Accordingly, the system can support iterative editing of such a 3D interactive script by using the intermediate elements along with user input to revise the intermediate elements. For instance, the system could, responsive to user input, revise an entity, a verb, or an event within the 3D interactive script while leaving other elements of the 3D interactive script intact.

Provided below is a simplified example of inputs and outputs used to generate an example 3D interactive script, in accordance with one or more embodiments. The final output includes events that can be interpreted by an interpreter to provide a 3D interactive experience. As discussed herein, in some embodiments verbs can correspond to animations that apply to any entity, including entities without predefined animation rigs.

### Inputs and Outputs:

```
{
″chat″: ″I′d like to create an interactive scene with a little girl, who continually says
′Hi′ until tapped three times. After the third tap, she stops saying ′Hi′ and randomly
plays one of these sounds:
[https://cdn.freesound.org/previews/704/704965_15251455-lq.mp3,
https://cdn.freesound.org/previews/704/704965_15251455-lq.mp3]. Once a sound
has played, she exclaims ′Yay!′ ending the interaction.″,
″story″: ″A little girl, continually says ′Hi′ until she is tapped three times. After the
third tap, she stops saying ′Hi′ and randomly plays one of these sounds:
[https://cdn.freesound.org/previews/704/704965_15251455-lq.mp3,
https://cdn.freesound.org/previews/704/704965_15251455-lq.mp3]. Once a sound
has played, she exclaims ′Yay!′ ending the interaction.″,
″entityActors″: [
  {
    ″type″: ″Young Girl″
  }
],
″entityPlot″: ″A little girl, continually says ′Hi′ until she is tapped three times. After
the third tap, she stops saying ′Hi′ and randomly plays one of these sounds:
[https://cdn.freesound.org/previews/704/704965_15251455-lq.mp3,
https://cdn.freesound.org/previews/704/704965_15251455-lq.mp3]. Once a sound
has played, she exclaims ′Yay!′ ending the interaction.″,
″eventPlot″: ″At %SceneStarts% <Young Girl> repeatedly |Say| +Hi+. When <Young
Girl> is %Tapped% 3
times, she will |DisableEvent|, |Say| +Hi+ and
|PlayAnyOfSoundURLs| :
\hat{ }https://cdn.freesound.org/previews/704/704965_15251455-lq.mp3\hat{ },
\hat{ }https://cdn.freesound.org/previews/704/704965_15251455-lq.mp3\hat{ }. After the
sound %CompletedEvent%, <Young Girl> will |Say| +Yay+ and then |EndMOD|.″,
  ″actors″: [
  {
    ″name″: ″Emily″,
    ″type″: ″Young Girl″
  }
],
″namePlot″: ″At %SceneStarts% <Emily> repeatedly |Say| +Hi+. When <Emily> is
%Tapped% 3 times, she will |DisableEvent|, |Say | +Hi+ and |PlayAnyOfSoundURLs|:
\hat{ }https://cdn.freesound.org/previews/704/704965_15251455-lq.mp3\hat{ },
\hat{ }https://cdn.freesound.org/previews/704/704965_15251455-lq.mp3\hat{ }. After the
sound %CompletedEvent%, <Emily> will |Say| +Yay+ and then |EndMOD|.″,
″plot″: ″When the scene starts, Emily repeatedly says ′Hi′. When Emily is tapped three
times, she stops saying ′Hi′ and randomly plays one of several sounds. After the sound
finishes, Emily says ′Yay′ and the scenario ends.″,
″scriptEvents″: [
  {
    ″id″: 0,
    ″repeatable″: true,
    ″enabled″: true,
    ″trigger″: {
      ″triggerType″: ″AlwaysActive″,
      ″args″: { }
    },
    ″action″: {
      ″actionType″: ″Say″,
      ″args″: {
        ″sentence″: ″Hi″,
        ″actor″: {
          ″name″: ″Emily″
        }
      }
    }
  },
  {
    ″id″: 1,
    ″repeatable″: false,
    ″enabled″: true,
    ″trigger″: {
    ″triggerType″: ″Tapped″,
      ″args″: {
      ″actor″: {
      ″name″: ″Emily″
      },
      ″occurrences″: 3
      }
    },
    ″action″: {
      ″actionType″: ″DisableEvent″,
      ″args″: {
      ″eventId″: 0
      }
    }
  },
  {
    ″id″: 2,
    ″repeatable″: false,
    ″enabled″: true,
    ″trigger″: {
      ″triggerType″: ″CompletedEvent″,
      ″args″: {
      ″eventId″: 1
      }
    },
    ″action″: {
      ″actionType″: ″PlayAnyOfSoundURLs″,
      ″args″: {
      ″soundList″: [
        {
        ″url″: ″https://cdn.freesound.org/previews/704/704965_15251455-lq.mp3″,
        ″durationMs″: 2115
        },
        {
        ″url″: ″https://cdn.freesound.org/previews/704/704965_15251455-lq.mp3″,
        ″durationMs″: 10143
        }
      ]
      }
    }
  },
  {
    ″id″: 3,
    ″repeatable″: false,
    ″enabled″: true,
    ″trigger″: {
      ″triggerType″: ″CompletedEvent″,
      ″args″: {
      ″eventId″: 2
      }
    },
    ″action″: {
      ″actionType″: ″Say″,
      ″args″: {
      ″sentence″: ″Yay!″,
      ″actor″: {
      ″name″: ″Emily″
      }
    }
  },
  {
    ″id″: 4,
    ″repeatable″: false,
    ″enabled″: true,
    ″trigger″: {
      ″triggerType″: ″CompletedEvent″,
      ″args″: {
      ″eventId″: 3
      }
    },
    ″action″: {
      ″actionType″: ″EndMOD″,
      ″args″: { }
    }
  }
],
″events″: [
  {
    ″id″: 0,
    ″repeatable″: false,
    ″enabled″: true,
    ″trigger″: {
      ″triggerType″: ″SceneStarts″,
      ″args″: { }
    },
    ″action″: {
      ″actionType″: ″LookAt″,
      ″args″: {
      ″actor″: {
        ″name″: ″Camera″
      },
      ″targetActor″: {
        ″name″: ″Emily″
      }
      }
    }
  },
  {
    ″id″: 1,
    ″repeatable″: true,
    ″enabled″: true,
    ″trigger″: {
      ″triggerType″: ″AlwaysActive″,
      ″args″: { }
    },
    ″action″: {
      ″actionType″: ″Say″,
      ″args″: {
      ″sentence″: ″Hi″,
      ″actor″: {
        ″name″: ″Emily″
      }
      }
    }
  },
  {
    ″id″: 2,
    ″repeatable″: false,
    ″enabled″: true,
    ″trigger″: {
      ″triggerType″: ″Tapped″,
      ″args″:{
      ″actor″: {
        ″name″: ″Emily″
      },
      ″occurrences″: 3
      }
    },
    ″action″: {
      ″actionType″: ″DisableEvent″,
      ″args″: {
      ″eventId″: 1
      }
    }
  },
  {
    ″id″: 3,
    ″repeatable″: false,
    ″enabled″: true,
    ″trigger″: {
      ″triggerType″: ″CompletedEvent″,
      ″args″: {
      ″eventId″: 3
      }
    },
    ″action″: {
      ″actionType″: ″Shake″,
      ″args″: {
      ″strength″: ″weak″,
      ″durationMs″: 1000,
      ″actor″: {
        ″name″: ″Camera″
      }
    }
  },
  {
    ″id″: 4,
    ″repeatable″: false,
    ″enabled″: true,
    ″trigger″: {
      ″triggerType″: ″CompletedEvent″,
      ″args″: {
      ″eventId″: 2
      }
    },
    ″action″: {
      ″actionType″: ″PlayAnyOfSoundURLs″,
      ″args″: {
      ″soundList″: [
      {
        ″url″: ″https://cdn.freesound.org/previews/704/704965_15251455-lq.mp3″,
        ″durationMs″: 2115
      },
      {
        ″url″: ″https://cdn.freesound.org/previews/704/704965_15251455-lq.mp3″,
        ″durationMs″: 10143
      }
      ]
      }
    }
  },
  {
    ″id″: 5,
    ″repeatable″: false,
    ″enabled″: true,
    ″trigger″: {
      ″triggerType″: ″CompletedEvent″,
      ″args″: {
      ″eventId″: 4
      }
    },
    ″action″: {
      ″actionType″: ″Say″,
      ″args″: {
      ″sentence″: ″Yay!″,
      ″actor″: {
        ″name″: ″Emily″
      }
    }
    }
  },
  {
    ″id″: 6,
    ″repeatable″: false,
    ″enabled″: true,
    ″trigger″: {
      ″triggerType″: ″CompletedEvent″,
      ″args″: {
      ″eventId″: 5
      }
    },
    ″action″: {
      ″actionType″: ″EndMOD″,
      ″args″: { }
    }
  }
]
}
```

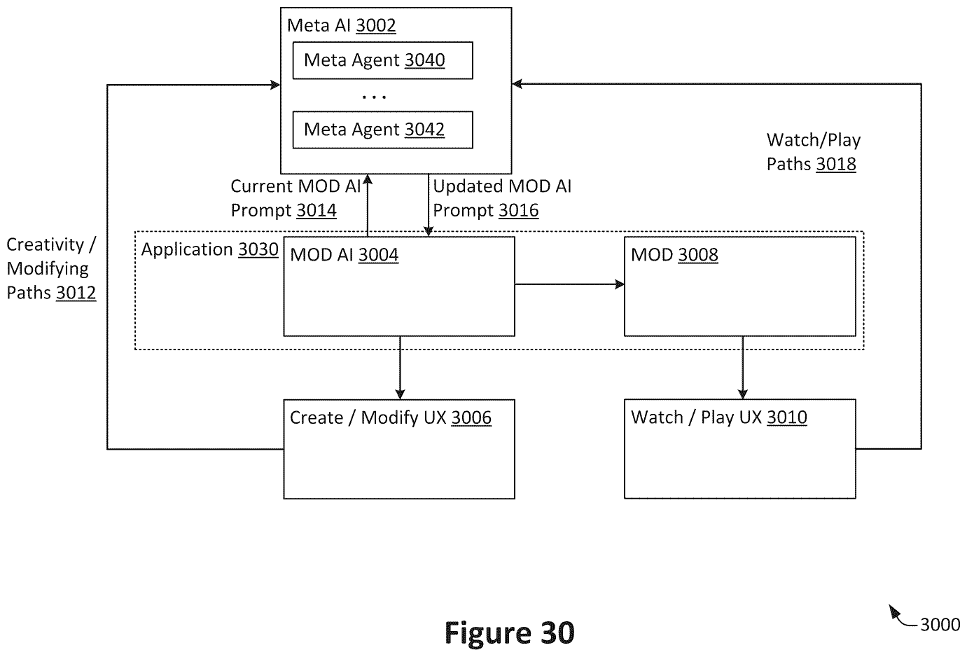

FIG. 30 illustrates a diagram of an ecosystem 3000 for providing a three-dimensional interactive virtual environment, configured in accordance with one or more embodiments. For the purpose of exposition, a three-dimensional interactive virtual environment is referred to in FIG. 30 as a MOD.

In some embodiments, an interactive three-dimensional virtual environment 3008 can be watched, played, or interacted with via a user interface at a client machine 3010. The interactive three-dimensional virtual environment 3008 can be created via an artificial intelligence environment creation process 3004. Additional details regarding the creation process 3004 are discussed throughout the application as filed, for instance with respect to the flow 2900 shown in FIG. 29.

In some embodiments, a meta interactive three-dimensional virtual environment refinement process 3002 may be used to refine an interactive three-dimensional virtual environment via reinforcement learning with human feedback (RLHF). For example, the meta interactive three-dimensional virtual environment refinement process 3002 may receive as input watch, play, and interaction paths 3018 that are generated via the client machine interface 3010. As another example, the meta interactive three-dimensional virtual environment refinement process 3002 may receive as input the current prompt from the existing the interactive three-dimensional virtual environment at 3014. As yet another example, the meta interactive three-dimensional virtual environment refinement process 3002 may receive as input one or more paths 3012 generated by a dedicated creation/modification interface 3006 for directly modifying the interactive three-dimensional virtual environment. As still another example, the meta interactive three-dimensional virtual environment refinement process 3002 may receive as input detailed analytics on the performance of the interactive three-dimensional virtual environment.

In some embodiments, one or more operations within the meta AI 3002 may be implemented via a meta agent such as the meta agents 3040 through 3042. The meta agents may be responsible for changing elements of the system itself, such as prompts used by the agents shown in FIG. 29 to determine various elements of a path language embedding. Each meta agent may be composed of one or more meta prompts, which each may include one or more meta components and one or more named components.

In some embodiments, such input can be accompanied by loss function output for a path indicating, for instance, which paths are more or less preferred. The loss function may be similar or identical to that used for the path large language model.

According to various embodiments, FIG. 30 illustrates a configuration in which input content (e.g., text, image, sound, and/or video) may be received and used to create an interactive three-dimensional virtual environment. The interactive three-dimensional virtual environment can be repetitively refined to create updated (e.g., better) interactive three-dimensional virtual environments. Input for refining the interactive three-dimensional virtual environment may be received from a user who generated the interactive three-dimensional virtual environment, from another user accessing the interactive three-dimensional virtual environment via the internet, and/or other sources (e.g., a robot or autonomous actor navigating the interactive three-dimensional virtual environment).

In some embodiments, the output of the refinement process may include updated prompts used to create the three-dimensional virtual environment. By executing these prompts, the refinement may be reflected in the script of the interactive three-dimensional virtual environment, in the actions of agents within the interactive three-dimensional virtual environment, or in any other aspect of the interactive three-dimensional virtual environment.

In some embodiments, the refinement process may involve fine tuning of a generative language model underlying the generation of the interactive three-dimensional virtual environment. For instance, one or more weights may be adjusted to cause a large language model to generate a different interactive three-dimensional virtual environment for the same prompt. In some embodiments, the generative language model may be refined in combination with revisions to the prompt.

In some embodiments, the meta interactive three-dimensional virtual environment refinement process 3002 may include an autotest agent. The autotest agent may employ a set of test media inputs to determine whether an updated interactive three-dimensional virtual environment is improved relative to the same loss function. The changes may be accepted if an improvement is detected. Otherwise the changes may be discarded.

In some embodiments, the meta interactive three-dimensional virtual environment refinement process 3002 may be used to repeatedly update the interactive three-dimensional virtual environment over time. The interactive three-dimensional virtual environment may continue to be updated until a triggering condition is met. For example, the interactive three-dimensional virtual environment may continue to be updated until a user indicates that the interactive three-dimensional virtual environment is finalized. As another example, the interactive three-dimensional virtual environment may continue to be updated until further refinement does not yield significant improvement.

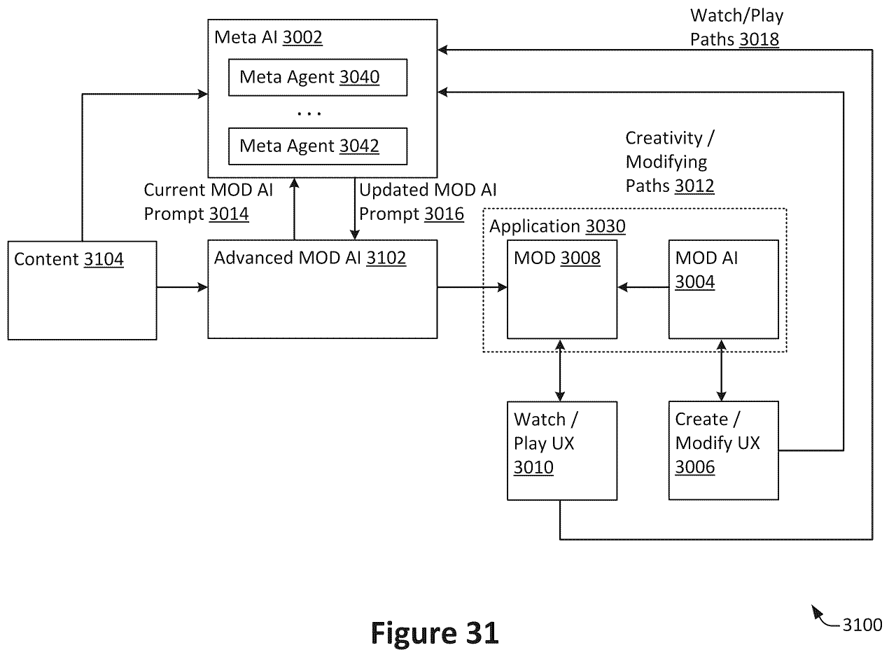

FIG. 31 illustrates a diagram of an ecosystem 3100 for providing a three-dimensional interactive virtual environment, configured in accordance with one or more embodiments. In many respects, the ecosystem 3100 is the same as the ecosystem 3000 shown in FIG. 30. However, in FIG. 31, an interactive three-dimensional virtual environment may be further improved by one or more experts via an advanced interactive three-dimensional virtual environment refinement process 3102.

In some embodiments, the advanced interactive three-dimensional virtual environment refinement process 3102 may be used to refine a plan or story that has proven to be highly effective. For instance, a plan or story may be used to generate a highly engaging three-dimensional virtual environment or a highly effective script for a robot agent. For example, an expert may refine a three-dimensional virtual environment by changing the inputs in one or more stages of creating the three-dimensional virtual environment as discussed with respect to the flow illustrated in FIG. 29.

In some embodiments, an expert may provide human feedback to the three-dimensional virtual environment generation process. This human feedback may aid in creating three-dimensional virtual environments that score better under the loss function. The interactions may be captured in the creation path.

In some embodiments, the system may support such expert interaction while at the same time providing a simpler version of the creation process at 3004 that is more accessible to non-expert users. Thus, a three-dimensional virtual environment may be created and/or refined based on input from one or more non-expert creators, one or more expert creators, and/or potentially many end users interacting with the three-dimensional virtual environment. Input from any or all of these users may be captured in the modifying path.

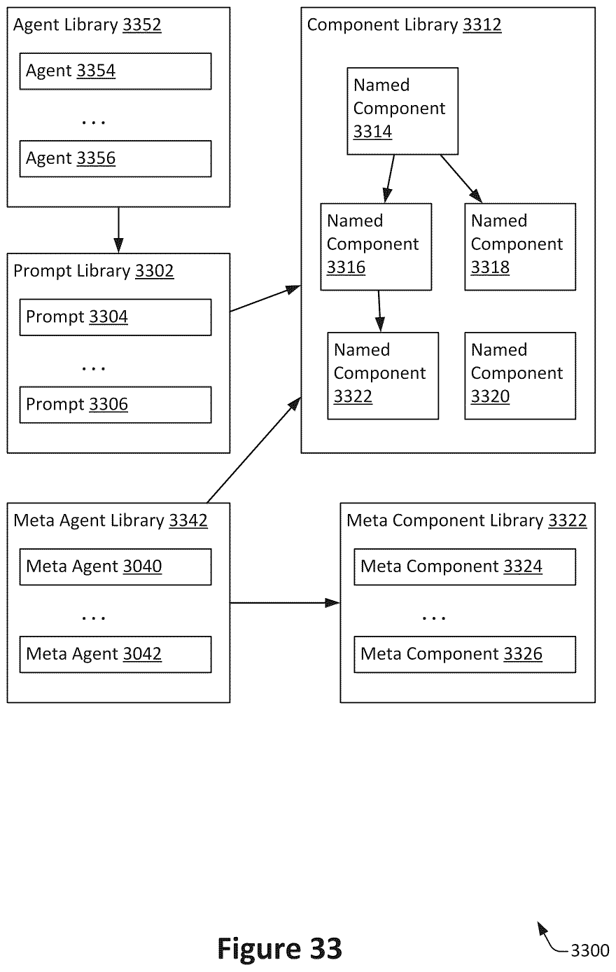

FIG. 33 illustrates a data model diagram 3300, configured in accordance with one or more embodiments. The data model diagram 3300 illustrates various elements for organizing agents and prompts in accordance with a normal form agentic AI architecture data model.

In some embodiments, agents 3354 through 3356 are stored in an agent library 3352. Examples of the agents 3354 through 3356 are shown in FIG. 29. For example, an agent may be responsible for determining scripts, determining entities, determining actions, and/or performing other such operations.

In some embodiments, an agent may rely on one or more prompts, such as the prompts 3304 through 3306. Prompts may be completed by a generative language model to generate novel text, such as elements of path language embeddings and/or scripts. Prompts may be stored in the prompt library 3302.

In some embodiments, prompts may be specified in terms of components. The components 3314 through 3322 (including 3316, 3318, 3320, and potentially many more) may be stored in the component library 3312.

In some embodiments, components may refer to other components by name, as shown in FIG. 33. Thus, components may be arranged in a graph-like data structure. Further, the need for duplication may be eliminated, so that a portion of text defined as a component can then be referenced by the name of the component without needing to be repeated.

In some embodiments, a component may be a portion of text. Components, and other elements shown in FIG. 33, may be stored in a version control system, such as Git. In this way, the changing characteristics of the components over time may be reflected.

In some embodiments, meta agents such as the meta agent 3040 through the meta agent 3042 may be stored in the meta agent library 3342. Meta agents may be composed of components and meta components. Meta agents may be tasked with improving the agents 3354 through 3356, for instance by adding or modifying prompts and components and/or by modifying the prompts and components included in the agents.

In some embodiments, the meta components 3324 through 3326 may be stored in meta component library 3322. The meta components 3324 through 3326 may specify higher level operations related to the modification of components and prompts. For example, a meta component may specify an operation for splitting an agent into two different agents. Such higher level operations need not be included in the agents that are producing path language embeddings and scripts, but may be needed when modifying the agents themselves.

According to various embodiments, the data model and architecture shown in FIG. 33 may support the flexible updating of a variety of elements discussed herein. For example, the agents 3354 through 3356 may apply prompts stored in the prompt library 3302 to dynamically determine elements of path language embeddings and scripts. As another example, the meta agents 3040 through 3042 may dynamically update the agents 3354 through 3356 by dynamically updating the components and/or meta components that make up the prompts included in or referenced by the agents.

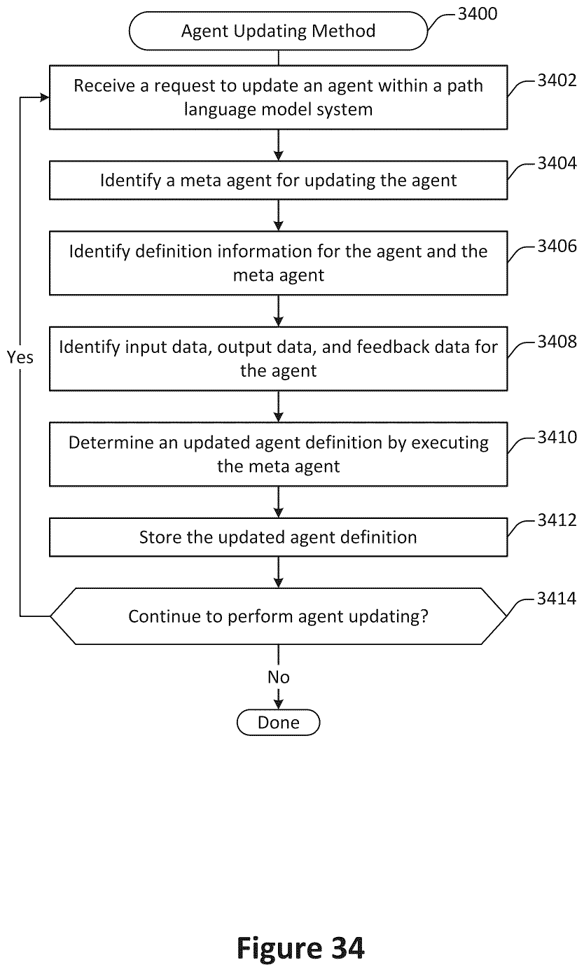

FIG. 34 illustrates a method 3400 for updating an agent, performed in accordance with one or more embodiments. The method 3400 may be performed to update one or more of the agents in the agentic AI pipeline shown in FIG. 29.

A request to update an agent within a path language model system is received at 3402. In some embodiments, the request may be generated periodically, for instance once on a daily or weekly basis. Alternatively, an agent may be updated when a determination is made that the agent's performance has fallen below a designated threshold based on feedback data collected in the system.

A meta agent for updating the agent is identified at 3404. In some embodiments, as shown in FIG. 33, a meta agent may include one or more components and/or meta components that collectively form prompts for updating one or more agents. A meta agent may correspond to one or more agents. For instance, a meta agent may include components corresponding with an agent as well as one or more meta components for updating those components.

Definition information for the agent and the meta agent is identified at 3406. In some embodiments, the definition information may be retrieved from the normal form agentic AI data model shown in FIG. 33.

Input data, output data, and feedback data for the agent are identified 3408. In some embodiments, the input data may include user input, intermediate values, and/or other information used by the agent to generate a path language model representation. The output data may include a path language model representation, intermediate values, or other information generated by executing the agent. The feedback data may include a loss function, loss function output values, user feedback, or other information for evaluating the output data.

An updated agent definition is determined at 3410 by executing the meta agent. In some embodiments, executing the meta agent may involve determining a prompt for the meta agent. The prompt for the meta agent may include one or more meta components, one or more components, and/or some or all of the input data, the output data, and the feedback data. As discussed with respect to FIG. 33, the meta components may include instructions for updating the components based on the input data, the output data, and/or the feedback data.

In some embodiments, the prompt may then be completed by a generative language model to determine updated definition information for the agent. The updated definition information may reflect any of various changes to the agent definition. For example, the text included in one or more of the components may be changed. As another example, new components may be added to and/or removed from the agent. As yet another example, a preexisting component may be split into two or more different components.

The updated agent definition is stored at 3412. The agent definition may be stored in accordance with the data model shown in FIG. 33. The updated agent definition may be used to execute the agent within the agent pipeline as shown in FIG. 29 to generate path language model definitions.

A determination is made at 3414 as to whether to continue to perform agent updating. In some embodiments, additional agent updating may be performed until updated component information is determined for all agents identified in the request received at 3402. Alternatively, or additionally, updated outcome information may be determined based on the updated agent definition, for instance by executing the updated agent. The updated outcome information may then be compared with feedback data to determine whether to continue updating the agent.

### 7. Video Generation

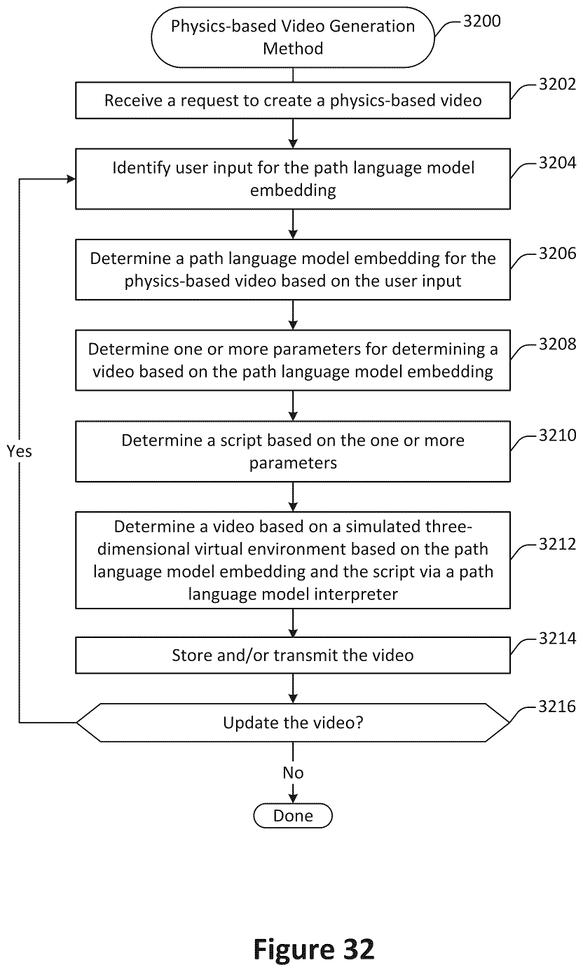

As discussed herein, various embodiments support the creation of videos, which may or may not be interactive. FIG. 32 illustrates a method 3200 of generating a video in accordance with such techniques, performed in accordance with one or more embodiments. Although these techniques are already described elsewhere in the application, FIG. 32 is provided to illustrate the power of such techniques for video generation.

A request to create a physics-based video is received at 3202. According to various embodiments, the request may be generated as discussed with respect to operations 102, 602, and 604. User input for the path language model embedding is identified at 3204. As discussed herein, various types of user input may be received, including text, images, video, sounds, other types of input, and/or multi-modal input.

At 3206, an original path language model embedding is determined for the physics-based video based on the original user input. According to various embodiments, such a path language model embedding may be determined as described herein, for instance with respect to the method 600 shown in FIG. 6.

One or more parameters for determining a video based on a path language model embedding are determined at 3208. According to various embodiments, the one or more parameters may be used to determine a sequence of states for the a three-dimensional representation of the path language model embedding for the purpose of rendering a video.

In some embodiments, the one or more parameters may be determined by a machine learning and/or artificial intelligence model. For example, such a model may be trained based on historical path data collected from client machines. The model may then receive the path language embedding as input and produce one or more parameters for determining a script representative of an actual playthrough by a person.

In some embodiments, the one or more parameters may be determined based on natural language input and/or other types of user input. For example, a user may provide natural language input, one or more clicks, or other such input leading to one or more events, actions, states, or other characteristics to occur in the three-dimensional environment during the video.

According to various embodiments, the script may represent a sequence of events to occur in a simulation based on the path language embedding. For example, one object moves near to another object, which then reacts based on the proximity of the first object. As another example, simulated user input representing a user mouse click activates a portion of the user interface at a particular point in time. The events represented in the script may then be processed based on the triggers included in the path language embedding and the physics engine in which the three-dimensional virtual environment is simulated. The physics engine may provide for various types of actions that need not be explicitly simulated. For instance, objects represented in the three-dimensional virtual environment may be affected by virtual gravity.

A video is determined at 3212 via a path language model interpreter. In some embodiments, the video may be determined based on a simulated three-dimensional virtual environment, which may be generated based on the path language model embedding and the one or more parameters. Determining the video may involve simulating the three-dimensional virtual environment via a physics engine and then recording a video of the simulated three-dimensional virtual environment from the perspective of one or more virtual cameras within the simulated three-dimensional virtual environment. The location of the one or more virtual cameras may be determined automatically or may be determined based on the one or more parameters.

According to various embodiments, such a video may be generated as described herein, for instance with respect to the method 700 shown in FIG. 7. The path language model interpreter may be a game engine, a 3D simulator, a physics engine, or any other type of engine capable of interpreting and rendering the path language model embedding.

In some embodiments, the state of the simulated three-dimensional virtual environment may be determined based on the one or more parameters determined at 3208. For instance, one or more entities within the simulated three-dimensional virtual environment may act in accordance with the one or more parameters.

The video is stored and/or transmitted at 3214. The video may be stored on any suitable storage device at the server. Alternatively, or additionally, the video may be transmitted to a client machine. The client machine to which the video is transmitted may be the client machine from which the request to generate the video originated. Alternatively, or additionally, the video may be transmitted to a different client machine, for instance a client machine accessing the video via a video sharing website.

A determination is made at 3216 as to whether to update the video. In some embodiments, the determination may be made based on user input. For example, the receipt of user input is discussed with respect to operation 108 shown in FIG. 1, as well as with respect FIG. 29, FIG. 30, and FIG. 31. A request to update the path language model embedding may be received from a user interface implemented at the client machine.

In some embodiments, one or more of the operations performed as discussed with respect to the method 3200 may be performed by an agent as shown in FIG. 29. For instance, a script may be determined by the script agent 2912, while one or more entities may be determined by the entity agent 2904.

Upon determining to update the video, additional user input for updating the path language model embedding and/or the one or more parameters is identified at 3204. According to various embodiments, any of the types of user input discussed herein may be received. For example, a user may provide or indicate user input such as text, touch, video, audio, or multi-modal input via a user interface at the client machine. As another example, paths traveled in the video if the video is implemented as an interactive 3D virtual environment may be provided as input.

According to various embodiments, the additional user input may be used to update the path language model embedding, the one or more parameters for determining the simulated three-dimensional virtual environment, or both. For example, the user input may lead to adding, changing, or removing one or more entities, verbs, or other elements to the path language model embedding. As another example, the user input may lead to a different configuration of elements within the three-dimensional virtual environment that is simulated based on the path language model embedding.

According to various embodiments, in the event that the path language model embedding is updated based on user input, the updated path language model may be determined based on the original user input, the additional user input, and the previous path language model embedding(s). The updated path language model embedding may be determined as discussed with respect to the method 600 shown in FIG. 6. In this way, the previously created path language model embedding, which is encoded as text, may be conversationally modified via the updated user input. Alternatively, the video may be conversationally modified without modifying the path language model embedding. For instance, different parameters may be specified, which may lead to a different video even though the path language embedding has not changed.

The techniques described herein may provide for physics-based video generation in a manner that offers significant improvements over conventional approaches. For example, conventional approaches to video generation using generative AI models proceed directly from input to video generation, without an intermediate phase in which an embedding is produced (e.g., operation 3204). Producing videos via such a conventional approach typically involves tens of millions of tokens and significant computing costs. Furthermore, videos produced via such a conventional approach are not modifiable based on additional user input, but rather must be entirely recreated based on new user input. That is, a user who wishes to modify a video produced via such a conventional approach would need to alter the original user input and recreate the video entirely.

In contrast to conventional approaches, techniques and mechanisms described herein provide for the generation of an intermediate path language model embedding in the course of generating the video. Because the intermediate path language model embedding is encoded as text, the path language model embedding may be conversationally modified based on updated user input. That is, a previously-created path language model embedding may serve as input for creating an updated path language model embedding, along with potentially the original user input and updated user input. The video may then be re-rendered based on the updated path language model embedding.

Further, in contrast to conventional approaches, techniques and mechanisms described herein provide for significantly lower computing costs. By separating the generation of the video into a path language model embedding generation phase and a video rendering phase, the generative model can be restricted to generating text and need not generate individual pixel values to include in the video. Because the number of words in a path language model embedding is far less than the number of pixels in a video created based on such an embedding, the computation cost for rendering the video via the path language model embedding is significantly lower (potentially by many orders of magnitude) than generating a video via other generative AI techniques.

### Part III—MetaForm AI

The preceding portions of this specification describe the foundational path language representation, three-dimensional interactive environment construction, and avatar/entity animation systems disclosed in the parent application (U.S. Pat. No. 12,229,913) and related provisional filings. Those systems establish the computing environment and content domain in which the present invention operates. The following portions of this specification disclose the specific technical improvements introduced by the present application: a deterministic dual-layer architecture that constrains the probabilistic outputs of the AI systems described above through (1) a domain-specific language (DNA Contract Language or DCL) that enforces a hard syntactic boundary between deterministic workflow execution and AI inference, and (2) a validated token catalog (DNA Map) that restricts AI outputs to a finite, provenance-tracked set of pre-validated content elements (genomes). This architecture is orchestrated by the Semantic Hypervisor, which manages isolated agent execution environments and enforces the boundary rules described herein. The dual-layer architecture is applicable to, but not limited to, the avatar animation, emoji processing, and 3D environment construction workflows described in the preceding sections.

According to various embodiments, the disclosed technology relates to a system and method for orchestrating large numbers of AI agents through an adaptive, distributed architecture that supports semantic normalization, automated agent evolution, and dynamic task coordination. The system, referred to as MetaForm AI, employs a meta-agent orchestrator that manages communication, collaboration, and workload distribution across thousands of agents operating in parallel. The architecture features a Semantic Normal Form (SNF) shared knowledge repository that standardizes inter-agent communication and data representation, minimizing redundancy and ensuring consistent interpretation of information. It further includes an Automated Agent Design (ADAS) module that continuously monitors agent performance, autonomously adapts agent configurations, and spawns new specialized agents when needed. By combining scalable orchestration, structured knowledge exchange, and self-improving agent design, MetaForm AI supports real-time, large-scale, and efficient multi-agent cooperation for complex computational tasks.

### III.1. Challenges with Conventional Techniques

Conventional multi-agent AI architectures face severe scalability constraints when managing high volumes of concurrent agents. As the number of agents increases, message-passing and scheduling overhead grow exponentially, resulting in degraded throughput, longer response times, and frequent system bottlenecks. When traditional frameworks attempt to orchestrate hundreds or thousands of agents, overloaded queues and sequential processing cause excessive latency. These issues make real-time orchestration impractical, as communication and synchronization demands exceed available computational resources.

Existing systems frequently rely on centralized control processes that produce race conditions and deadlocks in distributed environments. When multiple agents attempt to read or write shared data without adequate concurrency management, conflicting updates can corrupt results or stall execution. The absence of controlled synchronization among agents results in unpredictable timing and task dependencies, complicating fault recovery and resource scheduling. As task complexity grows, this lack of reliable distributed coordination increases the probability of execution errors and partial failures.

In many frameworks, agent execution takes place in small serial batches, causing underutilization of computing resources and poor parallel efficiency. Even when multiple agents execute simultaneously, static allocation policies lead to unbalanced load distribution, where some agents are idle while others become overburdened. This imbalance raises average turnaround time and inflates computational cost due to wasted capacity. Without effective load balancing and adaptive resource scaling, system performance deteriorates as agent counts increase, leading to sharply rising operational costs.

A further issue concerns redundant communication and duplicated computations among agents. Many existing systems use unstructured natural language messages or free-form data exchange, allowing multiple agents to repeat the same query or recompute already available results. This uncontrolled message proliferation leads to network congestion and elevated latency in communication pipelines. When several agents repeatedly generate or transmit overlapping information, memory usage and input/output overhead also increase, directly impairing overall throughput and reliability of results.

Another technical problem arises from inconsistencies in how agents represent and interpret shared information. In the absence of a standardized data schema, different agents may format intermediate outputs differently, causing loss of precision when integrating results. Inconsistent data representations degrade recall and precision in collective reasoning, as agents cannot accurately interpret the outputs of others. Unstructured representations also hinder aggregation and reconciliation of partial results, leading to logical conflicts, ambiguous outcomes, and error propagation across the system.

Additionally, current systems rely on static configurations of agents after deployment. Once agents are created, their prompts, logic, or parameters remain fixed even when performance declines or tasks evolve. Manual reconfiguration of dozens or hundreds of agents introduces latency, human error, and downtime. This rigidity prevents adaptation to changing input data, shifts in workload complexity, or degradation in model quality. The lack of automated feedback-based improvement limits runtime accuracy and requires costly manual retraining cycles, further increasing system maintenance overhead.

Various frameworks support orchestrating multi-agent AI systems, especially with large language model (LLM) based agents. These systems illustrate the potential of coordinated AI agents, but each also has limitations in scalability, adaptability, automation, and efficiency. For example, some conventional approaches provide structured role-based teamwork but are limited in scaling and generality. As another example, some conventional approaches do not handle large agent networks or self-driven evolution. As yet another example, some conventional approaches are not integrated into real-time systems. Collectively, these efforts make clear that while multi-agent AI is a rapidly evolving field, there remain critical shortcomings when pushing toward large-scale, dynamic agent ecosystems. These shortcomings define the open challenges that next-generation solutions must overcome.

Despite the progress in multi-agent AI, existing frameworks struggle to meet the demands of large-scale, highly adaptive agent collectives. Conventional frameworks fail to efficiently scale beyond at most dozens of interacting agents. Orchestrating thousands of agents introduces an exponential growth of potential interactions that can overwhelm traditional architectures. Coordination mechanisms that work for a small team (like round-robin message passing or a central controller) break down when the agent count is in the hundreds or more. The sheer communication overhead and scheduling complexity become bottlenecks. Moreover, many existing systems are not designed with distributed computing in mind-they might run all agents on a single machine or process, making it infeasible to increase throughput simply by adding agents. Without a fundamentally new approach to architecture, simply adding more agents leads to degraded performance (e.g. extreme latency, context swapping issues) and spiraling resource costs. Techniques and mechanisms described herein are directed to a scalable orchestration solution to coordinate orders of magnitude more agents by efficiently distributing work and managing inter-agent interactions.

In conventional frameworks, agent behaviors and roles are largely static once deployed-any improvement or adaptation (such as introducing a new skill or refining an agent's decision policy) requires human developers to manually modify prompts or code. This manual tweaking does not scale and becomes impractical in complex systems. Techniques and mechanisms described herein provide for automated agent evolution to address this gap, enabling agents or a meta-controller to learn from experience and update the system's configuration autonomously. Such meta-agents can discover better strategies than humans, underscoring the opportunity for self-optimizing systems. In some embodiments, the AI orchestration system allows agents to evaluate their performance, incorporate feedback, and evolve (e.g. by spawning new specialized agents or altering workflows) during runtime. The system supports a complex interplay of meta-reasoning and safety checks, for instance to ensure changes are beneficial. Techniques and mechanisms described herein provide for an adaptive, self-improving multi-agent system to move beyond static “set-and-forget” agent teams to ones that continuously learn and optimize their collaboration.

Conventional systems execute agent reasoning steps sequentially or in small batches, which becomes a major efficiency bottleneck when scaled up. In contrast, various embodiments provide for large agent societies that operate in parallel to be time-efficient. However, parallelizing numerous AI agents poses significant challenges. For instance, running hundreds of agents concurrently can exhaust computational resources (CPU, GPU, memory) and saturate model API limits. Techniques and mechanisms described herein provide for orchestrating parallel agent processes without incurring overwhelming overhead or deadlocks. Effective load balancing helps ensure that that a single agent or server does not become a hotspot while others sit idle. This involves dynamically distributing tasks based on workload, which conventional frameworks do not handle.

Conventional frameworks typically lack any built-in scheduler to allocate work across multiple machines or to spin up/down agent instances on demand. In contrast, techniques and mechanisms described herein provide for parallel execution involving handling of synchronization points, for instance when agents need to wait for others' results, and avoiding race conditions in shared resources. These are classic distributed system issues now manifesting in multi-agent AI. While enterprise-grade solutions can borrow techniques like round-robin task assignment, least-connections routing, or horizontal scaling of services, integrating these into AI agent orchestration is non-trivial and not addressed by existing tools. The challenge remains to achieve real-time throughput with large agent populations-ensuring that adding more agents yields linear or at least sub-linear increases in task completion time (rather than a breakdown in efficiency). In contrast to techniques and mechanisms described herein, attempts to deploy thousands of agents via conventional techniques suffer from diminishing returns due to coordination overhead.

Coordination among many agents requires efficient communication between agents. If every agent naively chats with every other agent, or continuously shares lengthy context, the communication overhead explodes, crippling performance. Currently, conventional multi-agent frameworks typically use unstructured natural language messages or simple data-passing, which often leads to repetitive exchanges and duplicated efforts. For example, multiple agents may request or compute the same information because there is no shared memory of facts. Indeed, without a shared knowledge repository or protocol, agents may “speak different languages” or formats, making it hard to aggregate their knowledge. This lack of standardization causes important details to get lost or forces agents to re-communicate context that another agent already knows, wasting time and compute. Inefficient inter-agent communication is thus a bottleneck in scaling up MAS (Multi-Agent Systems). Furthermore, as the number of messages grows, so does the difficulty in filtering relevant information-agents can be flooded with irrelevant or low-priority data. The open challenge here is to establish a more structured, knowledge-centric communication method: one that ensures agents can easily find and share what's needed without extensive back-and-forth. In current frameworks, such infrastructure is absent: there's little support for caching and reusing shared context or globally managing knowledge to prevent duplication. Thus, figuring out how to minimize communication overhead and maximize meaningful knowledge sharing among many AI agents is an unsolved problem critical to efficient scalability. Techniques and mechanisms described herein provide fora communication scheme that is scalable, informative, and avoids redundancy.

### III.2. Overview of Various Solutions to Technical Challenges

Techniques and mechanisms described herein relate to a set of systems and techniques referred to collectively as MetaForm AI. According to various embodiments, MetaForm AI is designed to address various open challenges associated with conventional orchestration techniques. It introduces a novel orchestration architecture and set of capabilities that allow it to dynamically coordinate, evolve, and optimize thousands of AI agents in real time, overcoming the key limitations of current systems.

In some embodiments, the system includes a meta-agent orchestrator that serves as the central coordination engine for thousands of autonomous AI agents. The orchestrator receives incoming tasks and decomposes them into sub-tasks that can be executed in parallel. It then assigns the sub-tasks to selected agents based on specialization, workload, or performance history. The orchestrator also monitors execution status and collects results from agents as they complete operations. These results are aggregated, reconciled, and compiled into a unified output representing the complete solution. The orchestrator maintains continuous oversight of agent activities, enabling efficient scheduling, real-time task distribution, and adaptive workload balancing across distributed computing environments.

In one or more embodiments, the system employs a Semantic Normal Form (SNF) that acts as a shared knowledge repository and standardized data representation layer. The SNF stores structured task data, intermediate results, and contextual information generated by agents or the orchestrator. It provides a normalized schema that all agents follow when writing or reading information, ensuring consistency across communications. Before performing new computations, an agent or the orchestrator queries SNF to determine if relevant results already exist, avoiding duplicate work. Information is maintained in a machine-readable semantic format that supports immediate reuse and precise interpretation by other agents, forming a unified knowledge memory accessible across the system.

According to various embodiments, the Automated Agent Design System (ADAS) continuously monitors agent performance using defined metrics and feedback provided during task execution. The module analyzes indicators such as accuracy, speed, and resource consumption to identify opportunities for improvement. When an agent's performance falls below a defined threshold, ADAS may modify its parameters, adjust its prompt configuration, or generate a new specialized agent variant with refined capabilities. Updated agents are integrated back into the system, where their performance on similar tasks is evaluated iteratively, creating a loop of self-improvement. This adaptive process enhances agent diversity and ensures that the active agent pool remains responsive to evolving requirements.

In some implementations, the architecture supports large-scale parallel execution through a distributed infrastructure across multiple nodes or computing clusters. The orchestrator dynamically allocates agent workloads based on available hardware capacity and resource monitoring metrics. Communication between agents, the orchestrator, and the shared knowledge repository can occur asynchronously, allowing multiple reasoning threads to execute concurrently. This decentralized scheduling approach prevents resource contention and ensures smooth progression even when thousands of agents operate simultaneously.

In one or more embodiments, the system performs dynamic load balancing by monitoring the active workload and redistributing tasks when an imbalance is detected. If a subset of agents becomes overloaded or lags behind others, the orchestrator may spawn additional agent instances or split complex subtasks among idle resources. These adjustments can occur mid-execution without halting the overall process. The load-balancing logic is informed by real-time performance data gathered from all agents, allowing efficient resource utilization and maintaining consistent throughput across varying workloads.

According to various embodiments, the architecture also supports hierarchical agent organization. Higher-level supervisory agents or the orchestrator itself can coordinate the outputs of lower-level agents. This structure allows complex, multi-stage tasks to be divided among multiple tiers of specialized agents. Intermediate results may be aggregated or transformed before being passed to subsequent tiers, enabling structured and scalable division of labor. The design facilitates modular, multi-level orchestration where subtasks are independently managed yet cohesively integrated into the final response.

In some embodiments, the system integrates a persistent communication interface for human collaboration. This interface allows users to submit tasks, review progress, and provide feedback or validation for ongoing operations. Human input can be incorporated into the orchestration flow and stored within the shared knowledge repository in SNF format. This ensures that user feedback becomes part of the structured memory, informing future decision-making, prompt generation, or agent adaptation cycles.

### III.3. Advantages Exhibited by Various Embodiments

According to various embodiments, MetaForm AI provides massive scalability with efficient orchestration. Unlike prior frameworks which struggle beyond small teams, MetaForm AI can natively manage thousands of agents concurrently. It employs a distributed orchestration engine that allocates agents across multiple nodes and coordinates their interactions through a high-throughput scheduler. By using parallel execution and sophisticated load-balancing algorithms, MetaForm ensures that adding more agents yields proportional gains in task handling capacity instead of gridlock. For example, tasks are intelligently routed to available agents based on real-time load and specialization, preventing any single bottleneck. This design lets MetaForm AI operate large agent swarms continuously and efficiently, where conventional frameworks like OpenAI Swarm or CrewAI would be overwhelmed. In essence, MetaForm AI treats the multi-agent system as a distributed computing problem—with built-in support for horizontal scaling and fault-tolerant scheduling—something unique among AI orchestration platforms.

According to various embodiments, MetaForm AI provides for Automated Agent Evolution (Self-Improving Agents). MetaForm AI directly tackles the adaptation gap by allowing agents to learn and evolve over time. It incorporates a meta-level learning module (a “manager-of-agents”) that monitors the performance of individual agents and the overall system, and can autonomously adjust agent behaviors or create new agents to improve outcomes. In practice, this means MetaForm AI can do things like analyze which agents are failing or underperforming at certain tasks and then modify their instructions or replace them with better variants. It builds on ideas from ADAS (automated agent design) but brings them into a live system: the meta-agent can dynamically reconfigure workflows or spawn optimized agents on the fly, rather than waiting for an offline redesign cycle. This capability for real-time agent evolution is a major differentiator. Conventional frameworks typically have static agent definitions—for instance, MetaGPT's roles are fixed by human designers, and Microsoft's AutoGen requires developers to predefine conversation flows. By contrast, MetaForm AI's agents and their coordination strategies can adapt continuously based on feedback and new challenges. This self-optimization loop means the longer MetaForm AI runs, the more efficient and effective its agent collective can become, without human intervention. It effectively closes the loop on learning: not only do the agents use machine learning internally for tasks, but the organization of agents itself improves via machine learning.

According to various embodiments, MetaForm AI provides for optimized parallelism and real-time coordination. To truly operate in real time at scale, MetaForm AI introduces advanced concurrency control and resource management techniques specifically tuned for multi-agent AI workloads. It can execute many agent dialogues or tool invocations in parallel by leveraging asynchronous processing and caching of intermediate results. MetaForm's runtime actively balances load: if one agent (or a subset of agents) is inundated with tasks, MetaForm can dynamically instantiate additional agent instances or redistribute tasks to other less-busy agents, much like an elastic cloud service. This ensures smooth real-time performance even under heavy loads, addressing the challenge where other systems slow down due to unbalanced workloads. Additionally, MetaForm AI uses hierarchical coordination to reduce complexity: for example, it can group agents into sub-teams with delegated subtasks, so that not every agent needs to talk to every other agent directly. This hierarchical model keeps parallel execution efficient and avoids the combinatorial explosion of interactions. The end result is that MetaForm AI achieves a level of throughput and responsiveness in large-scale agent operations that is beyond the reach of frameworks like AutoGen or Goose, which lack such integrated parallel orchestration intelligence.

According to various embodiments, MetaForm AI provides for structured communication and Semantic Normal Form (SNF): A cornerstone of MetaForm AI's innovation is how it handles inter-agent communication and knowledge management. MetaForm AI implements a Semantic Normal Form (SNF) for information exchanged among agents-essentially a common structured representation for knowledge and messages. Instead of relying purely on free-form natural language between agents (which can be verbose and ambiguous), MetaForm AI converts interactions into a normalized semantic format. This could be thought of as a shared language or ontology that all agents adhere to. By doing so, it ensures that an insight gained by one agent can be recorded in a structured knowledge base and immediately understood by others, without needing repetitive restatement. The SNF approach dramatically reduces redundant communication: agents check the shared knowledge store (or blackboard) in SNF format before asking questions or performing tasks that might have been done already. It also prevents misunderstandings—with a well-defined schema for facts, queries, and commands, agents avoid the problem of “speaking past each other” that plagues unstructured communication.

According to various embodiments, in MetaForm AI, every piece of information is tagged and stored in the semantic knowledge base, enabling efficient lookup and update by any agent. This structured knowledge management means inter-agent messages can be kept succinct (since detailed context can be fetched from the shared store when needed) and focused on just the novel information. The Semantic Normal Form acts as a single source of truth for the multi-agent system, allowing MetaForm AI to eliminate a huge portion of the overhead and inconsistency seen in other frameworks. Competing systems have nothing analogous to SNF—for instance, in CrewAI or OpenAI Swarm, agents communicate ad-hoc, and any shared memory is rudimentary or non-existent. By contrast, MetaForm's SNF and shared memory architecture gives it a robust communication backbone for large-scale coordination, resulting in more coherent, non-redundant collaboration across thousands of agents.

According to various embodiments, MetaForm AI distinguishes itself as a next-generation AI orchestration platform. It overcomes the scalability barriers by efficiently managing large agent populations, provides a mechanism for continuous agent improvement (closing the loop that ADAS opened conceptually), and establishes a structured communication infrastructure that keeps a vast multi-agent system coherent and efficient. In doing so, MetaForm AI unifies the strengths of prior art while addressing their weaknesses: it offers the collaborative power of frameworks like CrewAI/MetaGPT, the tool integration of Goose, and the multi-agent dialogue capabilities of AutoGen—but augments them with massive scalability, self-adaptability, and knowledge-centric coordination that none of those frameworks possess. This makes MetaForm AI a novel and superior solution for orchestrating AI agents at a scale and level of autonomy that was previously unattainable.

In some embodiments, the disclosed system provides major improvements in scalability and throughput for multi-agent AI orchestration. The meta-agent orchestrator distributes tasks across thousands of agents in parallel, using adaptive load balancing and distributed scheduling to prevent computational bottlenecks. By dynamically assigning subtasks to idle or specialized agents and reallocating workloads in real time, the system avoids the exponential communication and scheduling overhead that limits conventional architectures. This coordination approach allows for near-linear scaling with the number of agents, enhancing system performance across distributed environments.

According to various embodiments, by enabling dynamic coordination, on-the-fly agent evolution, and efficient structured communication, MetaForm AI paves the way for AI systems comprising thousands of agents working together in real time-a capability that squarely addresses the open challenges and pushes the boundary of what AI multi-agent collaboration can achieve. The introduction of MetaForm AI thus represents a significant leap beyond the state of the art, filling the critical gaps in automated large-scale agent orchestration and establishing a foundation for new AI-driven solutions that require massive, intelligent agent teamwork.

In one or more embodiments, the Semantic Normal Form (SNF) reduces or eliminates redundant communication and inconsistent data formatting among agents. By providing a uniform schema for representing knowledge and task data, SNF ensures that information is stored and interpreted consistently. Before computing a new result, an agent checks the SNF repository for existing outputs, preventing replication of prior work. This common knowledge representation reduces bandwidth usage, lowers latency, and improves coherence across agent interactions. The SNF thereby enhances efficiency and precision in collective reasoning.

In some implementations, the system improves reliability and fault tolerance through distributed execution. The orchestrator's decentralized scheduling allows independent nodes to process tasks concurrently without contention on shared resources. Should one node or agent fail, other agents can continue processing or take over the workload seamlessly. This approach avoids typical deadlocks and race conditions encountered in centralized multi-agent frameworks, providing more stable and predictable system behavior under heavy load.

According to various embodiments, the Automated Agent Design System (ADAS) introduces continuous performance optimization through automated adaptation. By monitoring key metrics such as accuracy, runtime, or resource consumption, ADAS can reconfigure or regenerate agents that show degraded performance. New specialized agents can be spawned automatically to handle specific subdomains or emerging task types. Over time, this produces a self-improving agent ecosystem that maintains high efficiency and relevance without manual intervention. This automated evolution addresses the rigidity of static agent configurations in existing systems.

In some embodiments, the combination of orchestrator oversight, dynamic load balancing, and SNF knowledge sharing increases overall system efficiency. Agents no longer operate in isolation or duplicate effort, as the orchestrator coordinates their actions and the SNF repository acts as a single source of structured truth. The orchestration logic ensures that parallel agents work collaboratively on distinct yet complementary subtasks, reducing computational waste. This distributed intelligence framework enables large-scale, real-time collaboration across many AI agents with stable performance under variable conditions.

In one or more embodiments, hierarchical agent organization provides flexible decomposition of complex tasks. Supervisory agents or the orchestrator itself can aggregate intermediate results from subordinate agents, enabling modular problem-solving pipelines. This structured design allows fine-grained management of multi-stage workflows and supports cascading dependencies without complex reconfiguration. The architecture thus enhances modularity, enabling extensible integration of new agent types or functions as system requirements evolve.

According to various embodiments, the persistent shared knowledge and runtime monitoring facilitate adaptive orchestration that maintains coherence over time. As tasks are completed, the results and learned context remain accessible for future operations, enabling reuse of prior knowledge. Agents benefit from accumulated context without repeated computation, ensuring continuity across sessions. This persistent semantic memory ensures that performance improvements compound with continued use, further differentiating the system from conventional short-term multi-agent frameworks.

In some embodiments, the disclosed technology provides significant advantages to businesses by enabling scalable automation across diverse operational domains. Enterprises can coordinate thousands of AI agents simultaneously, each handling specialized subtasks. This capability allows organizations to process large volumes of data, execute complex analyses, and manage dynamic workflows in real time. The adaptive load-balancing and distributed orchestration reduce infrastructure costs because computing resources are used more efficiently. Businesses benefit from high system throughput without the need to continuously expand hardware capacity, improving operational efficiency and reducing latency in data-driven decision-making.

In one or more embodiments, the system enhances productivity for individuals by automating repetitive or high-complexity tasks that would otherwise require extensive human attention. Professionals in fields such as research, data analysis, or content generation can delegate subtasks to adaptive AI agents, enabling them to focus on higher-level reasoning and strategy. The shared knowledge repository ensures consistent, accurate outputs, as agents refer to a standardized information schema. Users gain improved accuracy and coherence in multi-step workflows, while the system's self-evolving agents continually refine their performance without manual retraining, saving time and reducing errors.

In some implementations, the technology provides a foundation for collective intelligence that benefits society as a whole. Large-scale orchestration of AI agents supports more efficient handling of information in critical sectors such as healthcare, energy management, education, and public policy. For example, distributed agent collaboration can rapidly analyze massive datasets related to disease modeling, climate risk, or social infrastructure. The system's real-time adaptability allows new agents to emerge automatically as new challenges arise, fostering rapid innovation. This capacity for scalable, self-improving collaboration helps institutions respond more effectively to emerging societal needs.

According to various embodiments, organizations deploying this system benefit from continuous optimization and lower maintenance costs. The Automated Agent Design System (ADAS) autonomously monitors and adjusts underperforming agents, eliminating the need for frequent manual tuning or redeployment. Enterprises no longer rely on dedicated engineering teams for system reconfiguration, allowing technical staff to focus on strategic objectives. The persistence of structured knowledge and results within the Semantic Normal Form repository ensures long-term knowledge retention, enabling enterprises to reuse insights and improve consistency across projects.

In some embodiments, the architecture strengthens collaboration between humans and AI systems. The orchestrator's human interaction interface allows users to contribute oversight, validation, or domain knowledge directly into the orchestration workflow. This creates a hybrid model where human expertise complements AI efficiency. The integrated feedback loop ensures the system learns from human input over time, improving both trust and accuracy in decision-support activities. For individuals and teams, this means faster access to reliable, context-aware recommendations and solutions.

In one or more embodiments, the disclosed system contributes to environmental and economic sustainability. By dynamically balancing workloads and eliminating redundant computations, the architecture minimizes excess energy consumption in large-scale AI operations. Tasks that previously required multiple independent processes now share results through the common semantic knowledge base, reducing compute cycles and network overhead. This efficiency translates into tangible reductions in energy cost for data centers and smaller carbon footprints for organizations running AI-intensive operations. Additional details related to MetaForm AI are discussed in Part IV.

### Part IV—Extensions to MetaForm AI

### IV.1. Problems with Conventional Approaches

Conventional large language models and generative systems exhibit high rates of content fabrication because probabilistic generation lacks rigorous boundary conditions. When such models are used in production environments for structured content creation, subtle deviations in token generation can lead to factual errors, broken structures, or inconsistent outputs. These hallucinations introduce precision and recall problems in generated materials, as the model cannot consistently retrieve or reproduce valid sequences. In complex workflows that combine multiple AI calls, hallucination errors propagate through subsequent steps, compounding output inconsistency and increasing post-processing workload.

Traditional AI workflows that interleave deterministic and probabilistic logic often suffer from race conditions and nondeterministic execution paths. Because creative inference and process execution are typically mixed within the same runtime environment, step-ordering errors can occur when AI models modify, skip, or reorder workflow operations. These failures lead to low reproducibility across runs using the same input data, undermining auditability and traceability. The absence of strict separation between algorithmic control and model inference creates challenges for debugging, testing, and regression validation.

AI models generating outputs from unbounded vocabularies introduce significant latency and performance variability during inference. When the model must consider a large unconstrained output space, computational cost increases, and throughput declines, particularly in multi-agent systems where numerous model calls occur concurrently. This unpredictability complicates scaling and makes latency spikes more frequent. In distributed orchestration environments, inconsistent timing across parallel agents further amplifies synchronization delays and can cause throughput bottlenecks or stalled execution chains.

Automated content generation pipelines that rely on unverified input data often yield systemic quality drift. Minor errors in early data extraction-such as noisy, redundant, or misaligned tokens-propagate downstream and become embedded in trained or synthesized outputs. These uncontrolled variations cause failure modes in animation timing, motion continuity, and camera path interpolation, among others. Standard extraction algorithms lack consistent normalization, resulting in heterogeneous data precision across assets and degraded model performance when reusing mined datasets.

In large-scale synthesized asset libraries, lack of structured provenance prevents localized updates when errors are identified. If a specific content element is later deemed defective, there is typically no systematic way to identify and replace that element across related assets. This limitation creates cost and latency problems by requiring full regeneration of every affected output. Without a fine-grained record of data lineage, content errors cannot be corrected at scale, leading to inefficient reprocessing and inconsistent dataset hygiene.

### IV.2. Overview of Technical Solutions

In some embodiments, the system operates through a dual-layer execution architecture composed of a deterministic control layer and a content-constrained generative layer. The deterministic layer uses a domain-specific formal grammar known as the DNA Contract Language (DCL). DCL encodes procedural workflows as structured code blocks that specify operations, control logic, validation rules, and explicit AI invocation boundaries. The deterministic operations are executed algorithmically through an interpreter or compiled runtime under the supervision of a Semantic Hypervisor.

According to various embodiments, the Semantic Hypervisor functions as an advanced execution management layer operating at the hardware-software interface to dynamically balance computational load, coordinate agent lifecycles, schedule parallel processing sequences, and enforce strict memory boundary rules between deterministic execution threads and probabilistic inference components. By instantiating isolated execution environments that utilize rigidly designated memory namespaces (e.g., partitioning memory into separate input, output, and local variable registries identified by distinct syntactic prefixes within the compiled scripts), the Semantic Hypervisor physically isolates the execution state of one AI agent from another. This architecture fundamentally prevents memory state leakage and cross-contamination during high-concurrency multi-agent orchestration. Furthermore, the Semantic Hypervisor executes an Automated Agent Design (ADAS) protocol that continuously analyzes an execution log generated by the deterministic engine to automatically modify the underlying DNA Contract Language (DCL) scripts, thereby self-optimizing the allocation of processing resources and evolving agent behavior without manual human intervention. Within this controlled execution space, standard logic structures such as assignments, iterative loops, and conditional statements are executed predictably and reproducibly. The explicit ‘AI’ prefix identifies points where probabilistic reasoning may occur, making such transitions traceable and auditable.

In one or more embodiments, the Semantic Hypervisor serves as the supervisory layer coordinating large numbers of agent processes, functioning analogously to a traditional operating system hypervisor but within a semantic and computational context. It isolates execution contexts into namespaces, defines communication channels through structured memory references, and ensures deterministic synchronization across agents. The Hypervisor instantiates DCL runtimes for multiple agents, each running a script that follows a common schema for inputs, outputs, and intermediate variables. Within this framework, specialized orchestration policies schedule execution and allocate resource usage. Agents use standardized interfaces, expressed in Semantic Normal Form (SNF), to exchange structured records representing terms, schema references, and data relationships. SNF records provide a shared vocabulary that allows independently developed agents to cooperate predictably without ambiguity.

In some implementations, the content generation layer operates under a genome-based constraint mechanism known as DNA AI. This subsystem defines a closed selection domain for AI models by referencing a curated catalog, called the DNA Map, which stores pre-validated tokens known as genomes. A genome represents an atomic creative choice, such as a camera motion, transition effect, or visual style transformation. Each genome is internally defined as a discrete data object containing a sequence of tokens, parameter constraints, temporal bounds, and categorical metadata. When an AI model is invoked, it is restricted to operate within the context of the DNA Map; the model cannot produce arbitrary outputs but may instead select from available genomes according to contextual relevance. After inference, deterministic validation routines confirm that every selected genome corresponds exactly to an entry in the DNA Map. Any result outside that taxonomy is immediately rejected. This dual constraint structure ensures that the creative outputs generated by AI remain bounded within a known and traceable set of authorized building blocks.

According to various embodiments, the system maintains the DNA Map through automated genome mining pipelines that extract and normalize data from approved reference assets. These pipelines, referred to as mining chains, consist of ordered sequences of agents that handle acquisition, analysis, normalization, and persistence of new genomes. Within these chains, specialized Bleacher Agents perform data cleaning and normalization using numerical and geometric algorithms. For example, motion data may be smoothed using discrete Kalman filtering to remove tracking noise, while animation paths may be simplified through Ramer-Douglas-Peucker algorithms to retain only structurally significant keyframes. Coordinate normalization maps absolute pixel values to relative coordinate systems to ensure interoperability across different media resolutions. Temporal normalization aligns action durations proportionally to segment length, while quantization reduces parameter variability by discretizing values to standard bins. These steps convert irregular raw data into precise, schema-compliant genome tokens suitable for reuse across asset synthesis operations.

In some embodiments, the data structures produced by the mining process are stored within a relational or graph-oriented repository forming the DNA Map. The DNA Map serves as both a lookup database and a validation source during content synthesis. Each genome entry is associated with metadata including its origin asset, extraction timestamp, normalization chain identifier, and version history. The schema of the DNA Map defines categorical groupings by action type, motion primitive, or content domain, forming a structured integration domain that constrains creative synthesis. When AI is invoked by a DCL script, relevant subsets of the DNA Map are loaded into memory as read-only catalogs and supplied to the model through controlled interfaces. AI outputs are thus interpreted not as free text or unconstrained data but as references to enumerated genomes, resulting in outputs that can be mathematically traced, validated, and recomposed.

According to various embodiments, every synthesized asset carries a complete fingerprint of its composition through a structured provenance map. During synthesis, the system records which genomes were selected, where they appear in the output structure, and which versions of each genome were active at the time of generation. This provenance record enables targeted modifications across large collections of assets. When a genome is later discovered to produce undesirable results, it may be marked as blacklisted. The system can then query all provenance maps to identify related assets that use that genome and regenerate only those segments with an alternate approved genome. The remaining regions of each asset remain intact, reducing redundant computation and preserving stable content.

In some implementations, the overall synthesis workflow operates as a continuous feedback loop between mining, synthesis, and audit subsystems. Audit agents or human reviewers may inspect generated outputs and flag anomalies, which are then recorded as genome-level annotations in the DNA Map. Updated or replaced genomes propagate automatically through the system, as DCL workflows referencing those genome identifiers can dynamically refresh their asset compositions based on new catalog versions. This continuous provenance-managed update mechanism allows the platform to evolve its creative vocabulary without discarding prior assets or retraining entire model pipelines.

In one or more embodiments, modular architecture within the Semantic Hypervisor supports scalable deployment across distributed environments. Multiple independent hypervisors may coordinate via message queues, each hosting agent sets that operate on subsets of data within a shared DNA Map. The internal SNF schemas ensure consistent interpretation across environments, while DCL's deterministic semantics maintain uniform execution logic regardless of processing location. This distributed orchestration enables the framework to perform high-volume genome mining, synthesis, and validation at industrial scale, maintaining deterministic control over processes while constraining AI-driven components to well-defined selection domains.

Overall, the system described functions as an integrated computing environment that combines deterministic workflow enforcement, bounded probabilistic reasoning, structured data normalization, automated provenance tracking, and agent-based orchestration. These interacting components together form a controlled ecosystem capable of executing large-scale AI-assisted content generation in a verifiable, modular, and reproducible manner.

### IV.3. Benefits Exhibited by Various Embodiments

In one or more embodiments, the disclosed system improves the reliability and determinism of AI-assisted content generation by separating algorithmic control logic from AI inference. This separation reduces process-level hallucination by ensuring that workflow execution occurs through deterministic operations written in the DNA Contract Language (DCL). The explicit use of syntactic boundaries between deterministic instructions and probabilistic calls allows the system to maintain consistent behavior across executions, even when multiple AI models are invoked. As a result, workflows become reproducible, auditable, and less prone to sequence or control flow errors that commonly occur when AI models alter the logical order of operations.

In some embodiments, the dual-layer design improves content validity and predictability by constraining AI output to authorized content vocabularies through the genome-based DNA AI subsystem. By requiring AI models to select from pre-approved token sequences, referred to as genomes, instead of generating free-form content, the platform bounds the output space and prevents creation of invalid or fabricated data. This approach minimizes hallucination risk and ensures that AI-generated results strictly adhere to the syntactic, semantic, and domain-specific parameters defined within the DNA Map.

According to various embodiments, the automated genome mining pipelines provide a technical advantage by enabling self-updating and self-normalizing data ecosystems. Mining chains perform automated extraction, cleaning, and normalization of data using applied mathematical methods such as Kalman filtering, Ramer-Douglas-Peucker path simplification, and normalization across coordinate and temporal dimensions. These processes produce consistent and interoperable token structures that maintain uniform precision across datasets. The resulting dataset integrity improves synthesis quality and ensures that subsequent AI selections are made from uniform, validated, and schema-compliant sources.

In some implementations, the Semantic Hypervisor architecture enhances system scalability and consistency by managing multiple AI agents within a deterministic supervisory environment. The Hypervisor isolates context, enforces synchronization rules, and coordinates distributed workloads using standardized schemas in Semantic Normal Form (SNF). This structure ensures that agent interactions remain well-defined and free of race conditions or nondeterministic timing behaviors. As a result, multi-agent workflows execute predictably across distributed computing environments, improving parallel throughput and synchrony without sacrificing accuracy or reproducibility.

In one or more embodiments, the system's provenance tracking feature delivers a measurable technical improvement in data maintainability and version control. By embedding structured lineage records for every genome used in content synthesis, the system enables localized, automated updates and corrections. When a genome is identified as problematic, blacklisting triggers automatic detection of all related assets and selective regeneration of affected regions only. This allows precise, resource-efficient updates without regenerating entire datasets, significantly reducing computational overhead and storage requirements.

According to various embodiments, the combination of deterministic process control and probabilistic constraint-based selection produces a system with measurable gains in output consistency, error reduction, and audit transparency. The reproducibility of deterministic execution paths ensures that identical inputs yield identical outputs, while the bounded nature of genome selection limits potential deviations. Together, these mechanisms create an auditable computational framework capable of documenting the reasoning, selection, and lineage of every AI decision made during content generation.

In some implementations, the use of structured integration domains through the DNA Map effectively transforms unbounded generative problems into finite selection problems, which are computationally more efficient and predictable. Constraining AI context to a verified domain reduces computational cost during inference, improving inference speed and reducing resource variability across execution instances. This bounded context also simplifies validation at runtime by converting probabilistic evaluation into deterministic matching, thereby improving fault detection and system stability.

In one or more embodiments, the modular nature of DCL scripts, mining chains, and genome catalogs provides enhanced portability and maintainability across deployment environments. Because workflows are expressed as deterministic linguistic constructs with clearly defined AI boundaries, they can be audited, versioned, or replicated across systems without alteration of their functional behavior. This feature facilitates reliable scaling in multi-region or multi-cluster installations while preserving execution fidelity and compatibility.

Overall, the disclosed system improves computational determinism, runtime reliability, and data traceability in large-scale AI environments. By introducing formal boundaries, bounded output domains, and automated data lineage correction, the system provides a continuous and verifiable framework that addresses failures found in standard generative AI workflows. These improvements collectively represent technical advancements in structured content synthesis, distributed AI orchestration, and computational reproducibility.

In one or more embodiments, businesses benefit from predictable, verifiable, and cost-efficient AI content generation. The dual-layer architecture reduces error rates and rework by ensuring that every AI decision is traceable and deterministically executed. This leads to consistent quality across generated media assets, lowering quality assurance costs while maintaining brand compliance. The modular nature of DCL workflows allows enterprises to adjust processes quickly without retraining AI models, promoting faster deployment cycles and reducing total cost of ownership across AI-driven production pipelines.

In some embodiments, organizations achieve significant operational efficiency through automated genome management. By using automated mining chains to extract and normalize approved genomes, businesses can continuously refresh their creative vocabulary without manual intervention. When an error or brand inconsistency is detected, the provenance and blacklisting mechanism allows selective corrective action across large asset libraries. This precision update capability saves time, prevents costly asset regeneration, and ensures uniform compliance across digital content inventories.

According to various embodiments, the system enhances data governance, auditability, and intellectual property protection. Every token, genome, and output is versioned and traceable to its source, creating a verifiable chain of provenance. Enterprises can demonstrate regulated compliance regarding licensing, authorship, and content integrity, which is critical for sectors such as media, e-commerce, and advertising. The structured audit history reduces legal risks associated with ambiguous AI outputs while supporting transparent oversight for both internal teams and external auditors.

In some implementations, end users benefit from improved reliability and integrity of AI-generated materials. The deterministic execution enforced by DCL prevents skipped steps or fabricated transitions, resulting in consistent, trustworthy synthetic content. This reliability builds user confidence in automated creative systems and reduces the need for manual correction or oversight. Consumers and creative professionals alike can rely on the outputs for accurate, compliant, and repeatable results.

In one or more embodiments, the disclosed technology supports societal benefits by promoting responsible AI deployment. By constraining AI generation to verified vocabularies, the system directly addresses concerns of misinformation and untraceable content. The verifiable, provenance-tracked structure provides transparency in how AI-derived materials are produced and modified. This transparency supports ethical AI governance and contributes to public confidence in synthetic media technologies as safe, traceable, and reliable tools for communication and creativity.

According to various embodiments, distributed organizations gain scalability and interoperability advantages. The Semantic Hypervisor coordinates agent execution across diverse computing environments, ensuring that AI-driven workflows behave identically regardless of scale or geographic location. This consistency allows businesses to expand global production networks, leveraging unified creative logic while retaining full control and predictability over AI outputs.

In some implementations, the efficiency of the architecture translates into measurable sustainability benefits. Reducing redundant computation during mass updates lowers energy consumption and hardware demand. The selective regeneration model preserves existing assets rather than recreating them, minimizing unnecessary data processing at scale. This creates a more resource-efficient approach to AI deployment, aligning with environmental and operational sustainability goals.

Overall, in various embodiments, the disclosed system provides tangible advantages to individuals, businesses, and society through reliable AI control, traceable content synthesis, scalable workflow governance, and ethical transparency in automated generation processes. From a technical perspective, the system produces verifiable, auditable outputs with mathematically bounded hallucination risk-a concrete improvement in computer reliability for AI systems.

### IV.4. Conceptual and Formal Definitions

In some embodiments, as used herein the term “Genome” may refer to a discrete token sequence representing an atomic creative choice (e.g., animation effect, camera motion). Analogous to biological DNA sequences. The term “DNA Map” may refer to a structured catalog storing approved genomes, organized by category, and defining a valid selection space for AI models. The term “Subpath” may refer to an individual genome, which provides the atomic unit of a complete path through the content probability space. The term “Path” may refer to a complete synthesized asset represented as an ordered composition of genomes (e.g., subpaths). The term “Bleacher Agent” (also called a Normalization Agent or Sanitization Agent) may refer to a normalization/sanitization agent that processes raw extracted data to remove noise, artifacts, and inconsistencies before genome indexing. The term derives from the function of “cleaning” raw data into normalized form suitable for the DNA Map. The term “Mining Chain” may refer to an automated sequence of agents that extracts genomes from approved assets. The term “DCL DNA Contract Language” may refer to the domain-specific language separating deterministic operations from AI invocations. The term “Provenance” may refer to the complete lineage tracking of a genome, recording its source asset, extraction chain, and usage history.

Mathematically, the “Path Integral” in the MetaForm system is explicitly defined as a Discrete Combinatorial Summation, distinct from continuous stochastic path integrals used in physics (Feynman-Kac) or reinforcement learning (e.g., Theodorou et al.). The MetaForm system integrates over a finite, discrete database (the DNA Map), not continuous probability distributions. The MetaForm Path Integral is defined as a constrained discrete summation:

$$P ( Asset ) = {\sum }_{g ∈ {G}_{valid}} {\prod }_{i = 1}^{n} P ( {g}_{i} \vert {C}_{i - 1} , DCL )$$

where:
(G_{{valid}})=The set of all valid genome sequences defined by the DNA Map
(P(gᵢ|Cᵢ₋₁, DCL))=The probability of selecting genome (g_i) given:
   (C_{{i-1}})=The context established by previously selected genomes
   (DCL)=The deterministic constraints (REQUIRE statements) pruning invalid selections
   (n)=The number of genome positions in the asset structure

According to various embodiments, the formal definition exhibits various properties:
Discrete Domain: Unlike continuous integrals, the summation is over a finite set of genomes in the DNA Map
Constraint Pruning: DCL REQUIRE statements eliminate invalid branches, setting (P(gᵢ)=0) for constraint violations
Deterministic Gating: The product term ensures that if any selection violates DCL constraints, the entire path probability becomes zero

In some embodiments, to provide a simplified notation, the path integral can be expressed as:

$$Path Integral = \sum ( {genome}_{1} \times {genome}_{2} \times … \times {genome}_{n} )$$

for all valid (genome₁, genome₂, . . . , genomeₙ)∈DNA Map subject to DCL constraints where each genome (gᵢ) is a discrete token sequence from the DNA Map, subject to validation by DCL REQUIRE statements, and selected by AI from constrained options (i.e., not generated freely).

In some embodiments, a genome is a subpath, which is an atomic segment of a complete path through the content probability space. For example, a path may define a complete asset represented as ordered sequence of genomes. A subpath (Genome) may define a single validated creative choice with defined parameters. A Path Language Representation may serve as the genome token structure (JSON schema). A Path Integral may be a discrete combinatorial sum over valid genome compositions. An Integration Domain may be the DNA Map, providing a finite, curated catalog.

As an example provided in accordance with one or more embodiments, a synthesized video is a “path” composed of subpaths:

$$Asset Path = [ camera - genome : pan - left ] + [ motion - genome : fade - in ] + [ transition - genome : dissolve ] + …$$

In this example, each bracketed element is a genome (subpath) selected from the DNA Map. The set of all valid such compositions, subject to DCL constraints, constitutes the path integral for that asset type.

In some implementations, the DNA Map explicitly defines the integration domain for the path integral:
Finite Boundary: Only genomes in the DNA Map are valid; (g∉DNA_{Map}⇒P(g)=0)
Curated via Mining: The domain is populated by automated mining chains, not manual definition
Hallucination Prevention Proof: If an AI attempts to generate token (t) where (t∉DNA_{Map}), the path integral for that branch evaluates to zero (rejection).

This is the mathematical proof of hallucination prevention: The AI cannot hallucinate content outside the integration domain because such content has zero probability by definition.

It should be noted that various terms used herein are related. For example, a validated token catalog may be used to store token sequences formatted per semantic normal form (SNF). As another example, the hypervisor can analyze execution logs to auto-adapt scripts, which together provides for automated agent evolution (ADAS). As yet another example, the hypervisor can instantiate hardware-isolated environments. As still another example, DCL may be implemented as the deterministic version of the path language. As still another example, the deterministic engine and AI model interface may collectively enhance the path embedding generator.

### IV.5. System Architecture—Semantic Hypervisor

According to various embodiments, MetaForm is a semantic standardization layer that enables the orchestration, updating, and improvement of massive agent swarms. It implements what can be characterized as a “Semantic Hypervisor”-a computing architecture that enforces execution boundaries and manages agent lifecycles, analogous to how a traditional hypervisor manages virtual machine execution. Whereas a traditional hypervisor manages virtual machine execution, a semantic hypervisor manages AI agent execution. Whereas a traditional hypervisor enforces resource boundaries, a semantic hypervisor enforces semantic boundaries (DNA Map). Whereas a traditional hypervisor prevents illegal memory access, a semantic hypervisor prevents hallucination (invalid token generation). Whereas a traditional hypervisor isolates VM state, a semantic hypervisor isolates agent context via namespaces. Whereas a traditional hypervisor enforces schedules process execution, a semantic hypervisor schedules deterministic DCL execution.

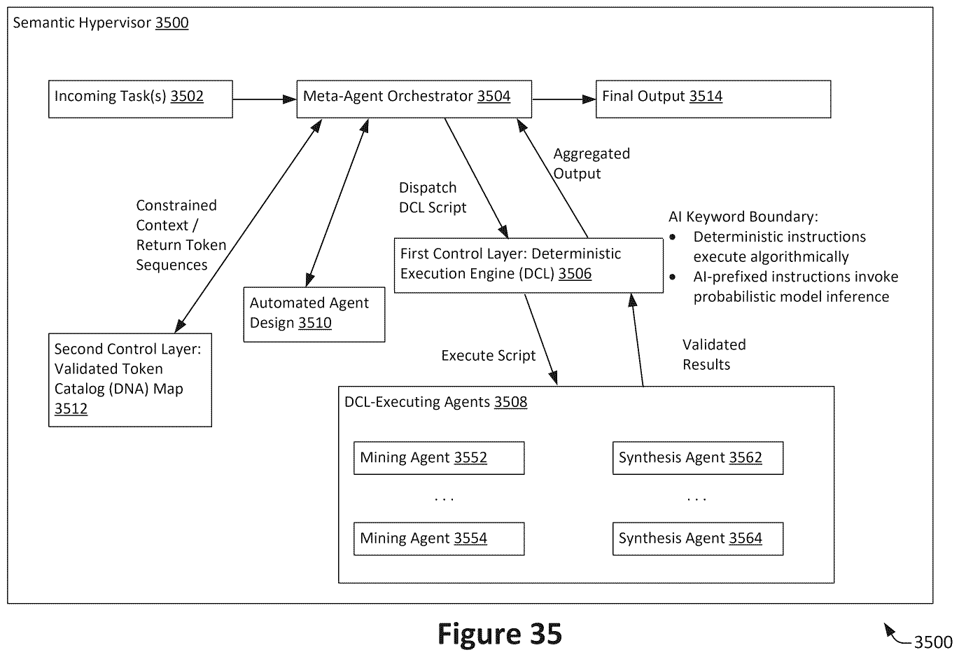

FIGS. 1-34 illustrate exemplary three-dimensional interactive environments, path language systems, and computing architectures from the parent application and are incorporated by reference for background context. FIG. 35 illustrates the overall system-level architecture of MetaForm AI highlighting its major components and their interactions, configured in accordance with one or more embodiments. The Meta-Agent Orchestrator 3504 coordinates a potentially large number of AI agents with the help of two components—the Validated Token Catalog (DNA) Map 3512 and Automated Agent Design (ADAS) 3510 modules—to manage tasks at scale. Various numbers (e.g., thousands) of AI agents can be dynamically assigned tasks, collaborate without redundant effort, and be refined or evolved over time.

According to various embodiments, the meta-agent orchestrator 3504 serves as the central coordinating engine. It receives incoming tasks (complex problems or user requests) and delegates them to a large pool of AI agents 3508 for parallel execution. The meta-agent orchestrator 3504 also collects and integrates results from agents to assemble the final output solution. It constantly oversees agent activities and performance.

In some embodiments, the meta-agent orchestrator 3502 functions as the kernel. It performs tasks such managing agent pools and lifecycles, allocating resources, and routing DCL scripts to agents. The orchestrator 3502 does not merely “assign tasks”—it instantiates DCL runtime environments. The “Task” is concretely defined as a DCL Script. This integration transforms the abstract “Orchestrator” into a concrete “DCL Execution Engine” 3904.

According to various embodiments, the Validated Token Catalog (DNA) Map Module 3512 serves as a knowledge representation module that converts tasks and data into a standardized format (e.g., SNF). The Validated Token Catalog (DNA) Map Module 3512 ensures that all agents interpret tasks consistently and can share information seamlessly. By using SNF, the meta-agent orchestrator 3504 prevents duplicate or redundant processing-results produced by one agent are immediately usable by others because everything is in a common semantic form.

In some embodiments, the Validated Token Catalog (DNA) Map Module 3512 functions as a bounded memory space for AI agents. It contains the valid genomes and enforces read-only access during all content generation operations, such that AI agents may query and select from the DNA Map but may not modify, add, or delete genome entries during synthesis. Write access to the DNA Map is restricted to the automated genome mining pipelines (described below) and to administrative operations such as genome blacklisting. This read-only enforcement during content generation prevents AI agents from corrupting the validated token catalog and ensures that the bounded selection domain remains stable throughout any synthesis workflow. The prevention of token generation outside the DNA Map constitutes the semantic equivalent of preventing “illegal memory access” in a traditional hypervisor.

According to various embodiments, the Automated Agent Design (ADAS) module 3510 serves as an adaptive design module responsible for evolving and refining agent capabilities. ADAS monitors performance metrics (KPIs) from agent operations and can automatically improve an agent's algorithms or create new specialized agents. This allows the system to optimize and update the agent pool dynamically without human intervention, ensuring that the collective intelligence improves over time.

According to various embodiments, the DCL-Executing Agent Pool 3508 serves as a collection of many (e.g., potentially thousands or more) of AI agents managed by the orchestrator. Each agent can be assigned specific tasks or subtasks. The meta-agent orchestrator 3504, via SNF, provides each agent with structured task data and, via ADAS, updates agents as needed. Agents execute tasks in parallel and feed results and performance feedback back to the orchestrator. The agent pool is highly dynamic-agents can be created, adapted, or retired on the fly based on the workload and their performance.

In some embodiments, the DCL-Executing Agent Pool 3508 may include functionality for providing hardware-isolated execution environments. Additionally, the automated agent design module 3510 may extract performance metrics from the DCL-executing agents and then feed updated script logic back to the meta-agent orchestrator 3504.

In some implementations, the DCL Execution Engine 3506 functions as the process scheduler, scheduling deterministic operations within DCL scripts independently of AI model inference operations. It performs tasks such as parsing the DCL script, executing deterministic operations, managing AI boundary transitions, and enforcing REQUIRE constraints. As illustrated in FIG. 35, the DCL execution engine 3506 connects to an AI model interface through which AI keyword invocations are transmitted and validated responses are received. The AI model interface represents the defined boundary point where probabilistic inference enters the deterministic execution context.

In some embodiments, agents can call other agents. Alternatively, or additionally, such agent calls can be coordinated by the meta-agent orchestrator 3504.

According to various embodiments, the Incoming Tasks 3502 include external tasks or requests enter the system through the orchestrator. After coordination and processing by the agents, the orchestrator produces a final output 3512 (e.g., a solution) that is delivered back to the user or calling system. This input/output interface is depicted to show how MetaForm AI handles large-scale tasks end-to-end: from receiving a problem to returning a coherent solution.

In FIG. 35, the Meta-Agent Orchestrator 3504 interfaces with an Incoming Task 3502 coming from an external source, and on the right with the Final Output result 3514 delivered once processing is complete. The orchestrator 3504 connects to the Validated Token Catalog (DNA) Map 3512, illustrating that it converts incoming tasks into a semantic normal form and also retrieves normalized data for consistency across the agent team. The connection between the orchestrator and ADAS 3510 indicates that the orchestrator supplies performance data (KPIs) to ADAS 3510 and, in return, receives updated agent designs or parameters. This highlights how ADAS enables continuous agent evolution within the system.

According to various embodiments, overall, this architecture diagram emphasizes MetaForm AI's ability to coordinate potentially thousands of agents (or more) through the orchestrator, which uses SNF to unify task representations and ADAS to continuously improve the agents. The flow from Task Input->Orchestrator->Agents->Orchestrator->Output shows how a task moves through the system and is solved by many agents working together under centralized coordination. The inclusion of SNF ensures that all agents work on the task in a complementary, non-overlapping way, and ADAS ensures the pool of agents remains optimized and effective over time. This architecture is what allows MetaForm AI to tackle complex tasks at scale efficiently and robustly.

Referring to FIG. 35, in accordance with various embodiments, the system-level architecture illustrates the dual-layer design described herein at the highest level of abstraction. A semantic hypervisor boundary 3500 encompasses the entire system. Within this boundary, the meta-agent orchestrator 3504 receives content generation requests and dispatches DCL scripts to the deterministic execution engine (DCL) 3506, which constitutes the first control layer. The validated token catalog (DNA Map) 3512, constituting the second control layer, is accessible to all DCL-executing agents in read-only mode during content generation operations.

According to various embodiments, the DCL-Executing Agents 3508 comprise DCL-executing agents, each operating within isolated namespace environments identified by syntactic prefixes (e.g., ?input, @output, _local). An AI keyword boundary annotation on the deterministic execution engine 3504 indicates that deterministic instructions execute algorithmically while AI-prefixed instructions invoke probabilistic model inference. DCL governs when AI is called and what AI may choose from. Content generation requests enter the system through the orchestrator 3504 and synthesized content assets with provenance maps are produced as output.

In some embodiments, every concept, process, or data structure in the system is defined in a single Component file using natural language structured by strict conventions. For example, consider the following illustrative example of a component definition in general as well as a specific component for motion.

### Component Definition

```
{
  ″term″: ″Component″,
  ″category″: ″concept″,
  ″definition″: ″[Component] is any normal form JSON-defined
  building block across
  chains (e.g., agents, chains, policies, validators). Components are
  versioned, schema-validated, and addressable by id to enable
  deterministic orchestration.″
}
```

### Example: Motion-Genome Component

```
{
  ″term″: ″Motion-Genome″,
  ″category″: ″concept″,
  ″schemaRef″: ″motion-genome-schema.json″,
  ″definition″: ″[Motion-Genome] encodes animation instructions
  defining motion effects
  such as fade, slide, reveal, scale, or rotate. Motion-genomes provide
  the atomic unit of animation in the platform.″,
  ″business-rules″: [
    ″Motion-genomes are the exclusive animation mechanism″,
    ″For coordinated animation, assign same genome ID to participating
    elements″,
    ″Source field provides provenance for rights management″
  ],
  ″architectural-invariants″: [
    ″Animation controlled via motion-genomes″,
    ″Reusable definitions across multiple elements″
  ]
}
```

According to various embodiments, agents do not rely on implicit knowledge or hard-coded logic. They reference specific definitions using [Term] notation, as shown in the following examples:
[Media-Analysis]: chain mines structural and semantic tokens from source media
[Motion-Genome]: encodes animation instructions defining motion effects
[Segment]: represents a temporal portion of content with associated tokens This creates a hyperlinked semantic graph where every concept has a single authoritative definition.

According to various embodiments, SNF is a specification for converting domain expressions into standardized semantic representations that enable features such as:
Algorithmic parsing-deterministic interpretation by DCL engines
Interoperability-uniform data exchange between agents
Deduplication-single authoritative definition prevents redundant processing

The following example illustrates an SNF structure in accordance with one or more embodiments.

### SNF Structure:

{
″snf-record″: {

| | |
|---|---|
| ″term″: ″string″, | // Canonical name (e.g., ″Motion-Genome″) |
| ″category″: ″enum″, | // concept \| contract-component \| meta-component |
| ″definition″: ″string″, | // Natural language meaning |
| ″schemaRef″: ″uri″, | // JSON Schema for validation |
| ″relationships″: [ | // Links to other SNF records |

```
    {″type″: ″requires″, ″target″: ″Term″},
    {″type″: ″produces″, ″target″: ″Term″}
    ]
  }
}
```

According to various embodiments, SNF functions as the “shared memory” or “blackboard” for the agent swarm, with the DNA Map as the persistent storage layer. This standardized representation enables agents developed independently to communicate without ambiguity. For instance, Bleacher Agents produce SNF, which is sent to the DNA Map for storage. Synthesis Agents then consume SNF and output assets.

According to various embodiments, the Component Reference System enables:
Single Source of Truth: Update one Component definition→improvement propagates instantly to all agents that reference it.
Conceptual Consistency: All agents share identical understanding of domain concepts.
Decoupled Logic: Agent behavior is independent of the underlying AI model.
Audit Trail: Every agent decision can be traced to specific Component definitions.

An example of a DCL Component Definition in accordance with one or more embodiments is as follows:

```
{
  ″term″: ″DCL″,
  ″category″: ″contract-component″,
  ″definition″: ″[DCL] is the DNA Contract Language executed by the agentic
  platform
  to orchestrate chains of agents over the [Token-Graph]. It separates
  Facts (normalized [Token] data) from Rules (deterministic control +
  Al-interpreted functions) and fixes the boundary between algorithm
  agents evaluation and model agents calls under [System-Instructions]
  with outputs validated by [Validation-Rules] and the [Policy-Engine].″
}
```

Referring again to FIG. 35, the semantic hypervisor boundary 3500 encompasses the Incoming Task(s) 3502, the Meta-Agent Orchestrator 3504, the First Control Layer: Deterministic Execution Engine (DCL) 3506, the DCL-Executing Agents 3508, the Automated Agent Design (ADAS) module 3510, the Second Control Layer: Validated Token Catalog (DNA) Map 3512, and the Final Output 3514. The semantic hypervisor boundary 3500 represents the enforced semantic and execution isolation layer within which all agent operations, deterministic control logic, and token validation processes occur. All data ingress and egress cross this boundary only through the orchestrator-managed interfaces.

In various embodiments, Incoming Task(s) 3502 are received by the Meta-Agent Orchestrator 3504 as structured or unstructured requests originating from users, external systems, or upstream computational processes. The Meta-Agent Orchestrator 3504 transforms these tasks into deterministic control instructions and semantic representations suitable for execution within the system. The orchestrator 3504 dispatches a DCL script to the First Control Layer: Deterministic Execution Engine (DCL) 3506 via the “Dispatch DCL Script” pathway illustrated in FIG. 35.

The First Control Layer: Deterministic Execution Engine (DCL) 3506 executes contract-defined logic algorithmically. As depicted in FIG. 35, an AI Keyword Boundary annotation is associated with the deterministic execution engine 3506. This boundary specifies that deterministic instructions execute strictly algorithmically, whereas AI-prefixed instructions invoke probabilistic model inference under constrained conditions. In this manner, DCL 3506 enforces separation between rule-based control flow and model-based generation, ensuring that probabilistic operations occur only when explicitly permitted by the governing contract components.

The DCL 3506 issues “Execute Script” instructions to the DCL-Executing Agents 3508. The DCL-Executing Agents 3508 comprise multiple specialized agents, including Mining Agent 3552, Mining Agent 3554, Synthesis Agent 3562, and Synthesis Agent 3564, as well as additional agents represented by ellipses in the figure. Mining agents are configured to extract structural or semantic tokens from source data and produce normalized semantic outputs. Synthesis agents are configured to consume validated semantic tokens and generate composite artifacts or higher-order outputs. Each agent operates within an isolated namespace and executes only the scope of instructions defined by the dispatched DCL script.

The DCL-Executing Agents 3508 return Validated Results to the Deterministic Execution Engine 3506. These validated results are constrained by validation rules and policy enforcement mechanisms to ensure conformance with schema definitions and component specifications. The Deterministic Execution Engine 3506 aggregates and structures these validated results and forwards an Aggregated Output to the Meta-Agent Orchestrator 3504, as illustrated by the return arrow labeled “Aggregated Output.”

The Second Control Layer: Validated Token Catalog (DNA) Map 3512 is accessible to system components for retrieval of constrained context and return token sequences, as indicated in FIG. 35. The connection labeled “Constrained Context/Return Token Sequences” illustrates that the Meta-Agent Orchestrator 3504 and associated execution components obtain normalized semantic definitions and previously validated tokens from the DNA Map 3512. In various embodiments, the DNA Map 3512 functions as a persistent semantic registry and enforces that only validated tokens are available for reuse, thereby preventing invalid or hallucinatory token propagation.

The Automated Agent Design (ADAS) module 3510 is operatively coupled to the Meta-Agent Orchestrator 3504. The orchestrator provides operational metrics, performance indicators, and execution traces to ADAS 3510. In response, ADAS 3510 generates updated agent configurations, revised component definitions, or newly instantiated agents that are subsequently incorporated into the DCL-Executing Agents 3508 pool. This feedback loop enables controlled evolution of agent capabilities while maintaining compliance with the deterministic and semantic constraints imposed by DCL 3506 and the DNA Map 3512.

After receiving aggregated and validated results from the Deterministic Execution Engine 3506, the Meta-Agent Orchestrator 3504 composes the Final Output 3514. The Final Output 3514 may include synthesized content assets, structured data outputs, provenance maps, validation artifacts, or combinations thereof. The orchestrator ensures that the final output reflects only validated tokens and contract-compliant operations performed within the semantic hypervisor boundary 3500.

In various embodiments, the arrows depicted in FIG. 35 represent controlled communication pathways. Upstream arrows from the DCL-Executing Agents 3508 to the Deterministic Execution Engine 3506 denote validated result propagation. Downstream arrows from the Deterministic Execution Engine 3506 to the agents 3508 denote script-controlled execution. Lateral connections between the Meta-Agent Orchestrator 3504 and both the DNA Map 3512 and ADAS 3510 denote semantic normalization and adaptive optimization functions, respectively. Collectively, these pathways illustrate a dual-layer control architecture in which deterministic execution (first control layer) and validated semantic storage (second control layer) operate in coordination under supervision of the Meta-Agent Orchestrator 3504 within the semantic hypervisor boundary 3500.

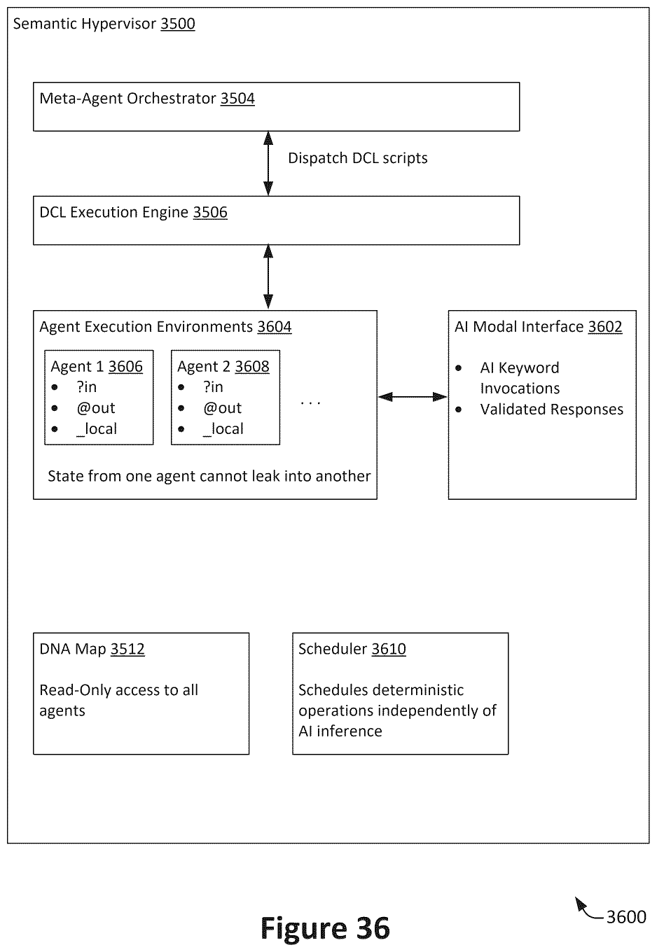

FIG. 36 illustrates a block diagram of the semantic hypervisor 3500, configured in accordance with one or more embodiments. The semantic hypervisor 3500 includes a meta-agent orchestrator 3504, a DCL execution engine 3506, and a DNA Map 3512.

In some embodiments, the meta-agent orchestrator 3504 functions as the kernel. It performs tasks such managing agent pools and lifecycles, allocating resources, and routing DCL scripts to agents 3508. The orchestrator 3504 does not merely “assign tasks”—it instantiates DCL runtime environments. The “Task” is concretely defined as a DCL Script. This integration transforms the abstract “Orchestrator” into a concrete “DCL Execution Engine”.

According to various embodiments, the meta-agent orchestrator receives content generation requests through an external interface, such as an API endpoint, a task queue, or a user-facing application. Each content generation request specifies at least a target content type (e.g., video, image, interactive experience) and input parameters such as reference assets, brand identity specifications, or textual descriptions. Upon receiving a content generation request, the meta-agent orchestrator identifies the appropriate DCL workflow script for the requested content type, decomposes the request into sub-tasks if the workflow requires multiple agent stages (such as a mining chain or synthesis chain), selects AI agents from the pool based on the sub-task requirements, and instantiates DCL runtime environments for each selected agent. The orchestrator then routes the workflow scripts to the assigned agents for execution, monitors their progress, and aggregates results into a unified output constituting the synthesized content asset.

In some implementations, the semantic hypervisor 3500 includes a process scheduler 3610, which schedules deterministic operations within DCL scripts independently of AI model inference operations. It manages agent execution environments 3604 of agents such as the agent 1 3606 and the agent 2 3608. It performs tasks such as parsing the DCL script, executing deterministic operations, managing AI boundary transitions, and enforcing REQUIRE constraints. As illustrated in FIG. 36, the DCL execution engine 3506 connects to an AI model interface 3602 through which AI keyword invocations are transmitted and validated responses are received. The AI model interface represents the defined boundary point where probabilistic inference enters the deterministic execution context. For example, keywords such as ?input_parameters, @output_state, and_local_vars may be used to provide structured memory blocks. Further, the different environments may be separated via strict memory partitioning.

In some embodiments, the DNA Map 3512 functions as a bounded memory space for AI agents. It contains the valid genomes and enforces read-only access during all content generation operations, such that AI agents may query and select from the DNA Map but may not modify, add, or delete genome entries during synthesis. Write access to the DNA Map is restricted to the automated genome mining pipelines (described below) and to administrative operations such as genome blacklisting. This read-only enforcement during content generation prevents AI agents from corrupting the validated token catalog and ensures that the bounded selection domain remains stable throughout any synthesis workflow. The prevention of token generation outside the DNA Map constitutes the semantic equivalent of preventing “illegal memory access” in a traditional hypervisor.

According to various embodiments, the Semantic Hypervisor achieves agent execution isolation through the namespace system defined in DCL. Each AI agent executing a workflow script operates within an isolated execution context comprising three namespaces: the input namespace (identified by the ? prefix) containing immutable parameters specific to that agent's assigned task; the output namespace (identified by the @ prefix) containing mutable session state that the agent produces as its results; and the local namespace (identified by the _ prefix or lowercase initial letter) containing mutable variables scoped to the current execution block. When the meta-agent orchestrator instantiates a DCL runtime environment for an agent, it populates the input namespace with task-specific data and initializes empty output and local namespaces. During execution, each agent can only read from its own input namespace and the shared validated token catalog (DNA Map), and can only write to its own output and local namespaces. This namespace isolation ensures that state produced by one agent's execution cannot leak into another agent's execution context, analogous to how a traditional hypervisor isolates virtual machine memory spaces. The orchestrator collects results from each agent's output namespace after execution completes.

According to various embodiments, the Semantic Hypervisor executes DCL scripts within the isolated namespaces described above. When the meta-agent orchestrator assigns a task to an AI agent, the Semantic Hypervisor instantiates a DCL runtime environment for that agent, populates its input namespace with task-specific parameters, attaches a read-only reference to the relevant portion of the validated token catalog (DNA Map), and initiates deterministic execution of the agent's workflow script. The DCL execution engine operates within this Hypervisor-managed environment, such that the pause-invoke-validate-resume cycle described therein occurs within the namespace isolation and bounded memory constraints enforced by the Hypervisor. This integration ensures that the deterministic execution guarantees of DCL and the constrained selection guarantees of DNA AI are both enforced within the Hypervisor's agent management framework.

### IV.6—AI Agent Lifecycle and Workflow Orchestration

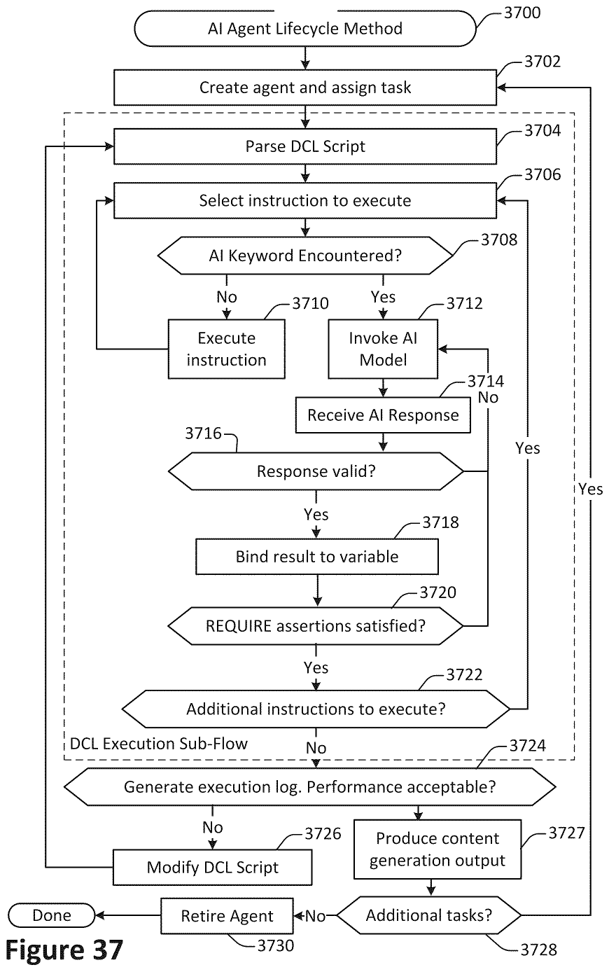

FIG. 37 illustrates a flowchart 3700 detailing the lifecycle of an AI agent within MetaForm AI, from the point it is tasked with a job to its eventual retirement, performed in accordance with one or more embodiments. It shows how MetaForm AI manages each agent's existence and performance in a continuous feedback loop. The orchestrator actively monitors each agent's Key Performance Indicators (KPIs) during task execution and uses that feedback to decide whether an agent should be adapted (via ADAS) for better performance or eventually retired. This dynamic lifecycle management is crucial for optimizing workflows in real time and maintaining an efficient agent ecosystem.

At 3702, the agent is created and one or more tasks are assigned. In some implementations, when a new task (or a new portion of work) arises, the orchestrator either selects an available agent or creates a new agent (using ADAS if a specialized skill is needed). The agent is assigned the task to work on. This marks the beginning of the agent's lifecycle for that task. The assigned agent then executes the task, as part of a DCL Execution Sub-Flow. In some embodiments, the agent uses the instructions and data (provided in SNF format) to perform its specific subtask or role. During execution, the agent might also interact with SNF to fetch any needed normalized information and avoid duplicating work done by others.

Operations 3704-3722 of FIG. 37 describe the DCL Execution Sub-Flow performed by the DCL execution engine within the Semantic Hypervisor environment. At 3704, the DCL execution engine parses the DCL script associated with the assigned task. The script is defined according to a formal grammar comprising statements including assignments, assertions, control flow structures, filter operations, AI invocations, and logging instructions. Parsing identifies statement boundaries, variable namespaces, control flow blocks, and explicit AI invocation instructions marked by the designated AI keyword.

At 3706, the execution engine selects an instruction to execute in accordance with the script order and control flow logic. Deterministic instructions—including SET assignments, REQUIRE assertions, IF/ELSE blocks, FOR loops, FILTER operations, and LOG statements—are executed algorithmically and reproducibly without invoking any probabilistic model inference.

At 3708, the engine determines whether the selected instruction contains the AI keyword. The AI keyword constitutes a syntactic boundary between deterministic execution and probabilistic model inference. If no AI keyword is encountered, execution proceeds to 3710.

At 3710, the deterministic instruction is executed. This may include variable binding within the input (?), output (@), or local (_) namespaces, deterministic filtering of collections using strictly defined predicates, or evaluation of assertion conditions. After execution of the deterministic instruction, control returns to 3706 to select the next instruction.

If, at 3708, the selected instruction includes the AI keyword, execution proceeds to 3712. At 3712, the DCL execution engine invokes the AI model through a defined interface. In some embodiments, runtime is paused while the relevant DNA Map subset is loaded as AI's complete selection domain, providing a construct constrained context.

In some embodiments, prior to invocation, the engine loads a relevant subset of the validated token catalog (DNA Map) corresponding to the script's execution context and provides that subset as constrained context to the AI model. The AI model is thereby restricted to selecting and parameterizing entries from the provided subset rather than generating unconstrained content.

At 3714, the system receives the AI model's response. The response is structured according to a predefined schema associated with the AI invocation and typically comprises one or more selected token sequence identifiers and associated parameter values.

At 3716, the execution engine validates the received response. Validation includes confirming that each returned token sequence identifier exists within the loaded subset of the validated token catalog and that all returned parameters conform to defined type and value bounds. If the response is not valid, an error condition is generated and the AI invocation may be re-attempted or execution halted in accordance with system policy.

If the response is valid, at 3718, the validated and assertion-compliant response is bound to a variable in the appropriate namespace (e.g., output or local namespace). Binding is performed deterministically by assigning the validated result to the designated variable specified in the AI invocation statement. Deterministic execution then resumes.

Execution proceeds to 3720, where one or more REQUIRE assertions are evaluated against the validated response. These assertion instructions constitute deterministic validation constraints defined within the script. If any assertion constraint is not satisfied, the response is rejected and treated as a validation failure. If all assertion constraints are satisfied, execution proceeds to 3722.

At 3722, the execution engine determines whether additional instructions remain to be executed in the script. If additional instructions remain, control returns to 3706 and the selection-execution cycle continues. If no further instructions remain, the DCL execution sub-flow completes and control proceeds to subsequent lifecycle operations, including performance evaluation and potential agent adaptation or retirement.

Collectively, operations 3704-3722 implement the pause-invoke-validate-resume cycle in which deterministic control flow governs all transitions, AI inference occurs only at explicitly marked AI keyword boundaries, and all probabilistic outputs are subjected to catalog validation and deterministic assertion checks before being incorporated into the execution state.

At 3724, an execution log is generated and performance monitoring is performed. In some embodiments, as the agent works, the Meta-Agent Orchestrator continuously monitors the agent's performance. Key Performance Indicators (such as speed, accuracy, resource usage, etc.) for the task are collected. This monitoring can happen in real-time during execution and after the task completes.

The orchestrator evaluates whether the agent's performance meets the required standards for the task. In some implementations, if the agent's performance is acceptable (Yes), it means the task was completed successfully or the agent is performing well enough to continue. If the performance is below expectations (No), the system determines that improvements are needed.

At 3726, if Performance is Inadequate (No), the orchestrator engages the Automated Agent Design (ADAS) module to adapt or improve the agent by modifying the DCL script based on the execution log. According to various embodiments, such operations may involve tuning the agent's algorithms, providing additional training, or even generating a new improved agent model. The agent may then be refined and updated. After adaptation, the agent returns to the execution stage to retry the task or tackle the next attempt with its improved capabilities. This loop of execute->monitor->adapt can repeat iteratively, allowing the agent to learn from mistakes and improve within the task's timeframe. Modifications apply to figure operations.

At 3727, if instead Performance is Adequate (Yes), then content generation output is produced by the agent. According to various embodiments, the content generation output may be generated based on the output of the nondeterministic model executed by the agent, potentially in combination with one or more deterministic operations.

At 3728, the agent successfully completes the task (or its part of the task) meeting the KPIs. The results are reported back to the orchestrator. After a successful task completion, the orchestrator checks at 3728 if there are more tasks remaining that could use this agent. If yes, the agent will be assigned the next task (looping back to the Task Assignment stage at 3702) and continue operating. This allows proficient agents to be reused for multiple tasks, increasing efficiency. If no further tasks are available for this agent (or if the system has developed superior agents via ADAS making this agent obsolete), then the agent's active role is concluded.

At 3730, the agent is dynamically retired from the pool. Retirement could mean the agent process is terminated or archived. This occurs when the agent is no longer needed-either it has completed all its work and no new tasks require its particular skills, or the orchestrator/ADAS has replaced it with a better-performing agent design. Retiring idle or underperforming agents frees up system resources and keeps the agent pool optimized. Notably, in MetaForm AI this retirement is not permanent deletion of knowledge-any useful experience or data the agent produced (in SNF) remains available to the system. The retirement step marks the end of that agent's lifecycle within the context of MetaForm AI's operations.

In some embodiments, throughout this lifecycle, MetaForm AI optimizes agent workflows in real-time. The feedback loop (monitoring KPIs and adapting agents on the fly) ensures that agents are continuously improved or swapped out to meet performance targets. This means the system can react to difficulties an agent encounters (for example, if an agent is struggling with a task, it will be quickly upgraded or replaced by a more capable agent) and thus maintain overall efficiency and effectiveness.

This lifecycle diagram underscores how MetaForm AI keeps the agent population adaptive and optimized. According to various embodiments, agents that perform well are reused for subsequent tasks, maximizing their utility, whereas agents that struggle are promptly upgraded or eventually phased out. The orchestrator's real-time KPI monitoring combined with ADAS-driven agent evolution ensures that at any given time, the pool of agents is as effective as possible. This dynamic approach is a significant innovation of MetaForm AI, allowing it to maintain high performance across thousands of agents handling ever-changing tasks.

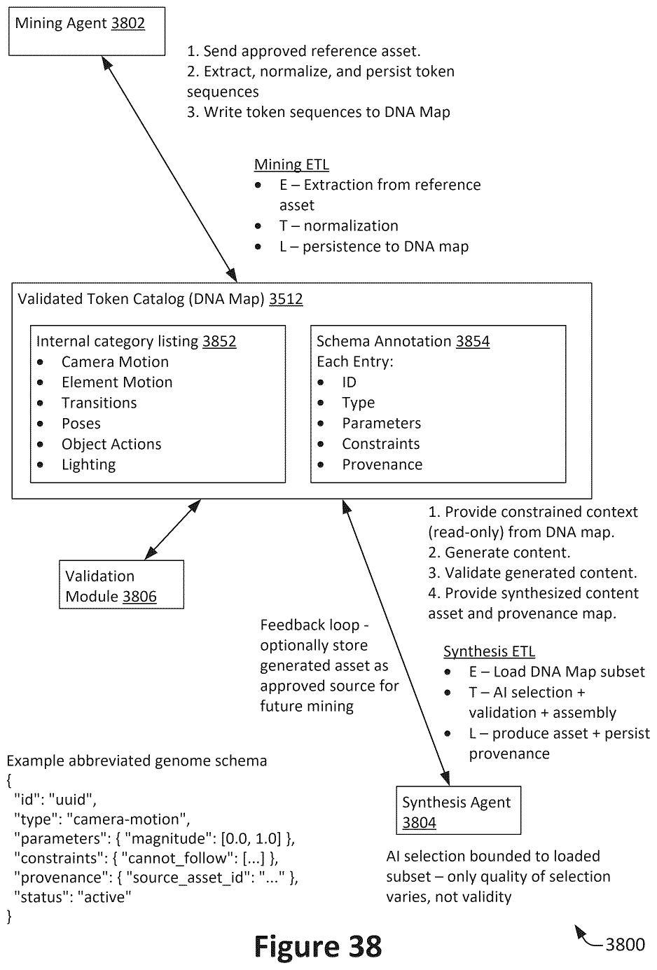

FIG. 38 illustrates a message passing diagram showing utilization of the Semantic Normal Form (SNF), configured in accordance with one or more embodiments. SNF is a feature of MetaForm AI that helps to ensure all agents can interoperate smoothly and avoid redundant computations. SNF provides a shared data representation and knowledge base that agents and the orchestrator use to exchange information. By converting tasks, inputs, and intermediate outputs into a common semantic format, SNF enables an agent's output to become immediately usable by other agents. This prevents different agents from accidentally duplicating the same work and fosters efficient collaboration among potentially thousands of agents.

In some embodiments, SNF includes Standardized Task Representation, a universal format for tasks and data. When the orchestrator breaks down a problem, the subtasks are described in SNF terms (e.g., standardized data structures or ontologies). Similarly, any result an agent produces is translated into SNF before being shared. This standardization means every agent “speaks the same language,” eliminating misinterpretation and the need for data conversion between agents.

In the message passing diagram, a Validated Token Catalog (DNA Map) 3512 includes an internal category listing 3852 and a schema annotation 3854. The Validated Token Catalog (DNA Map) 3512 can be thought of as a central repository or blackboard that agents can read from and write to. The Validated Token Catalog (DNA Map) 3512 communicates with various elements, such as a mining agent 3802, a validation module 3806, and a synthesis agent 3804. Although only two agents are shown for the purpose of exposition, in practice the system may support thousands of agents. The Validated Token Catalog (DNA Map) 3512 stores information such as intermediate results, partial computations, or learned insights. Because all agents have access to this repository, the system functions as a cohesive team rather than isolated units.

In some embodiments, SNF helps to prevent redundant processing. If one agent has already completed a subtask or computed a piece of data, that result is stored in SNF. Other agents, before starting a similar computation, will check SNF (implicitly via the orchestrator's task assignment or directly, depending on design) to see if the result is already available. This means no two agents will waste time solving the same sub-problem independently. In practice, this drastically improves efficiency, especially in large teams, because each piece of work is done once and immediately reused wherever else needed.

In some embodiments, SNF facilitates interoperability and seamless collaboration. By using SNF as an intermediary, agents can specialize in different aspects of a task but still contribute to a unified outcome. For instance, one agent might specialize in data extraction, another in analysis, and another in summarization; SNF allows them to pass their intermediate outputs along the chain flawlessly. FIG. 38 emphasizes how SNF acts as an integration layer, so the output of Agent A can flow into Agent B's input, etc., without custom translation. This design greatly simplifies adding new agents or changing agents' roles, because as long as they read/write SNF, they can plug into the MetaForm AI ecosystem.

In some embodiments, the Meta-Agent Orchestrator is responsible for enforcing the use of SNF. When distributing tasks, it formats them into SNF and also checks SNF for existing results that might fulfill new subtasks. It orchestrates agents in such a way that SNF stays up-to-date with the latest partial results. Essentially, the orchestrator and SNF together ensure global knowledge is shared, making the whole multi-agent system more intelligent than the sum of its parts.

As shown in FIG. 38, agents are connected to the Validated Token Catalog (DNA Map) 3512. In some embodiments, any agent can both contribute to SNF and consume from SNF, although only one example flow is shown in FIG. 38 for clarity. This hub-and-spoke structure means every piece of information only needs to be produced once. If Agent B later produces a result “Y” that Agent A or C might need, it would similarly post it to the Validated Token Catalog (DNA Map) 3512, and the others would fetch it rather than recalculate it.

It should be noted that although FIG. 38 illustrates a single centralized repository, in some embodiments a decentralized model may also be used to facilitate scaling. For instance, different groups of agents may be assigned to different shared knowledge base nodes that provide locally centralized knowledge to the group.

The interoperability afforded by SNF is visually clear: different agents (possibly with different specializations or created by different design strategies) can collaborate because SNF harmonizes their inputs and outputs. For example, Agent A's output might be a data structure or knowledge chunk that, thanks to SNF's standardization, Agent B immediately understands and can incorporate into its task. SNF effectively acts as a shared memory or common language for the agents.

In some embodiments, this approach markedly improves efficiency and scalability in comparison to conventional techniques. In a team of thousands of agents, without SNF there might be wasted effort where agents unknowingly repeat each other's work. With SNF, MetaForm AI behaves intelligently as a whole: once something is solved or a piece of data is processed, that knowledge is globally available. This is a key innovation for large-scale AI systems, enabling MetaForm AI to tackle very complex problems by dividing labor among agents without losing coherence or efficiency.

As an example scenario, suppose MetaForm AI is processing a large document. Agent A is responsible for extracting all person names from the text, Agent B is translating the text into another language, and Agent C is summarizing the text. Without SNF, each agent might independently read and parse the entire document, which is wasteful. With SNF, Agent A's extraction of names (an intermediate result) is stored in the SNF. When Agent C needs the list of important entities for summarization, it simply pulls Agent A's results from SNF, rather than parsing the document again. Similarly, Agent B's translated text could be stored for Agent C to use in creating a summary in the new language. In this way, SNF orchestrates a seamless hand-off of information between agents, preventing redundant parsing and computations. The result is a much faster and more efficient multi-agent collaboration.

According to various embodiments, the system operates as a bidirectional pipeline in which the mining subsystem and the synthesis subsystem are both governed by the same deterministic execution engine and the AI keyword boundary. In the mining direction, extraction workflow scripts written in DCL process approved reference assets via a mining agent 3802 to extract, normalize, and persist new token sequences (genomes) to the validated token catalog (DNA Map). In the synthesis direction, content generation workflow scripts written in DCL are executed at a synthesis agent 3804 to select token sequences from the validated token catalog and compose synthesized content assets. Because both directions use the identical domain-specific language, the identical syntactic AI keyword boundary, the identical deterministic execution engine, and the identical validation and logging mechanisms, the system maintains uniform process control, auditability, and hallucination prevention across both extraction and generation operations.

In some embodiments, a synthesized content asset produced by the synthesis subsystem is eligible to be designated as an approved reference asset for processing by the mining subsystem. For example, a synthesized video that has passed quality review may be marked as “approved for mining,” and the mining subsystem can then extract new genomes from that synthesized video and add them to the validated token catalog. This bidirectional feedback creates an incremental expansion mechanism: as the system generates more approved content, the validated token catalog grows, enabling greater creative variety in subsequent synthesis operations while maintaining the same bounded, provenance-tracked constraints.

Referring to FIG. 37, in accordance with various embodiments, the bidirectional pipeline described in the preceding paragraph is illustrated as a diagram centered on the validated token catalog (DNA Map) 3512. On a mining pathway (top side), approved reference assets are processed by mining agents that extract, normalize, and persist token sequences to the DNA Map with write access. On a synthesis pathway (bottom side), synthesis agents receive constrained context from the DNA Map with read-only access and produce synthesized content assets with associated provenance maps. A feedback loop connects the synthesis output back to the pool of approved reference assets, indicating that a synthesized content asset may be designated as an approved source for future mining.

The DNA Map 3512 includes a schema annotation showing the structure of each token sequence entry (identifier, type, parameters, constraints, provenance, status). An annotation on the synthesis pathway indicates that AI selection is bounded to the loaded subset and only quality of selection varies, not validity. Additionally, labeled zone brackets identify the Extract-Transform-Load (ETL) stages along each pathway: on the mining pathway, extraction spans from the approved reference asset through the mining agents, transformation spans the normalization operations, and loading spans the persistence to the DNA Map; on the synthesis pathway, extraction spans the loading of DNA Map subsets, transformation spans AI selection and validation and assembly, and loading spans the production of the synthesized asset and persistence of provenance.

In one or more embodiments, modular architecture within the Semantic Hypervisor supports scalable deployment across distributed environments. Multiple independent hypervisors may coordinate via message queues, each hosting agent sets that operate on subsets of data within a shared DNA Map. The internal SNF schemas ensure consistent interpretation across environments, while DCL's deterministic semantics maintain uniform execution logic regardless of processing location. This distributed orchestration enables the framework to perform high-volume genome mining, synthesis, and validation at industrial scale, maintaining deterministic control over processes while constraining AI-driven components to well-defined selection domains.

Overall, the system described functions as an integrated computing environment that combines deterministic workflow enforcement, bounded probabilistic reasoning, structured data normalization, automated provenance tracking, and agent-based orchestration. These interacting components together form a controlled ecosystem capable of executing large-scale AI-assisted content generation in a verifiable, modular, and reproducible manner.

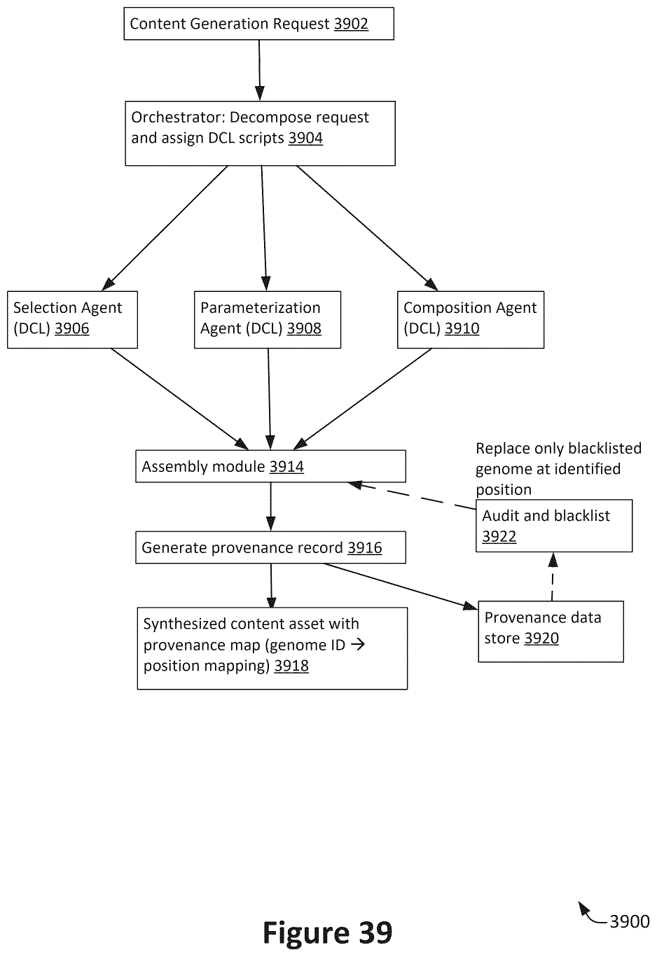

FIG. 39 illustrates a task partitioning and execution flow diagram 3900 for a method performed in accordance with one or more embodiments. FIG. 39 demonstrates how MetaForm AI handles a complex task by dividing it into subtasks and executing those subtasks in parallel across multiple agents. It also highlights the system's ability to dynamically balance the workload among a vast number of agents, and how partial results are finally aggregated into a coherent solution. This end-to-end process showcases MetaForm AI's scalability and real-time adaptability when solving large problems. The sequence of events and components in this diagram includes the following elements.

In some embodiments, the process begins when MetaForm AI receives a complex task 3902 such as a request to generate content, for instance in a large project or query that is too multifaceted for a single agent to handle efficiently. The Meta-Agent Orchestrator analyzes this task and partitions it into a set of smaller, more manageable subtasks at 3904.

According to various embodiments, each subtask represents a portion of the overall problem—these could be independent components or parallelizable chunks of work. This partitioning leverages SNF to ensure each subtask is well-defined and understood by the agents that will handle it. A content generation request ecan be decomposed by the orchestrator into sub-tasks assigned to DCL-executing agents (such as a selection agent 3906, a parameterization agent 3908, and a composition agent 3910). Each agent executes its respective DCL script with the AI keyword boundary constraints described herein.

According to various embodiments, each agent receives a well-defined subtask (in SNF format) and begins work on it. This demonstrates MetaForm AI's massive parallelism: it can leverage thousands of agents to tackle different parts of a problem at the same time, drastically reducing solution time for complex tasks.

According to various embodiments, the assigned agents (Agent 1, Agent 2, Agent 3, etc.) execute their respective subtasks concurrently. Each agent focuses on its piece of the problem. Because of SNF and the orchestrator's coordination, agents can also share intermediate results if there are any dependencies between subtasks (ensuring no agent needlessly repeats work another has done). During this execution phase, the orchestrator doesn't simply wait idle; it actively monitors the progress of each agent and the workload distribution.

According to various embodiments, as agents work, MetaForm AI's orchestrator keeps track of performance and can dynamically rebalance the workload for optimal efficiency. If it detects that one subtask is lagging or an agent is overloaded (for instance, Subtask B turning out to be more complex than initially estimated and Agent 2 struggling), the orchestrator can take action in real time. This might involve spawning additional agents to help with that subtask or redistributing portions of the subtask to other available agents. This kind of adaptive repartitioning is a unique capability-MetaForm AI doesn't fix the task division at the start, but can adjust on the fly to ensure no single agent becomes a bottleneck. In practice, this means even if one component of the task is slow, the system will marshal more resources (agents) to maintain overall throughput. This dynamic balancing scales up to thousands of agents or more; if one agent cannot handle its load, many others can be allocated quickly to share the work.

In some embodiments, as an agent (or team of agents for a subtask) finishes its work, it produces a partial result (the solution to its subtask). The Meta-Agent Orchestrator then acts in the role of an aggregator. Partial results are sent back to a central aggregation module. The orchestrator collects these outputs. Thanks to SNF, these results are in compatible formats, which simplifies merging them. The aggregation stage involves combining all the pieces—it could be as straightforward as concatenating answers, or as complex as integrating different data analyses—depending on the nature of the original task. The critical point is that MetaForm AI efficiently brings together the fruits of all parallel computations.

The outputs of these agents flow into an assembly module 3914, which composes the synthesized content asset from validated selected token sequences as described in the preceding paragraph. In some implementations, after aggregation, the assembly produces the final output at 3916, which is the coherent solution to the original complex task. This final result takes into account all the sub-results and ensures they fit together correctly (nothing missing or inconsistent). The final output is then delivered back to the user or system that requested the task. It's important to note that despite the task being split and solved by many agents, the end result is presented as a unified answer, as if a single intelligent entity solved the problem. MetaForm AI's orchestrator and SNF guarantee that the parallel efforts integrate seamlessly, so the user sees a coherent solution without needing to know the details of the parallel processing.

In some embodiments, after assembly, a provenance record generation step creates the structured provenance map 3916 recording the ordered mapping of token sequence identifiers to positions within the asset. The synthesized content asset and its provenance map are then produced as the final output at 3918.

In some embodiments, a surgical update feedback path connects the provenance data store 3920 back through an audit and blacklist decision point 3922 to the assembly module 3914, illustrating how selective replacement of blacklisted genomes at identified positions operates without regenerating entire assets.

Overall, FIG. 39 illustrates MetaForm AI's end-to-end capability for handling large and complex tasks: massive parallelism in execution, combined with intelligent orchestration and load balancing, leading to fast and reliable outcomes. The system can scale to potentially thousands of agents or more working at once, yet coordinate them so well that the final answer is accurate and complete. Conventional systems might struggle to manage so many agents without conflicts or wasted work, but MetaForm AI's use of SNF and dynamic orchestration (via the Meta-Agent Orchestrator and ADAS for agent optimization) makes it possible to use sheer numbers of agents effectively.

### IV.7. Two-Way Hallucination Prevention—the Integrated Architecture

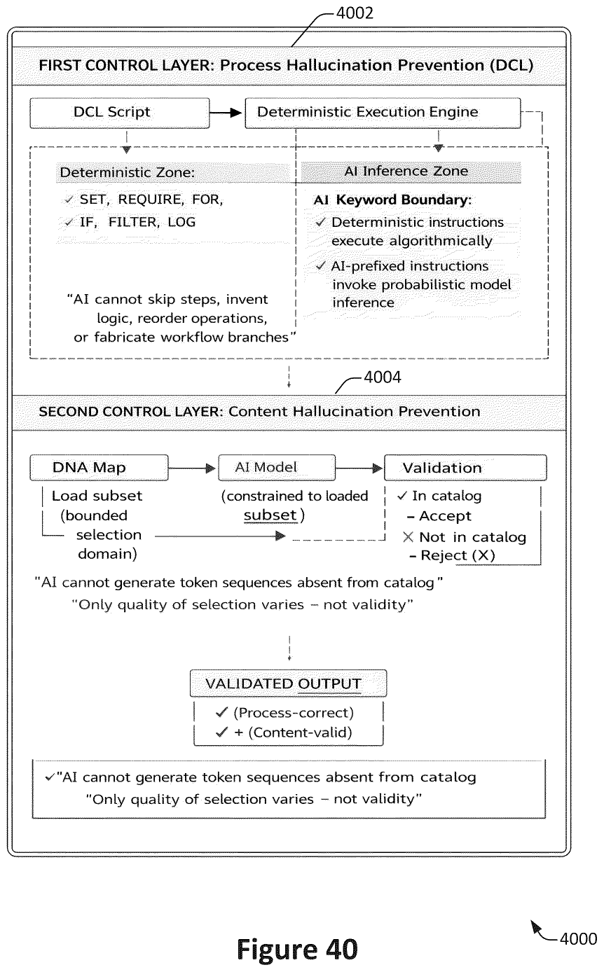

FIG. 40 illustrates a block diagram 4000 showing two-way hallucination detection, configured in accordance with one or more embodiments. In some embodiments, two types of hallucination may be prevented. At 4002, a first control layer prevents process hallucination from a top-down perspective by DCL. Specifically, the AI cannot skip steps, invent logic, or change workflow. A thick vertical line within the first control layer represents the AI keyword boundary separating the deterministic execution zone from the AI inference zone. At 4004, a second control layer prevents content hallucination in a bottom-up way by DNA AI. Specifically, the AI cannot generate invalid/unexpected outputs. Within the second control layer, the DNA Map provides a bounded selection domain that is loaded as a subset into the AI model's invocation context, such that the loaded subset constitutes the AI model's complete selection domain. An arrow from the DNA Map to the AI model invocation labeled “Load subset as AI's complete selection domain” visually illustrates the constrained selection design invariant: the AI model operates within the boundaries defined by the DNA Map subset, and only quality of selection varies, not validity. Outputs validated against the loaded subset are accepted; outputs referencing token sequences absent from the catalog are rejected. Both control layers converge at a validated output that is both process-correct and content-valid.

Consider process hallucination examples. Without DCL, an AI might skip validation steps entirely, invent new workflow branches, ignore error conditions, process items out of order, or forget to save results. With DCL, the runtime enforces constraints, for instance as follows:

// These MUST execute - Al cannot skip or modify
REQUIRE ?video EXISTS ″Video must be provided″
REQUIRE video_ar == ″9:16″ OR video_ar == ″1:1″ OR video_ar == ″16:9″
FOR layer IN input_layers
// Every layer is processed
SET layer_verb_id = new_id( )
// Al is called with constrained context
SET inferred_verbs = Al analyze_layer_animations_v3(layer, source_id,
action_templates)
// Validation cannot be skipped
REQUIRE contains(action_template_names, verb.action)
END
// Save MUST occur
SET @layerVerbs = validated_verbs
Content Hallucination Examples Prevented

Consider content hallucination examples. Without DNA AI, an AI might: invent new action types (“super-zoom-360”), generate invalid parameter combinations, create timing values outside bounds, or produce mismatched token references. With DNA AI, constraints may be provided as followed.

// Valid vocabulary is loaded
SET action_template_names = [″pan-left″, ″pan-right″, ″zoom-in″,
″fade-in″, ... ]
// Al output is validated
SET inferred = Al analyze_layer_animations_v3( ... )
// Invalid selection is REJECTED
REQUIRE contains(action_template_names, inferred.action)
″Action 'super-zoom-360' not in approved catalog - REJECTED″
Combined Guarantee

The two-way architecture ensures:

According to various embodiments, the two-way architecture ensures:
Process Integrity: Every step in the workflow executes exactly as defined
Content Validity: Every AI output is drawn from pre-validated options
Auditability: Every decision can be traced to specific code and vocabulary
Determinism: Given same inputs and same genome catalog, output is reproducible

### IV.8. DCL (DNA Contract Language)—Top-Down Hallucination Control

According to various embodiments, DCL captures complex business processes as deterministic code that executes algorithmically—not by a probabilistic LLM. This eliminates “process hallucination”—where an AI skips steps, invents logic, or hallucinates workflow—while preserving flexibility for content generation. DCL is designed to be implementation-agnostic for the deterministic portions. The deterministic operations (SET, REQUIRE, FOR, IF, FILTER, etc.) may be executed through any of the following mechanisms:
Compilation: DCL transpiled to executable code in another language (e.g., Python, JavaScript)
Interpretation: DCL executed by a dedicated runtime interpreter
Hybrid execution: Combination of compiled and interpreted execution

In some embodiments, deterministic operations always execute deterministically, regardless of implementation approach. Only instructions explicitly marked with the AI keyword invoke probabilistic AI model inference. An example of the DCL syntax is formally defined using Extended Backus-Naur Form (EBNF):

```
(* DCL Script Structure *)
Script
::= { Statement }
(* Statement Types *)
Statement ::= Assignment | Assertion | ControlFlow | Al_Invocation | Logging
(* Assignment - Deterministic value binding *)
Assignment ::= ″SET″ Variable ″=″ Expression
Variable ::= InputVariable | OutputVariable | LocalVariable
InputVariable ::= ″?″ Identifier (* Immutable input parameter *)
OutputVariable ::= ″@″ Identifier (* Mutable session output *)
LocalVariable ::= ″_″ Identifier | [a-z] Identifier (* Mutable local state *)
(* Assertions - Deterministic validation *)
Assertion ::= ″REQUIRE″ Condition StringLiteral
  | ″REQUIRE″ Condition
(* Al Boundary - The Core Innovation *)
Al_Invocation ::= ″SET″ Variable ″=″
″AI″ FunctionName ″(″ ArgumentList ″)″
    (* Explicitly marks transition from deterministic to probabilistic *)
(* Control Flow - Deterministic logic *)
ControlFlow ::= IfBlock | LoopBlock | FilterOp
IfBlock ::= ″IF″ Condition { Statement } [ ″ELSE″ { Statement } ] ″END″
LoopBlock ::= ″FOR″ Iterator ″IN″ Collection { Statement } ″END″
(* Filter Operation - Deterministic Set Operation *)
FilterOp ::= ″FILTER″ Collection ″WHERE″ Predicate
    (* Predicate MUST be deterministic: equality, comparison, contains *)
    (* Semantic similarity (vector search) EXCLUDED unless via Al call *)
(* Logging *)
Logging ::= ″LOG″ LogLevel StringExpression
LogLevel ::= ″info″ | ″warn″ | ″error″ | ″debug″
(* Expressions *)
Expression ::= Literal | Variable | FunctionCall | BinaryOp | UnaryOp
Condition ::= Expression ComparisonOp Expression | Expression
″EXISTS″
Predicate ::= Condition (* Must resolve to Boolean deterministically *)
```

In some embodiments, the grammar may include symbols and features such as the following:

| Symbol | Meaning | Determinism |
|---|---|---|
| ? | Input namespace | Deterministic |
| | (immutable) | |
| @ | Output namespace (mutable | Deterministic |
| | session state) | |
| — | Local variable (mutable | Deterministic |
| | within block) | |
| AI | AI function invocation | Probabilistic |
| REQUIRE | Validation constraint | Deterministic |
| FILTER | Set operation | Deterministic (no semantic |
| | | search) |

In some embodiments, The FILTER operation executes a deterministic iteration over a Collection, evaluating a Predicate for each element. The Predicate must resolve to a Boolean value using:
Strict equality (==,!=)
Numerical comparison (<, >, <=, >=)
Deterministic string matching (contains, startsWith)

In some embodiments, semantic similarity operations are prohibited in FILTER unless wrapped in an explicit AI invocation. As used herein, “semantic similarity operations” refers to any computation that evaluates the degree of semantic relatedness between two or more data elements using probabilistic or learned representations, including but not limited to: vector cosine similarity between embedding representations, Euclidean or other distance metrics in embedding space, approximate nearest neighbor (ANN) queries against vector databases, and any other comparison that requires model inference or learned representations to evaluate. These operations are distinguished from deterministic comparators (strict equality, numerical comparison, deterministic string matching). The DCL explicitly marks steps requiring creative intelligence with the AI keyword. This syntactic distinction is formally defined in the system. For instance, consider the following illustrative example of an AI-Functions Component Definition

```
{
  ″term″: ″Al-Functions″,
  ″category″: ″contract-component″,
  ″definition″: ″[Al-Functions] capture semantic decisions requiring interpretation
    of [Request].description or nuanced [Policy] text. They are executed
    by model agents with strict output schemas checked by [Validation-Rules].
    In DCL syntax, Al functions MUST be called with the Al keyword prefix
    (e.g., SET score = Al score_by_request_description(request, pattern))
    to visually distinguish semantic (non-deterministic, costly, LLM-powered)
    operations from deterministic functions.
    This explicit marking enables:
    (1) cost transparency - easy to count Al calls and estimate execution cost
    (2) performance analysis - identify optimization opportunities
    (3) execution optimization - batch or parallelize Al calls
    (4) debugging clarity - isolate hallucination sources
    The [Contract-Linter] validates that all semantic functions declared
    with function_type='semantic' are called with Al keyword.″
}
```

According to various embodiments, DCL execution flow may involve the following operations.
Deterministic Execution: The DCL runtime executes the process algorithmically (Top-Down control)
AI Boundary: When an AI instruction is encountered, deterministic execution pauses
Constrained Context: The system constructs a constrained context for the AI model to perform only that specific creative step
Validation: The AI result is validated against schema before returning to deterministic flow
Resume: Deterministic execution continues with validated AI output

The following examples illustrate various elements of DCL execution.

Example 1: Transition Extraction Agent (Illustrative DCL). This example shows the clear separation—extensive deterministic setup, a single AI call, then deterministic post-processing:

```
// DETERMINISTIC: Input validation and setup
REQUIRE ?media EXISTS “Media input must be provided”
SET mediaFile = “”
SET mediaId = 0
IF ?media.file EXISTS
  SET mediaFile = ?media.file
  SET mediaId = ?media.id
ELSE
  SET mediaFile = ?media
  SET mediald = 1
END
SET @extracted_genomes = [ ]
SET @validTypes = [“cut”, “fade”, “dissolve”, “wipe”, “slide”, “zoom”]
// Check for optimization opportunity
SET hasSegments = false
IF ?segments EXISTS AND ?segments.boundaries EXISTS
  SET segmentCount = count(?segments.boundaries)
  IF segmentCount > 0
    SET hasSegments = true
    LOG info “OPTIMIZED MODE: Using pre-computed segments”
  END
END
// === AI CALL: The ONLY non-deterministic step ===
IF hasSegments
  SET analysis = AI extract_transitions(mediaForAI, ?segments)
ELSE
  SET analysis = AI extract_transitions(mediaForAI)
END
// DETERMINISTIC: Post-processing and validation
FOR item IN analysis.transitions
  REQUIRE contains(@validTypes, item.type)
    “Invalid type - must be one of: cut, fade, dissolve, wipe, slide, zoom”
  SET genome = { }
  SET genome.id = new_id( )
  SET genome.duration = item.duration
  SET genome.type = item.type
  SET genome.description = item.description
  SET genome.origin = “mined”
  APPEND @extracted_genomes += genome
END
```

Example 2: Motion Genome Extraction Agent (Illustrative DCL). This example shows genome-constrained AI selection:

```
// DETERMINISTIC: Load approved action vocabulary (genomes from
DNA Map)
SET genome_catalog = ?dna_map
SET valid_genome_names = [ ]
FOR g IN genome_catalog
  IF g.operator EXISTS
    SET valid_genome_names = valid_genome_names + [g.operator]
  END
  IF g.name EXISTS
    SET valid_genome_names = valid_genome_names + [g.name]
  END
END
LOG info “Loaded genome catalog: ” + count(genome_catalog)
// === AI CALL: Analyze with constrained vocabulary ===
SET inferred_motions = AI analyze_element_motions(element,
source_id, genome_catalog)
// DETERMINISTIC: Validate AI chose only from approved
vocabulary
FOR motion IN inferred_motions
  SET _motion_name = motion.action
  // CRITICAL: Reject if not in approved genome catalog
  REQUIRE contains(valid_genome_names, _motion_name)
    “Invalid motion action \”“ + _motion_name +
    ”\“ (not found in genome catalog)”
  // Build validated output token
  SET motion_genome = { }
  SET motion_genome.id = new_id( )
  SET motion_genome[“element-id”] = element.id
  SET motion_genome.start = motion.start
  SET motion_genome.end = motion.end
  SET motion_genome.origin = “mined”
  SET motion_genome[“origin-type”] = “media-analysis”
  SET @extracted_motions = @extracted_motions + [motion_genome]
END
```

Example 3: Visual Element Extraction Agent (Illustrative DCL). Shows extensive deterministic post-processing after AI extraction:

```
// === SINGLE AI CALL ===
SET extraction_result = AI extract_image_layers(?imageUrl)
// === EXTENSIVE DETERMINISTIC POST-PROCESSING ===
// Unwrap schema variations
SET unwrapped = extraction_result
IF extraction_result.layers EXISTS AND NOT
is_array(extraction_result.layers)
  SET unwrapped = extraction_result.layers
END
// Initialize output with safe defaults
SET @imageLayerGroups = {
  “overlay”: {“exists”: false, “layers”: [ ]},
  “product”: {“exists”: false},
  “background”: {“exists”: false},
  “objects”: {“exists”: false, “items”: [ ]}
}
// Guardrail: Product is pose-only, never an object
SET promoted = false
IF @imageLayerGroups.product.exists == false
  FOR obj IN @imageLayerGroups.objects.items
    SET is_product_like = false
    IF obj.description EXISTS
      SET d = lower(obj.description)
      IF contains(d, “hero product”) OR contains(d, “main product”)
        SET is_product_like = true
      END
    END
    // Promotion logic
    IF is_product_like == true AND promoted == false AND
    obj.bbox EXISTS
      SET @imageLayerGroups.product.exists = true
      SET @imageLayerGroups.product.bbox = obj.bbox
      SET promoted = true
    END
  END
END
// Filter out product-like objects
SET filtered_items = [ ]
FOR obj IN @imageLayerGroups.objects.items
  IF is_product_like == false
    EMIT filtered_items += obj
  END
END
SET @imageLayerGroups.objects.items = filtered_items
```

The following AI function patterns are representative of those used in DCL agents.

| Function Pattern | Agent Type | Purpose |
|---|---|---|
| AI analyze_transitions( ) | Transition Extractor | Detect transition types |
| | | between segments |
| AI transcribe_audio( ) | Audio Processor | Extract audio transcript to |
| | | text |
| AI extract_text_overlays( ) | Text Recognizer | Extract text elements from |
| | | visual media |
| AI analyze_semantic_elements( ) | Element Analyzer | Analyze element structure |
| | | and relationships |
| AI detect_boundaries( ) | Boundary Detector | Detect scene or segment |
| | | boundaries |
| Al extract_visual_layers( ) | Layer Extractor | Extract compositional layers |
| | | from images |
| AI detect_attributes( ) | Attribute Detector | Detect semantic properties of |
| | | content |
| AI analyze_motion_patterns( ) | Motion Analyzer | Extract motion/animation |
| | | genomes |
| AI extract_action_sequences( ) | Action Extractor | Extract action sequence |
| | | genomes |
| AI comprehensive_analysis( ) | Full Analyzer | Complete multi-modal |
| | | analysis |
| AI rank_similarity( ) | Similarity Ranker | Rank matches for selection |

In some embodiments, in a typical DCL workflow, about 90% of operations are deterministic (SET, REQUIRE, FOR, IF, FILTER, LOG, APPEND). About 10% involve AI model inference (AI-prefixed calls). A 200+ line DCL file may exhibit an average of 1-3 AI calls per agent. In many embodiments, the ratio of deterministic instructions to AI invocation instructions in a given script is at least 9:1. For example, a 200+ line DCL file may contain an average of only 1 to 3 AI calls per agent, with the remaining instructions being entirely deterministic. All structural, relational, and validation logic executes deterministically. This high ratio of deterministic to probabilistic operations reflects the design principle that AI is invoked only for creative decisions requiring semantic interpretation and means that the overwhelming majority of the system's computational operations consist of reproducible, verifiable algorithmic computation. The AI model's role is confined to a small number of bounded selection decisions within an otherwise deterministic pipeline.

### IV.9. DNA AI and Genomes—Bottom-Up Hallucination Control

According to various embodiments, while DCL controls the process (Top-Down), DNA AI controls the content (Bottom-Up) at 4004 by constraining AI selections to genomes stored in the DNA Map. Conventional AI content generation is a high-risk effort. AI generates arbitrary outputs from probability distribution. Each generation is a novel creation. Hallucination is the generation of content outside acceptable boundaries. Risk scales with output complexity. In contrast, DNA AI Constrained Selection is a low-risk effort. AI selects from pre-validated options (genomes). Each output is a composition of known-good building blocks. Hallucination risk is selecting from wrong vocabulary, which is detectable and rejectable, and is bounded by vocabulary size.

According to various embodiments, a genome is a sequence of tokens that must be used together to represent a valid creative choice. The term draws analogy to biological DNA. Whereas Biological DNA is composed of a sequence of nucleotides (ATCG), DNA AI is composed of a sequence of tokens (actions, parameters). Whereas biological DNA encodes valid proteins, DNA AI encodes valid creative outputs. Whereas invalid sequences in biological DNA don't produce viable organisms, invalid sequences in DNA AI are rejected by validation. Whereas biological DNA evolves through natural selection, DNA AI is mined from approved assets.

According to various embodiments, A comparison of traditional GenAI tokens to MetaForm Genome tokens is as follows:

| Feature | Traditional GenAI Token | MetaForm Genome |
|---|---|---|
| Granularity | Sub-word / Character (e.g., | Atomic Creative Action (e.g., |
| | “ing”, “th”) | “Pan Left”, “Fade In”) |
| Validation | None (Probabilistic | Pre-validated via Mining |
| | Generation) | Chain |
| Context | Context Window (Short-term, | DNA Map (Long-term, |
| | ~128K tokens) | Curated) |
| Traceability | Black Box (Model Weights) | Full Provenance (Source Asset |
| | | ID) |
| Control Mechanism | Prompt Engineering | DNA Contract Language (DCL) |
| Hallucination Risk | High (Unbounded | Low (Bounded Selection) |
| | Generation) | |
| Update Capability | Regenerate Entire Output | Surgical Genome |
| | | Replacement |

According to various embodiments, the following example of a specification defines a Genome as a structured data object with a specific schema:

```
{
  “$schema”: “genome-schema.json”,
  “genome”: {
    “type”: “object”,
    “required”: [“id”, “type”, “parameters”, “provenance”],
    “properties”: {
      “id”: {
        “type”: “string”,
        “format”: “uuid”,
        “description”: “Universally unique identifier for this genome”
      },
      “type”: {
        “type”: “string”,
        “enum”: [“camera-motion”, “element-motion”, “transition”,
a“pose”, “object-ction”, “lighting”],
        “description”: “Category of creative action”
      },
      “name”: {
        “type”: “string”,
        “description”: “Human-readable action name (e.g., ‘pan-left’,
        ‘fade-in’)”
      },
      “parameters”: {
        “type”: “object”,
        “description”: “Mutable properties with strict bounds”,
        “properties”: {
          “magnitude”: {“type”: “number”, “minimum”: 0.0,
          “maximum”: 1.0},
          “duration_ms”: {“type”: “integer”, “minimum”: 0,
          “maximum”: 10000},
          “ease”: {“type”: “string”, “enum”: [“linear”,
“ease-in”, “ease-out”, “ease-in- out”]},
          “direction”: {“type”: “string”, “enum”: [“left”,
          “right”, “up”, “down”, “in”, “out”]}
        }
      },
      “constraints”: {
        “type”: “array”,
        “description”: “Rules for valid composition with other
        genomes”,
        “items”: {
          “type”: “object”,
          “properties”: {
            “cannot_follow”: {“type”: “array”, “items”: {“type”:
            “string”}},
            “must_precede”: {“type”: “array”, “items”: {“type”:
            “string”}},
            “incompatible_with”: {“type”: “array”, “items”: {“type”:
            “string”}}
          }
        }
      },
      “provenance”: {
        “type”: “object”,
        “required”: [“source_asset_id”, “extraction_chain”,
        “extraction_timestamp”],
        “properties”: {
          “source_asset_id”: {
            “type”: “string”,
            “description”: “Cryptographic link to source asset”
          },
          “extraction_chain”: {
            “type”: “string”,
            “description”: “Mining chain that extracted this genome”
          },
          “extraction_timestamp”: {
            “type”: “string”,
            “format”: “date-time”
          },
          “checksum”: {
            “type”: “string”,
            “description”: “SHA-256 hash for integrity verification”
          }
        }
      },
      “brandDNA”: {
        “type”: “object”,
        “description”: “Brand-specific metadata for style matching”,
        “properties”: {
          “tempo”: {“type”: “string”, “enum”: [“slow”, “moderate”,
          “fast”]},
          “tone”: {“type”: “string”, “enum”: [“soft”, “neutral”,
          “energetic”]},
          “durationRange”: {“type”: “array”, “items”: {“type”:
“number”}, “minItems”: 2, “maxItems”: 2}
        }
      },
      “status”: {
        “type”: “string”,
        “enum”: [“active”, “blacklisted”, “deprecated”],
        “default”: “active”
      }
    }
  }
}
```

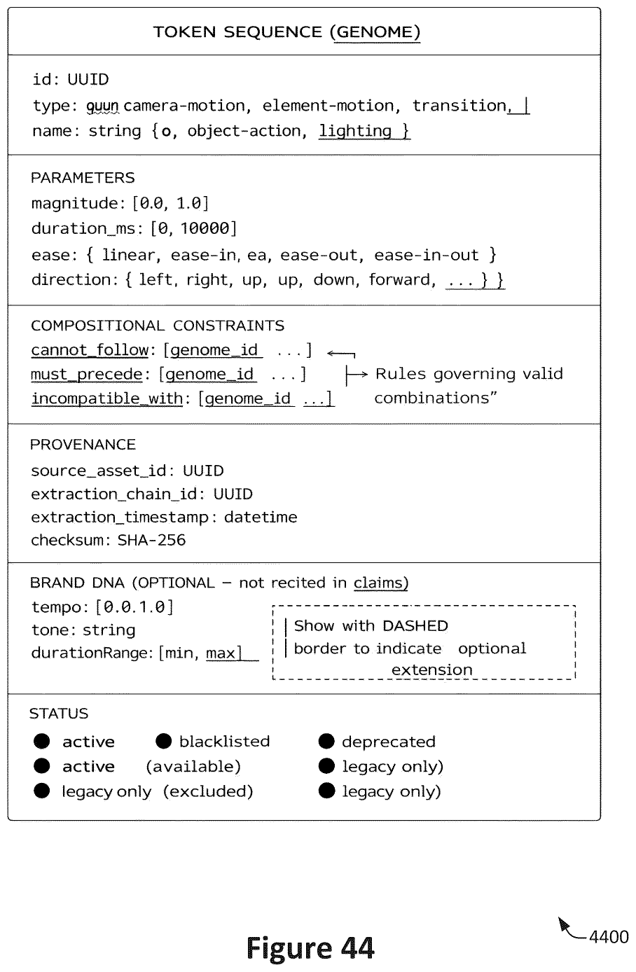

FIG. 44 illustrates a block diagram of a token sequence (sometimes referred to herein as a genome). In accordance with various embodiments, the token sequence (genome) schema structure is illustrated as a structured data diagram showing the fields and organization of each entry in the validated token catalog. The schema includes: a unique identifier (UUID); a type classification corresponding to a content action category (such as camera-motion, element-motion, transition, pose, object-action, or lighting); a name string; a parameters section with defined value bounds (such as magnitude in the range 0.0 to 1.0, duration in milliseconds, easing function, and direction); a compositional constraints section specifying cannot_follow, must_precede, and incompatible_with rules governing valid combinations with other token sequences; a provenance section comprising source asset identifier, extraction chain identifier, extraction timestamp, and checksum; a brand DNA section containing tempo, tone, and duration range metadata; and a status field with three possible values: active (available for AI selection), blacklisted (excluded from all constrained contexts), and deprecated (excluded from new generation but retained in provenance records), with status transition rules as described in the preceding paragraph.

According to various embodiments, each genome in the validated token catalog (DNA Map) has an associated status value that governs its availability for AI selection. The status values and their operational rules are as follows. A genome with “active” status is available for inclusion in constrained contexts provided to AI models and may be selected during content generation. A genome with “blacklisted” status is excluded from all constrained contexts and may not be selected by any AI model; blacklisting is triggered by a designation that the genome produces undesirable results, as described with respect to genome blacklisting below. A genome with “deprecated” status is excluded from constrained contexts for new content generation but remains referenced in provenance records of previously synthesized assets for traceability purposes. Status transitions follow defined rules: an active genome may transition to blacklisted or deprecated; a blacklisted genome may transition to deprecated but not back to active; a deprecated genome may not transition to any other status. The content generation engine enforces these status rules by filtering the validated token catalog to include only genomes with active status before constructing the constrained context for any AI invocation.

The following example illustrates the use of a Genome in video generation.

```
// Camera Motion Genome (Complete)
{
  “id”: “550e8400-e29b-41d4-a716-446655440001”,
  “type”: “camera-verb”,
  “name”: “pan-left”,
  “parameters”: {
    “magnitude”: 0.6,
    “duration_ms”: 1200,
    “ease”: “ease-in-out”,
    “direction”: “left”
  },
  “constraints”: [
    {“cannot_follow”: [“pan-left”], “incompatible_with”: [“zoom-in”]}
  ],
  “provenance”: {
    “source_asset_id”: “asset-789-approved”,
    “extraction_chain”: “media-analysis”,
    “extraction_timestamp”: “2026-01-15T10:30:00Z”,
    “checksum”: “sha256:a1b2c3d4...”
  },
  “brandDNA”: {
    “tempo”: “moderate”,
    “tone”: “soft”,
    “durationRange”: [0.8, 1.5]
  },
  “status”: “active”
}
// Animation Genome
{
  “name”: “fade-in”,
  “category”: “OPACITY”,
  “parameters”: {
    “from_opacity”: {“type”: “number”, “default”: 0.0},
    “to_opacity”: {“type”: “number”, “default”: 1.0},
    “ease”: {“enum”: [“linear”, “ease-out”]}
  }
}
```

The following example of DNA Map Structure illustrates the use of genome storage in the DNA Map, which provides a structured catalog of approved genomes.

```
{
  “version”: “2.0”,
  “description”: “Unified genome catalog containing motion primitives”,
  “lastUpdated”: “2026-01-15”,
  “easeEnum”: [
    “linear”, “ease-in”, “ease-out”, “ease-in-out”, “smooth”,
    “power2-in”, “power2-out”, “power3-in”, “power3-out”,
    “back-in”, “back-out”, “sine-in”, “sine-out”, “elastic-out”
  ],
  “categories”: {
    “CAMERA”: “Camera motion genomes”,
    “TRANSFORM”: “Transform and motion genomes”,
    “OPACITY”: “Opacity and blend genomes”,
    “ELEMENT”: “Element animation genomes”,
    “TEXT”: “Text-specific animation genomes”,
    “EFFECT”: “Visual effects genomes”,
    “LIGHTING”: “Lighting genomes”,
    “SPATIAL”: “3D and depth genomes”
  },
  “genomes”: [
    // 100+ genome primitives defined here, each with:
    // - name, category, parameters, constraints, provenance
  ]
}
```

In some embodiments, tokens may be restricted in any of various ways.
1. Pre-Invocation: Load approved vocabulary BEFORE AI call
2. Constrained Prompting: Provide vocabulary as explicit context to AI
3. Selection Task: AI selects from vocabulary, not free generation
4. Post-Validation: Verify AI output against vocabulary
5. Rejection: Invalid selections trigger error, not silent acceptance

An example implementation pattern is as follows:

```
// STEP 1: Load approved genome vocabulary
SET action_templates = ? actions
SET action_template_names = [ ]
FOR a IN action_templates
  SET action_template_names = action_template_names + [a.name]
END
// STEP 2: AI selects from vocabulary (receives catalog as context)
SET inferred_verbs = AI analyze_layer_animations_v3(layer,
source_id, action_templates)
// STEP 3: Validate selections against vocabulary
FOR verb IN inferred_verbs
  REQUIRE contains(action_template_names, verb.action)
    “REJECTED: Action not in approved catalog”
END
```

### IV.10. Genome Blacklisting and Mass Asset Update

When synthesizing assets at scale (hundreds or thousands of videos), the system can efficiently update them when a problem is discovered. Every synthesized asset maintains a complete DNA Provenance Map-a structured data record of exactly which genomes were used and their source, enabling surgical updates. An example of a formal provenance map schema is as follows:

```
  “$schema”: “provenance-map-schema.json”,
  “synthesized-asset”: {
    “type”: “object”,
    “required”: [“synthesized-asset-id”, “synthesis-timestamp”,
“dcl-script-version”, “dna-provenance”],
    “properties”: {
      “synthesized-asset-id”: {
        “type”: “string”,
        “format”: “uuid”,
        “description”: “Unique identifier for the synthesized asset”
      },
      “synthesis-timestamp”: {
        “type”: “string”,
        “format”: “date-time”,
        “description”: “When this asset was synthesized”
      },
      “dcl-script-version”: {
        “type”: “string”,
        “description”: “Version of DCL script used for synthesis”
      },
      “asset-type”: {
        “type”: “string”,
        “enum”: [“video”, “image”, “interactive-experience”, “audio”],
        “description”: “Type of synthesized asset”
      },
      “dna-provenance”: {
        “type”: “array”,
        “description”: “Complete genome lineage for every component”,
        “items”: {
          “type”: “object”,
          “required”: [“genome-id”, “genome-type”, “source-asset-id”,
“position-in-asset”],
          “properties”: {
            “genome-id”: {
              “type”: “string”,
              “format”: “uuid”,
              “description”: “Reference to genome in DNA Map”
            },
            “genome-type”: {
              “type”: “string”,
              “enum”: [“element-motion”, “camera-motion”,
“transition”, “pose”, “object-action”],
              “description”: “Category of genome”
            },
            “action”: {
              “type”: “string”,
              “description”: “Specific action name (e.g., ‘fade-in’,
              ‘pan-left’)”
            },
            “source-asset-id”: {
              “type”: “string”,
              “description”: “Asset from which this genome was
              mined”
            },
            “source-chain”: {
              “type”: “string”,
              “description”: “Mining chain that extracted the genome”
            },
            “position-in-asset”: {
              “type”: “object”,
              “description”: “Location within synthesized asset”,
              “properties”: {
                “segment”: {“type”: “integer”},
                “layer”: {“type”: “integer”},
                “time-range”: {
                  “type”: “object”,
                  “properties”: {
                    “start”: {“type”: “number”},
                    “end”: {“type”: “number”}
                  }
                }
              }
            },
            “parameter-values”: {
              “type”: “object”,
              “description”: “Specific parameter values used in this
              instance”
            }
          }
        }
      },
      “blacklist-affected”: {
        “type”: “boolean”,
        “default”: false,
        “description”: “Flag indicating asset contains blacklisted
        genome”
      },
      “regeneration-status”: {
        “type”: “string”,
        “enum”: [“current”, “pending-regeneration”, “regenerated”],
        “default”: “current”
      }
    }
  }
}
```

An example instance of a provenance map is as follows:

```
  {
    “synthesized-asset-id”: “550e8400-e29b-41d4-a716-446655440123”,
    “synthesis-timestamp”: “2026-01-20T14:30:00Z”,
    “dcl-script-version”: “synthesis-agent-v2.3”,
    “asset-type”: “video”,
    “dna-provenance”: [
      {
        “genome-id”: “550e8400-e29b-41d4-a716-446655440001”,
        “genome-type”: “element-motion”,
        “action”: “fade-in”,
        “source-asset-id”: “approved-asset-789”,
        “source-chain”: “media-analysis”,
        “position-in-asset”: {“segment”: 2, “element”: 3, “time-range”:
{“start”: 0.0, “end”: 0.15}},
        “parameter-values”: {“duration_ms”: 500, “ease”: “ease-in”}
      },
      {
        “genome-id”: “550e8400-e29b-41d4-a716-446655440042”,
        “genome-type”: “camera-motion”,
        “action”: “pan-left”,
        “source-asset-id”: “approved-asset-456”,
        “source-chain”: “media-analysis”,
        “position-in-asset”: {“segment”: 1, “time-range”: {“start”: 0.2,
        “end”: 0.8}},
        “parameter-values”: {“magnitude”: 0.6, “ease”: “ease-in-out”}
      }
    ],
    “blacklist-affected”: false,
    “regeneration-status”: “current”
}
```

This architecture enables a shift from “Human-in-the-loop” (manual review of each asset) to “Logic-in-the-loop” (automated propagation). Once a genome is blacklisted, (a human or automated audit decision), the DCL logic automatically propagates this decision across the entire asset library via a database query, such as “SELECT synthesized-asset-id FROM provenance_map WHERE genome-id=‘<blacklisted-genome-id>’”.

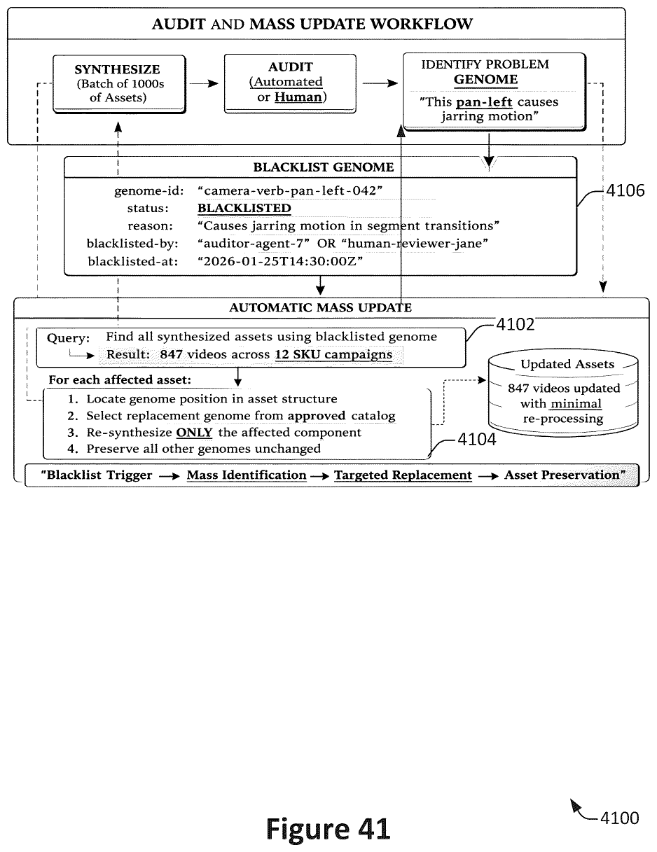

FIG. 41 illustrates a workflow 4100 for auditing and mass updating, performed in accordance with one or more embodiments. Because synthesized assets are composed of discrete genomes with clear boundaries, updates are surgical. In a conventional approach without genome structure, when a problem is discovered in 1 synthesized content asset (e.g., a video, image, or interactive experience), all 1000 assets must be manually reviewed and regenerated from scratch. There are no guarantees the same problem won't recur. In contrast, with MetaForm and Genome Structure, a problem can be traced to specific genome via provenance. A query 4102 then finds all 847 videos using that genome. Genome blacklisting can be used to automatically flag all 847. Each video can be updated by replacing ONLY the problematic genome, as shown at 4104. The rest of composition is preserved intact.

According to various embodiments, an example blacklist genome implementation 4106 is as follows:

```
{
  “operation”: “blacklist-genome”,
  “genome-id”: “camera-verb-pan-left-042”,
  “reason”: “Causes jarring motion in segment transitions”,
  “replacement-strategy”: “select-similar-from-approved”,
  “affected-assets-query”: {
    “filter”: {“dna-provenance.genome-id”: “camera-verb-pan-left-042”},
    “action”: “flag-for-regeneration”
  }
```

According to various embodiments, an example Regeneration DCL (simplified) is as follows:

```
// Load asset's DNA provenance
SET provenance = ?asset.dna_provenance
// Find blacklisted genomes
SET blacklisted = FILTER provenance WHERE genome.status ==
“BLACKLISTED”
FOR bl IN blacklisted
  // Get position in asset structure
  SET position = bl.position_in_asset
  // Select replacement from approved genomes (excluding blacklisted)
  SET candidates = FILTER ?approved_genomes
    WHERE category == bl.genome_type
    AND id != bl.genome_id
    AND status != “BLACKLISTED”
  // AI selects best replacement from approved candidates
  SET replacement = AI select_replacement_genome(position,
  candidates, ?context)
  // Update asset at specific position only
  SET @updated_asset = replace_genome_at(asset, position,
  replacement)
END
```

The provenance record structure described above—including the ordered mapping of genome identifiers to positions within each synthesized content asset—is the data structure queried and updated in the selective replacement process described above. The genome_id and position fields in the provenance map directly enable identification of the exact location within each affected asset where the blacklisted genome must be replaced.

Consider the application of this approach to content asset generation (including but not limited to video, image, and interactive experience generation) in comparison with conventional techniques.

| | | MetaForm with Genome |
|---|---|---|
| Scenario | Traditional | Blacklisting |
| Generate 1000 product | 1000 independent | 1000 structured compositions |
| videos | generations | |
| Discover problem in 50 videos | Manual review of all 1000 | Query provenance → find 50 |
| Identify root cause | Unknown - could be anything | Specific genome identified |
| Fix the problem | Regenerate 50 from scratch | Blacklist genome + targeted |
| | | update |
| Prevent recurrence | Hope for the best | Blacklisted genome excluded |
| | | from all future synthesis |
| Update remaining 950 | Not applicable | Automatic - if any use |
| | | blacklisted genome |

Consider the example of a Multi-Market Video Campaign which involves generating 5000 videos for 500 SKUs across 10 markets. An auditor reviews 50 videos (1% sample), and identifies 3 problematic genomes causing brand violations. The auditor then blacklists 3 genomes, and the system identifies 1200 affected videos. They are automatically regenerated with replacement genomes. Then, 5000 compliant videos are delivered with 1% audit effort.

According to various embodiments, auditing can be performed by automated audit agents configured as DCL-defined agents that check synthesized assets against brand rules, quality thresholds, compliance requirements. Alternatively, or additionally, auditing can be performed by human reviewers with manual review with structured feedback that identifies specific problematic elements. As still another example, hybrid auditing can involve automated pre-screening with human spot-check. Any audit finding can be traced to a specific genome, enabling systemic correction rather than case-by-case fixes.

According to various embodiments, and as illustrated in FIG. 41, the system provides a dual-level audit propagation mechanism that enables a human operator to audit a small subset of synthesized content assets and propagate corrections to the full library at scale. At production volumes (e.g., thousands or tens of thousands of synthesized assets), it is impractical for an operator to review every output individually. Instead, the operator audits a representative subset—for example, 1% of outputs- and the system propagates findings through two distinct levels.

At a first level (content-level propagation), the operator examines the audited subset and identifies specific token sequences (genomes) that cause quality or compliance issues. The operator can respond in two ways, independently or in combination. First, the operator may designate problematic token sequences as blacklisted in the validated token catalog. Upon blacklisting, the system queries the provenance data store to identify every synthesized content asset in the library that used the blacklisted token sequence—including assets not individually audited—and performs selective replacement of the blacklisted token sequence in each affected asset while preserving all other portions intact. This propagates the operator's audit finding from the reviewed subset to all affected assets at scale without requiring individual review of each asset. Second, the operator may determine that a particular category of token sequences in the validated token catalog is insufficient for a desired quality level. In response, the operator designates one or more additional reference assets as approved sources for mining, and the automated extraction pipeline processes these additional reference assets to extract, normalize, and persist new token sequences in the identified category. This expands the selection domain available for future content generation, increasing creative variety while maintaining the same bounded, provenance-tracked constraints.

At a second level (process-level propagation), the operator examines execution logs from the audited subset to identify areas where the agent chain can be improved. Because each agent in the chain executes a workflow script written in the domain-specific language (DCL), and because DCL scripts are deterministic code rather than probabilistic prompts, the operator can modify a specific agent's DCL script to address the identified issue. The modification may involve adding validation constraints, adjusting filter parameters, improving AI invocation context construction, or restructuring the workflow logic. Once modified, the improved script can be used to re-execute the chain on the audited subset to verify the improvement. Critically, because DCL scripts are deterministic, the modification automatically applies to ALL future content generation operations that execute the modified script. Every subsequent run of the chain-whether processing new reference assets through mining or generating new synthesized content through synthesis-inherits the improvement without any additional operator action. This means a single script modification based on auditing a small subset propagates to an unlimited number of future operations.

Together, these two levels create a compounding improvement mechanism. Content-level propagation fixes existing outputs at scale (correcting the library). Process-level propagation fixes the process itself (improving all future outputs). An operator who audits 1% of outputs and makes targeted corrections at both levels effectively improves 100% of the current library and 100% of future production. This dual-level audit propagation is a core efficiency advantage of the architecture: it enables hallucination-free complex business processes at industrial scale with limited human effort.

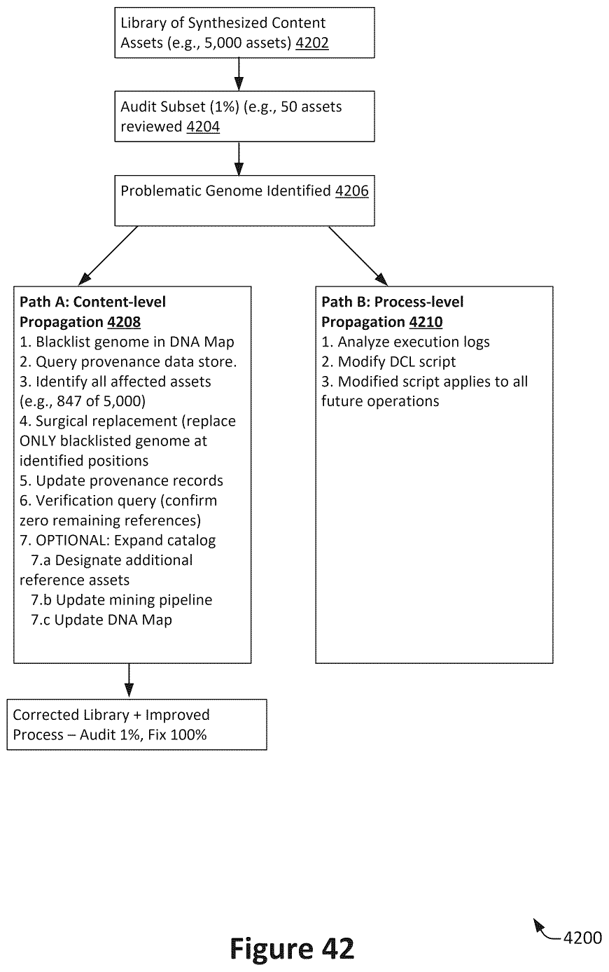

FIG. 42 illustrates a remediation and propagation method 4200 for correcting defects within a large library of synthesized content assets, in accordance with one or more embodiments. The method enables detection of a problematic genome or token construct through partial audit and propagates corrective action across the entire asset library and associated generation processes.

In various embodiments, the method begins with a Library of Synthesized Content Assets 4202. The library 4202 may include a large number of previously generated assets (e.g., approximately 5,000 assets), each associated with provenance metadata and references to one or more genomes, components, or token definitions stored in a DNA Map or equivalent semantic catalog.

An Audit Subset 4204 is selected from the library 4202. In some embodiments, the audit subset comprises a statistically significant sampling of the library, such as approximately one percent (e.g., 50 of 5,000 assets). The audit subset 4204 is reviewed using automated validation, manual inspection, or a combination thereof to detect structural, semantic, or content-level defects.

From the audit subset 4204, a Problematic Genome Identified step 4206 determines that a particular genome, token definition, component, or semantic construct is defective, invalid, incomplete, or otherwise undesirable. Identification may occur through anomaly detection, policy violation detection, quality scoring, inconsistency analysis, or explicit human review.

Upon identification of the problematic genome 4206, the method branches into two complementary propagation paths: Path A (Content-Level Propagation) 4208 and Path B (Process-Level Propagation) 4210. These paths may be executed independently or in combination.

In Path A: Content-Level Propagation 4208, the problematic genome is first blacklisted within the DNA Map or equivalent semantic registry. Blacklisting prevents future selection or reuse of the problematic genome during content generation.

A provenance data store is queried to identify all assets within the library 4202 that reference the blacklisted genome. In some embodiments, the provenance system maintains explicit mappings between assets and genome identifiers, enabling precise enumeration of affected assets (e.g., 847 of 5,000 assets).

All affected assets are identified, and a surgical replacement operation is performed. The surgical replacement replaces only the blacklisted genome at the specific positions in which it occurs, without regenerating unaffected portions of each asset. This targeted modification preserves valid content while correcting only the defective genome references.

Following replacement, provenance records are updated to reflect the substitution of the corrected or substitute genome. A verification query is then executed to confirm that no remaining references to the blacklisted genome persist within the library. The verification step ensures complete removal of the defective construct.

In some embodiments, Path A further includes an optional catalog expansion step. The catalog may be expanded by designating additional reference assets, updating the mining pipeline to incorporate new exemplars, and updating the DNA Map accordingly. This optional expansion may improve semantic coverage and reduce the likelihood of similar defects recurring.

In Path B: Process-Level Propagation 4210, execution logs corresponding to prior generation events are analyzed. The execution logs may include DCL scripts, agent invocation traces, parameter settings, and decision branches that led to the incorporation of the problematic genome.

Based on log analysis, the governing DCL script or equivalent deterministic control logic is modified. The modification may include altering selection constraints, updating validation rules, revising decision branches, or adjusting filtering conditions that permitted the problematic genome to be used.

The modified DCL script is then applied to all future operations. In this manner, subsequent content generation requests are governed by updated deterministic logic that prevents reintroduction of the problematic genome at the process level.

After completion of Path A and/or Path B, the method yields a Corrected Library and Improved Process, as indicated in FIG. 42. In some embodiments, auditing a relatively small subset of assets (e.g., approximately one percent) enables correction of substantially all affected assets within the entire library. This approach may be characterized as “Audit 1%, Fix 100%,” reflecting that identification of a root-level semantic defect allows deterministic propagation of corrective action across both stored content and future generation workflows.

The described method leverages centralized genome definitions, explicit provenance tracking, and deterministic control scripts to enable scalable remediation. Because each asset references standardized genome identifiers and because process logic is codified in modifiable scripts, a single detected defect can be corrected retroactively across stored assets and prospectively across future operations without requiring complete regeneration of the entire asset library.

### IV.11. Fully Automated Extraction of Genomes from Approved Assets

According to various embodiments, the system extracts genomes through automated agent chains—not manual curation. That is, the “learning” of valid genomes is itself an automated process. For instance, Genome Mining can be fully automated by allowing agent chains to extract tokens. Asset Approval can be configurable (e.g., manual, automatic, or hybrid). DNA Map Population can be fully automated (e.g., mined genomes indexed automatically). Synthesis Constraints can be fully automated (e.g., DCL enforces genome selection).

In some embodiments, the selection of which assets to mine can be manual (e.g., human reviewers mark assets as “approved for mining”). Alternatively, or additionally, approval can be automatic (e.g., QA agents or rule-based systems approve assets meeting criteria). Alternatively, or additionally, approval can be hybrid (e.g., initial automatic filtering followed by human spot-check). Once an asset is designated as approved, the extraction of genomes can be fully automated.

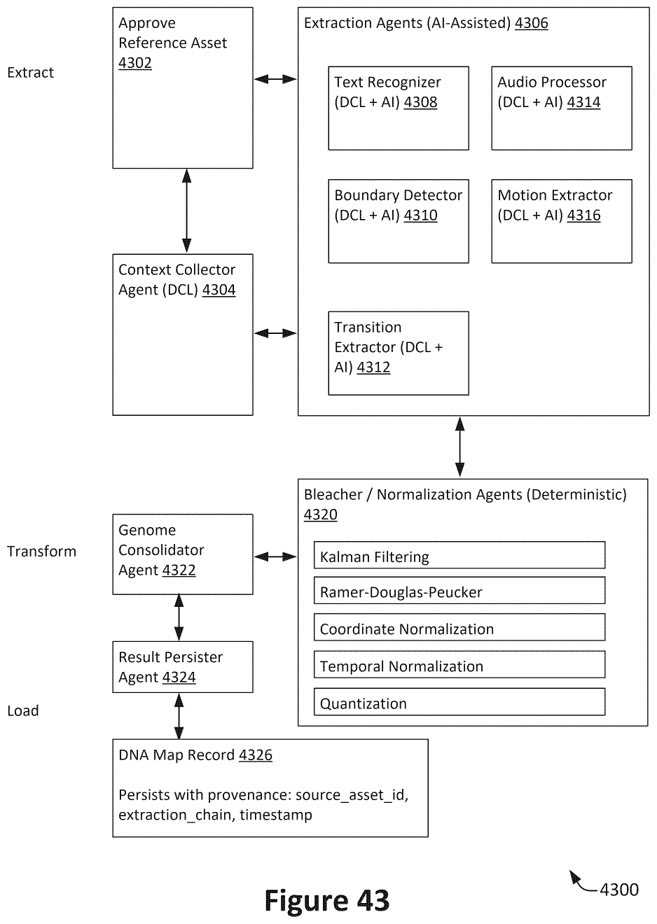

FIG. 43 illustrates a mining chain pipeline, configured in accordance with various embodiments. The mining chain pipeline is illustrated as a top-to-bottom flow from an approved reference asset 4302 through an ordered sequence of processing agents to the validated token catalog (DNA Map) 4326. Three labeled zone brackets identify the Extract-Transform-Load (ETL) stages of the pipeline. According to various embodiments, the Extract zone spans from the approved reference asset through the context collector agent 4304 and the extraction agents 4306 (such as TextRecognizer 4308, AudioProcessor 4314, BoundaryDetecto 4310r, TransitionExtractor 4312, SegmentProcessor, FrameExtractor, SemanticAnalyzer, MotionExtractor 4316, ElementAnalyzer, and AnimationExtractor), each annotated as executing DCL scripts with AI keyword invocations.

According to various embodiments, the Transform zone spans the deterministic Bleacher/Normalization agents 4320, which apply the mathematical normalization operations described herein, including discrete Kalman filtering for signal smoothing, Ramer-Douglas-Peucker algorithm for path simplification, coordinate normalization mapping absolute values to relative coordinate systems, temporal normalization aligning durations proportionally, and quantization reducing parameter variability to standard bins. The Transform zone also spans the Genome Consolidator agent 4322. The Load zone spans the Result Persister agent 4324 and the DNA Map record 4325, with an annotation indicating that token sequences are persisted with provenance metadata including source asset identifier, extraction chain identifier, and extraction timestamp. Every agent in the pipeline executes DCL scripts with the AI keyword boundary.

According to various embodiments, each processing agent in the mining chain executes a workflow script written in the same domain-specific language (DCL). Each mining agent's workflow script comprises deterministic instructions (SET, REQUIRE, FOR, IF, FILTER, LOG, APPEND) and one or more AI invocation instructions identified by the designated AI keyword. The deterministic execution engine processes mining scripts identically to synthesis scripts: deterministic instructions execute algorithmically, the runtime pauses upon encountering an AI keyword, constrained context is constructed and transmitted to an AI model, the AI model's response is validated, and execution resumes. For example, the TransitionExtractor agent's DCL script (uses deterministic SET and REQUIRE instructions for setup and validation, a single AI extract_transitions ( ) call for analysis, and deterministic FOR and APPEND loops for post-processing-exhibiting the same deterministic-to-AI ratio and syntactic boundary pattern as synthesis workflow scripts. This architectural consistency means the same execution engine, the same validation rules, and the same execution logging apply to both mining and synthesis operations.

An illustrative example of a video-mining chain for a multi-agent pipeline is as follows. In some embodiments, each agent in the chain receives tokens from previous agents, executes its DCL (deterministic+AI calls), outputs mined genomes with provenance tracking, and passes results to the next agent.

```
{
  “term”: “mediaAnalysis”,
  “category”: “chain”,
  “definition”: “A media analysis chain mines structural and semantic
      tokens from source media: temporal patterns, transitions, segment
      boundaries, scene semantics (objects/graphics/composition),
      motion genomes (camera/element/lighting), semantic layer
      groupings, element animations, and representative frames.”,
  “members”: [
    {“type”: “agent”, “name”: “ContextCollector”, “order”: 1,
“role”: “Gather input context”},
    {“type”: “agent”, “name”: “TextRecognizer”, “order”: 2,
“role”: “Extract text elements”},
    {“type”: “agent”, “name”: “AudioProcessor”, “order”: 3,
“role”: “Process audio track”},
    {“type”: “agent”, “name”: “BoundaryDetector”, “order”: 4,
“role”: “Detect segment boundaries”},
    {“type”: “agent”, “name”: “TransitionExtractor”, “order”: 5,
“role”: “Extract transition genomes”},
    {“type”: “agent”, “name”: “SegmentProcessor”, “order”: 6,
“role”: “Process segments”},
    {“type”: “agent”, “name”: “FrameExtractor”, “order”: 7,
“role”: “Extract key frames”},
    {“type”: “agent”, “name”: “SemanticAnalyzer”, “order”: 8,
“role”: “Analyze semantic content”},
    {“type”: “agent”, “name”: “MotionExtractor”, “order”: 9,
“role”: “Extract motion genomes”},
    {“type”: “agent”, “name”: “ElementAnalyzer”, “order”: 10,
“role”: “Analyze element structure”},
    {“type”: “agent”, “name”: “AnimationExtractor”, “order”: 11,
“role”: “Extract animation genomes”},
    {“type”: “agent”, “name”: “GenomeConsolidator”, “order”: 12,
“role”: “Consolidate all genomes”},
    {“type”: “agent”, “name”: “ResultPersister”, “order”: 13,
“role”: “Persist to DNA Map”}
  ]
}
```

An illustrative example of an image-mining chain for a multi-agent pipeline is as follows. “Bleacher” agents (also called Normalization Agents or Sanitization Agents) clean raw extracted data, removing noise and artifacts to produce normalized genome tokens suitable for the DNA Map.

```
{
  “term”: “imageAnalysis”,
  “category”: “chain”,
  “definition”: “An image analysis chain: Layer Extractor extracts
      layers from the image, Token Extractor converts layers to tokens,
      Normalization agents normalize specific layer types,
      and Result Persister saves to the DNA Map.”,
  “members”: [
    {“type”: “agent”, “name”: “ContextCollector”, “order”: 1,
“role”: “Gather input context”},
    {“type”: “agent”, “name”: “LayerExtractor”, “order”: 2,
“role”: “Extract compositional layers”},
    {“type”: “agent”, “name”: “TokenExtractor”, “order”: 3,
“role”: “Convert layers to tokens”},
    {“type”: “agent”, “name”: “OverlayNormalizer”, “order”: 4,
“role”: “Normalizes overlay/text layers”},
    {“type”: “agent”, “name”: “SceneNormalizer”, “order”: 5,
“role”: “Normalizes scene/background layers”},
    {“type”: “agent”, “name”: “CompositionNormalizer”, “order”: 6,
“role”: “Normalizes composition layers”},
    {“type”: “agent”, “name”: “ObjectNormalizer”, “order”: 7,
“role”: “Normalizes object layers”},
    {“type”: “agent”, “name”: “GenomeConsolidator”, “order”: 8,
“role”: “Consolidate all genomes”},
    {“type”: “agent”, “name”: “ResultPersister”, “order”: 9,
“role”: “Persist to DNA Map”}
  ]
}
```

An illustrative example of a schema for mining output for Genome Tokens with Provenance is as follows. Each mined genome includes complete provenance for traceability. The source and origin-type fields enable complete traceability from any genome back to its source asset.

```
{
  “motion-genome”: {
    “properties”: {
      “id”: {
        “type”: [“integer”, “string”],
        “description”: “Unique motion genome identifier”
      },
      “layer-id”: {
        “type”: [“integer”, “string”],
        “description”: “Layer ID reference”
      },
      “start”: {
        “type”: “number”,
        “minimum”: 0.0,
        “maximum”: 1.0,
        “description”: “Start time as percentage of segment duration”
      },
      “end”: {
        “type”: “number”,
        “minimum”: 0.0,
        “maximum”: 1.0,
        “description”: “End time as percentage of segment duration”
      },
      “original-duration”: {
        “type”: “number”,
        “description”: “Original duration in seconds from source video”
      },
      “action”: {
        “type”: “array”,
        “description”: “Embedded action definitions linking to DB
        action catalog”,
        “items”: {
          “properties”: {
            “assetTokenActionId”: {“type”: “integer”},
            “name”: {“type”: “string”},
            “start”: {“type”: “number”},
            “end”: {“type”: “number”},
            “ease”: {“type”: “string”},
            “parameter”: {“type”: “array”}
          }
        }
      },
      “source”: {
        “type”: [“integer”, “string”],
        “description”: “Source asset identifier for provenance”
      },
      “origin”: {
        “enum”: [“mined”, “synthesized”, “crafted”],
        “description”: “Token provenance: mined=extracted,
synthesized=generated, crafted=manual”
      },
      “origin-type”: {
        “enum”: [“media-mining”, “image-mining”, “synthesis”, ...],
        “description”: “Which chain created this token”
      }
    }
  }
}
```

In some embodiments, Bleacher Agents may transform raw extracted data into normalized genome tokens. For example, Kalman Filtering may be used for Motion Smoothing. Motion capture data extracted from video is inherently noisy (jittery camera movements, tracking artifacts). The Bleacher Agent may employ a discrete Kalman Filter to estimate the true motion state from noisy measurements.

In one embodiment, the Bleacher Agent applies a Kalman Filter with state vector: xₖ=[p, v]^{T} where p represents position (e.g., camera pan angle, object location) and v represents velocity (rate of change). The filter operates in two phases. In a prediction phase, the next step is estimated based on motion model. In an updating phase, the correct prediction is determined using observed measurements. This process minimizes mean squared error of the motion estimate, distinguishing between signal (i.e., true creative intent, such as smooth pan motion) and noise (e.g., extraction artifacts such as tracking jitter or compression artifacts). The result ensures that only smooth, intentional motions are indexed as genomes in the DNA Map.

In some embodiments, Ramer-Douglas-Peucker (RDP) may be used for Keyframe Decimation. Animation data often contains redundant keyframes (e.g., a straight-line motion represented by 100 intermediate points). The Bleacher Agent utilizes the Ramer-Douglas-Peucker (RDP) algorithm to compress continuous motion into discrete genome tokens. The RDP algorithm recursively simplifies a curve by finding the point with maximum perpendicular distance from the line connecting endpoints. If distance>threshold (epsilon), the point is kept and the sub-segments are recursively processed. If the distance≤threshold (epsilon), the intermediate points are removed. An example technical implementation is as follows:

```
function RDP(points, epsilon):
  if length(points) <= 2:
    return points
  max_distance = 0
  max_index = 0
  for i = 2 to length(points) − 1:
    distance = perpendicularDistance(points[i], line(points[1],
    points[end]))
    if distance > max_distance:
      max_distance = distance
      max_index = i
  if max_distance > epsilon:
    left = RDP(points[1:max_index], epsilon)
    right = RDP(points[max_index:end], epsilon)
    return concatenate(left, right)
  else:
    return [points[1], points[end]]
```

In some embodiments, RDP may reduce raw motion data into minimal “Key Poses” or “Control Points” that define the essence of the motion. This decimated sequence constitutes the genome, enabling complex continuous motions to be represented as lightweight, discrete tokens.

In some embodiments, beyond smoothing and decimation, Bleacher Agents perform normalization to ensure genome interoperability. Coordinate normalization maps absolute pixel coordinates (e.g., x=1920 px) to relative vector space (e.g., x=1.0). It ensures a “Pan Right” genome extracted from a 4K video works correctly when synthesized into a 720p video. An example formula for coordinate normalization is as follows.

$$( {x}_{normalized} = \frac{{x}_{absolute}}{width} ) , ( {y}_{normalized} = \frac{{y}_{absolute}}{height} )$$

In some embodiments, temporal normalization retimes actions to percentage of segment duration (0.0 to 1.0). It enables synchronized composition regardless of original asset duration. An example formula is as follows.

$$( {t}_{normalized} = \frac{{t}_{absolute}}{{duration}_{segment}} )$$

In some embodiments, quantization involves parameter values discretized to finite precision for storage efficiency. Duration values are binned to standard intervals (e.g., 0.5 s, 1.0 s, 1.5 s)

In some embodiments, a Bleacher Agent algorithmic pipeline may include a number of operations. For example, a pipeline may include:
1. Raw Extraction→
2. Kalman Smoothing→
3. RDP Decimation→
4. Coordinate Normalization→
5. Temporal Normalization→
6. Quantization→
7. Genome Token Output

In some embodiments, the deterministic execution engine directs the automated extraction pipeline to execute a sequence of specific computational transformations to convert unbounded raw environmental data into discrete, interoperable token sequences (genomes). This pipeline performs the extraction of raw content data and reduces memory storage requirements by normalizing the data. The normalization process applies discrete Kalman filtering to achieve signal smoothing on spatial tracking data, removing sensor noise without invoking probabilistic AI models. Furthermore, the pipeline applies a Ramer-Douglas-Peucker algorithm to execute path simplification, which compresses continuous, high-density motion data into minimal, discrete keyframe waypoints. By compressing continuous data streams into discrete token sequences via Ramer-Douglas-Peucker decimation and mapping absolute coordinate values to relative coordinate values, the system drastically reduces the memory footprint and the computational load required for subsequent AI inference operations and multi-agent coordination. The identical DCL+AI-keyword boundary is used in both the mining subsystem and the synthesis subsystem, creating a closed, auditable loop as shown in FIG. 38.

The following illustrative DCL script demonstrates a complete content-generation workflow as executed by the deterministic engine shown in FIG. 37:
#Task: Generate a validated camera motion sequence
SET ?in.scene_id=“SCENE_042”
SET ?in.style=“cinematic”
#Step 1: Query the DNA Map for available motion genomes
SET_local.candidates=FILTER DNA_MAP
   WHERE type=‘camera-motion’
   AND status=‘active’
   AND scene_compatibility INCLUDES ?in.scene_id
#Step 2: AI boundary-deterministic execution pauses here
SET @out.selected_motion=AI_INVOKE
   type=‘camera-motion’
   context=_local.candidates
   style=?in.style
#Step 3: Deterministic execution resumes-validate AI output
REQUIRE @out.selected_motion.genome_id IN DNA_MAP
REQUIRE @out.selected_motion.status=‘active’
REQUIRE @out.selected_motion.type=‘camera-motion’
#Step 4: Bind to output and log provenance
SET @out.final_motion=@out.selected_motion
LOG provenance={
   genome_id: @out.selected_motion.genome_id,
   source_asset: @out.selected_motion.provenance.source_id,
   extraction_chain: @out.selected_motion.provenance.chain_id,
   timestamp: NOW ( )
}

In the above script, the namespace prefixes ?in (immutable input parameters), @out (mutable output state), and _local (transient local variables) enforce the hardware-isolated memory partitioning described in connection with FIG. 36. The AI_INVOKE keyword at Step 2 causes the deterministic execution engine to forcibly suspend deterministic processing and transfer control to the AI model interface, which constructs a bounded selection domain from the filtered candidate set. The AI model is constrained to select exclusively from this domain. Upon return, the REQUIRE assertions at Step 3 validate the AI output before deterministic execution resumes. If any assertion fails, the script terminates with an error and the invalid token sequence is rejected.

### Part IV—Conclusion

The disclosed dual-layer architecture produces a specific technical improvement in computer functionality: it transforms an unbounded generative AI inference problem into a bounded combinatorial selection problem, resulting in measurably reduced inference computation, deterministic validation of outputs against a finite catalog, and enabling surgical update operations on stored content items that are impossible without the provenance-tracked genome structure. These improvements are rooted in the specific computing architecture described herein and are not achievable through generic AI prompting or conventional software engineering techniques.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of video content generation. However, the techniques of the present invention apply to any complex business process that combines deterministic workflow logic with AI-assisted decision-making under bounded constraints. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A computing system for controlled artificial intelligence content generation, comprising:
a first control layer executed via one or more processors and including a deterministic execution engine configured to process scripts defining content generation workflows, a script including a plurality of deterministic instructions and one or more AI invocation instructions syntactically distinguished from the deterministic instructions by a designated keyword within the script, the deterministic execution engine executing the deterministic instructions algorithmically and pausing deterministic execution upon encountering an AI invocation instruction;
a second control layer including a validated token catalog stored in a structured data store on a storage device and defining a finite set of permissible token sequences;
an AI model interface configured to receive a constrained context comprising at least a subset of the validated token catalog relevant to the AI invocation instruction and to respond with a token sequence selected from the subset, the token sequence representing an atomic content element and being associated with provenance metadata identifying a source from which the token sequence was derived, wherein deterministic execution of subsequent deterministic instructions in the script is resumed after the token sequence is received; and
an agent orchestrator configured to facilitate operation of the first control layer and the second control layer to execute the script to determine a synthesized content item.

2. The computing system recited in claim 1, wherein deterministic execution of subsequent deterministic instructions is resumed only after validating that the token sequence corresponds to an entry in the validated token catalog.

3. The computing system of claim 2, wherein the subsequent deterministic instructions include assertion instructions that specify a validation constraint evaluated against the token sequence after binding the token sequence to a variable, the synthesized content item being determined upon determining that the validation constraint is satisfied.

4. The computing system of claim 1, wherein the first control layer prevents process hallucination by ensuring that the deterministic execution engine enforces execution of every deterministic instruction in the script in a prescribed sequence such that an AI model cannot skip, reorder, or fabricate workflow steps, and wherein the second control layer prevents content hallucination by constraining AI model outputs to the finite set of permissible token sequences defined in the validated token catalog such that any AI model output referencing a token sequence absent from the validated token catalog is excluded from the synthesized content item and is rejected during validation.

5. The computing system of claim 1, wherein the script is defined in a domain-specific language having a formal grammar that syntactically distinguishes a plurality of statement types selected from the group consisting of: variable assignments binding values to variables in designated namespaces, assertions evaluating validation constraints, conditional branching and iterative loop structures, AI invocations identified by the designated keyword, and logging instructions, and deterministic filter operations that evaluate predicates using strict equality, numerical comparison, or deterministic string matching and are prohibited from performing semantic similarity operations unless wrapped within an AI invocation instruction bearing the designated keyword.

6. The computing system of claim 1, wherein the token sequence is a structured data object comprising:
a unique identifier,
a type classification corresponding to a content action category,
one or more parameters with defined value bounds,
compositional constraints specifying compatibility rules with other token sequences including at least one of (i) a set of token sequences that cannot immediately follow the designated token sequence, (ii) a set of token sequences that must precede the token sequence or that are incompatible with the token sequence, and (iii) provenance metadata comprising at least a source asset identifier, an extraction chain identifier, and an extraction timestamp.

7. The computing system of claim 1, wherein the synthesized content item is associated with a provenance map recording an ordered mapping of token sequence identifiers to positions within the synthesized content item, the provenance map enabling identification and selective replacement of individual token sequences within the synthesized content item without entirely regenerating the synthesized content item.

8. The computing system of claim 1, further comprising a semantic hypervisor configured to manage execution of a plurality of AI agents by:
instantiating isolated execution environments for the AI agents having separate input, output, and local variable namespaces identified by distinct syntactic prefixes within the scripts such that state from one AI agent's execution does not leak into another AI agent's execution;
restricting the plurality of AI agents to output token sequences present in the validated token catalog, the validated token catalog being accessible to the plurality of AI agents in a read-only mode during content generation operations such that an AI agent's generation of a token sequence not present in the validated token catalog constitutes a boundary violation; and
scheduling execution of deterministic operations within the scripts independently of AI model inference operations.

9. The computing system of claim 1, wherein the script is written in a domain-specific language defined by a formal grammar comprising production rules for statements including assignments, assertions, control flow structures, filter operations, AI invocations, and logging instructions, and wherein the script includes variables organized into designated namespaces including an input namespace for immutable parameters identified by a first syntactic prefix, an output namespace for mutable session state identified by a second syntactic prefix, and a local namespace for mutable block-scoped variables identified by a third syntactic prefix.

10. The computing system of claim 1, wherein the computing system is configured to
generate an execution log classifying executed instructions as deterministic or probabilistic, the execution log enabling identification of sources of non-deterministic behavior within a workflow;
identify, based on the execution log, a modification to at least one instruction in the script to address an identified source of non-deterministic behavior; and
apply the modification to the script to produce a modified script, whereby subsequent execution of the modified script by the deterministic execution engine applies the modification to future content generation operations using the modified script without requiring modification of previously produced content generation outputs.

11. The computing system of claim 1, wherein the token sequence includes compositional constraint data specifying one or more rules governing valid combinations with other token sequences, the computing system further comprising an assembly model configured to determine the synthesized content item based on an ordered composition of selected token sequences including the token sequence upon validating that the ordered composition of selected token sequences satisfies the compositional constraint data.

12. The computing system of claim 1, wherein the token sequence has an associated status value indicating whether the token sequence is active, blacklisted, or deprecated, the subset excluding token sequences having a blacklisted or deprecated status.

13. The computing system of claim 1, wherein the validated token catalog is populated through an automated extraction pipeline comprising an ordered sequence of processing agents executing respective workflow scripts comprising deterministic instructions and one or more AI invocation instructions syntactically identified by a designated keyword, the processing agents performing:
extraction of raw content data from approved reference assets using AI model analysis invoked by the designated keyword,
normalization of the raw content data by applying one or more of signal smoothing using discrete Kalman filtering,
path simplification using a Ramer-Douglas-Peucker algorithm,
coordinate normalization mapping absolute coordinate values to relative coordinate values,
temporal normalization mapping absolute time values to proportional values relative to a segment duration, and
persistence of normalized token sequences to the validated token catalog with associated provenance metadata identifying a reference asset, the automated extraction pipeline, and an extraction timestamp.

14. The computing system of claim 1, wherein the system operates as a bidirectional pipeline in which: a mining subsystem executes the respective workflow scripts of processing agents to process approved reference assets and populate the validated token catalog with normalized token sequences, and a synthesis subsystem executes content generation workflow scripts to select token sequences from the validated token catalog and compose synthesized content assets, wherein both the mining subsystem and the synthesis subsystem use workflow scripts comprising deterministic instructions and AI invocation instructions syntactically identified by the designated keyword, such that both extraction and synthesis enforce an identical boundary between deterministic execution and probabilistic AI model inference, wherein the synthesized content item is designated as an approved reference asset for processing by the mining subsystem.

15. The computing system of claim 1, further comprising:
a library of synthesized content items generated by AI-assisted content synthesis including the synthesized content item, the library storing a provenance record comprising an ordered mapping of token sequence identifiers to positions within the synthesized content item, each token sequence identifier referencing a corresponding entry in a validated token catalog from which the token sequence was selected during synthesis, wherein the computing system is configured to:
receive a designation that a designated token sequence in the validated token catalog is invalid;
query the library to identify a set of affected synthesized content assets whose provenance records contain a designated token sequence identifier; and
for each affected synthesized content asset in the set:
identify, from the provenance record, a position within the affected synthesized content asset at which the designated token sequence was used,
select a replacement token sequence from the validated token catalog, the replacement token sequence being of a same type classification as the designated token sequence and having an active status,
replace the designated token sequence at the position with the replacement token sequence while preserving all other portions of the affected synthesized content asset, and
update the provenance record to reflect the replacement token sequence.

16. The computing system of claim 15, wherein determining that the designated token sequence is invalid is based on an audit of a subset of the synthesized content assets in the library, and wherein the selective replacement propagates the audit finding from the audited subset to all affected synthesized content assets in the library without requiring individual audit of each affected asset, the selective replacement requiring regeneration of only the portions of affected assets corresponding to the designated token sequence with remaining portions preserved intact.

17. The computing system of claim 15, wherein selecting the replacement token sequence comprises providing candidate replacement token sequences and contextual information about the position within the affected synthesized content asset to an AI model, the AI model selecting the replacement token sequence from among a set of candidates.

18. The computing system of claim 17, wherein determining that the designated token sequence is invalid is associated with a blacklist entry comprising a reason for the designation, a replacement strategy indicator, and a query definition for identifying affected assets in the library.

19. A method for controlled artificial intelligence content generation, comprising:
executing a deterministic execution engine in a first control layer via one or more processors to process scripts defining content generation workflows, a script including a plurality of deterministic instructions and one or more AI invocation instructions syntactically distinguished from the deterministic instructions by a designated keyword within the script, the deterministic execution engine executing the deterministic instructions algorithmically and pausing deterministic execution upon encountering an AI invocation instruction;
transmitting a constrained context comprising at least a subset of the validated token catalog relevant to the AI invocation instruction to an AI model interface, the constrained context determined by accessing a second control layer including a validated token catalog stored in a structured data store on a storage device and defining a finite set of permissible token sequences;
receiving from the AI model interface a token sequence selected from the subset, the token sequence representing an atomic content element and being associated with provenance metadata identifying a source from which the token sequence was derived;
resuming execution of subsequent deterministic instructions in the script after the token sequence is received; and
determining a synthesized content item based on the deterministic instructions and the token sequence.

20. One or more non-transitory computer readable media having instructions stored thereon for performing a method for controlled artificial intelligence content generation, the method comprising:
executing a deterministic execution engine in a first control layer via one or more processors to process scripts defining content generation workflows, a script including a plurality of deterministic instructions and one or more AI invocation instructions syntactically distinguished from the deterministic instructions by a designated keyword within the script, the deterministic execution engine executing the deterministic instructions algorithmically and pausing deterministic execution upon encountering an AI invocation instruction;
transmitting a constrained context comprising at least a subset of the validated token catalog relevant to the AI invocation instruction to an AI model interface, the constrained context determined by accessing a second control layer including a validated token catalog stored in a structured data store on a storage device and defining a finite set of permissible token sequences;
receiving from the AI model interface a token sequence selected from the subset, the token sequence representing an atomic content element and being associated with provenance metadata identifying a source from which the token sequence was derived;
resuming execution of subsequent deterministic instructions in the script after the token sequence is received; and
determining a synthesized content item based on the deterministic instructions and the token sequence.
